(19) United States
(12) Patent Application Publication
(10) Pub. No.: US 2019/0036908 A1
(43) Pub. Date: Jan. 31, 2019

(54) TECHNIQUES FOR MANAGING SECURE CONTENT TRANSMISSIONS IN A CONTENT DELIVERY NETWORK

(71) Applicant: Qualcomm Incorporated, San Diego, CA (US)

(72) Inventors: Huichun Liu, CN (CN); Xipeng Zhu, CN (CN); Ruiming Zheng, CN (CN)

(21) Appl. No.: 16/082,760

(22) PCT Filed: Apr. 15, 2016
(86) PCT No.: PCT/CN2016/079450

§ 371 Date: Sep. 6, 2018

(51) Int. Cl. H04L 29/06; H04L 9/32; H04L 9/08

(52) U.S. Cl. CPC H04L 63/0823; H04L 63/166; H04L 67/02; H04L 9/083; H04L 9/3263

(57) ABSTRACT

Techniques are described for managing secure content transmissions in a content delivery network (CDN). A method for handling content requests at an edge node device of a CDN includes receiving a request to access content of a website from a user equipment (UE) over a wireless network; obtaining, in response to receiving the request, an authentication certificate for the website from a key server by providing an authentication certificate of the edge node device to the key server; and establishing a secure connection with the UE based at least in part on the authentication certificate. A method for wireless communication at a UE includes generating a request to access content of a website; processing the request at a modem, the processing including associating mobile CDN content delivery acceleration information with the request; and transmitting the request and the associated mobile CDN content delivery acceleration information to a network access device.

### CROSS REFERENCES

The present application is a 371 national phase filing on International Application No. PCT/CN2016/079450 to Liu, entitled “TECHNIQUES FOR MANAGING SECURE CONTENT TRANSMISSIONS IN A CONTENT DELIVERY NETWORK”, filed Apr. 15, 2016.

### BACKGROUND

### Field of the Disclosure

The present disclosure, for example, relates to wireless communication systems, and more particularly to techniques for managing secure content transmissions in a content delivery network (CDN).

### Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of network access devices (e.g., base stations), each simultaneously supporting communication for multiple communication devices, otherwise known as user equipment (UEs). A base station may communicate with UEs on downlink channels (e.g., downlinks, for transmissions from a base station to a UE) and uplink channels (e.g., uplinks, for transmissions from a UE to a base station).

In some cases, a wireless communication system may function as a mobile CDN and interface with an Internet CDN.

### SUMMARY

In a wireless communication system providing a mobile CDN that interfaces with an Internet CDN, the repeated retrieval and delivery of content from a content server associated with the Internet CDN may consume significant bandwidth within the mobile CDN. To free bandwidth within the mobile CDN, it may be useful to cache content retrieved from the Internet CDN at a device (e.g., an edge node device) within the mobile CDN. However, the caching of content retrieved from an Internet CDN, within a mobile CDN, may raise various authentication, encryption, and mobility issues. The present disclosure therefore describes techniques for managing secure content transmissions in a CDN.

In one example, a method for handling content requests at an edge node device of a CDN is described. The method may include receiving a request to access content of a website from a UE over a wireless network; obtaining, in response to receiving the request, an authentication certificate for the website from a key server by providing an authentication certificate of the edge node device to the key server; and establishing a secure connection with the UE based at least in part on the authentication certificate for the website.

In some examples of the method, establishing the secure connection with the UE may include transmitting the authentication certificate for the website to the UE, receiving an encrypted premaster secret from the UE, transmitting the encrypted premaster secret to the key server, receiving a decrypted premaster secret from the key server, and establishing the secure connection with the UE based at least in part on the decrypted premaster secret. In some examples, the method may include processing the request to access the content of the website after establishing the secure connection with the UE, determining that the content is cached at the edge node device based at least in part on mobile CDN content delivery acceleration information associated with the request to access the content, and delivering the content to the UE. In some examples, the method may include processing the request to access the content of the website after establishing the secure connection with the UE, determining that the content is not cached at the edge node device based at least in part on mobile CDN content delivery acceleration information associated with the request to access the content, obtaining the content from the website, and delivering the content to the UE. In some examples, the method may include identifying the key server based at least in part on: the website, an identified owner of the website, or a combination thereof. In some examples, the request to access the content of the website may be received through a network access device, and the secure connection with the UE may be established through the network access device. In some examples, the CDN may include a mobile CDN between the UE and a packet gateway, and the edge node device may be within the mobile CDN. In some examples, the CDN may include a mobile CDN between the UE and a packet gateway, and the edge node device may be within the CDN and outside the mobile CDN.

In one example, an apparatus for handling content requests at an edge node device of a CDN is described. The apparatus may include means for receiving a request to access content of a website from a UE over a wireless network; means for obtaining, in response to receiving the request, an authentication certificate for the website from a key server by providing an authentication certificate of the edge node device to the key server; and means for establishing a secure connection with the UE based at least in part on the authentication certificate for the website.

In some examples of the apparatus, the means for establishing the secure connection with the UE may include means for transmitting the authentication certificate for the website to the UE, means for receiving an encrypted premaster secret from the UE, means for transmitting the encrypted premaster secret to the key server, means for receiving a decrypted premaster secret from the key server, and means for establishing the secure connection with the UE based at least in part on the decrypted premaster secret. In some examples, the apparatus may include means for processing the request to access the content of the website after establishing the secure connection with the UE, means for determining that the content is cached at the edge node device based at least in part on mobile CDN content delivery acceleration information associated with the request to access the content, and means for delivering the content to the UE. In some examples, the apparatus may include means for processing the request to access the content of the website after establishing the secure connection with the UE, means for determining that the content is not cached at the edge node device based at least in part on mobile CDN content delivery acceleration information associated with the request to access the content, means for obtaining the content from the website, and means for delivering the content to the UE. In some examples, the apparatus may include means for identifying the key server based at least in part on: the website, an identified owner of the website, or a combination thereof. In some examples, the request to access the content of the website may be received through a network access device, and the secure connection with the UE may be established through the network access device. In some examples, the CDN may include a mobile CDN between the UE and a packet gateway, and the edge node device may be within the mobile CDN. In some examples, the CDN may include a mobile CDN between the UE and a packet gateway, and the edge node device may be within the CDN and outside the mobile CDN.

In one example, another apparatus for handling content requests at an edge node device of a CDN is described. The apparatus may include a processor, and memory in electronic communication with the processor. The processor and the memory may be configured to receive a request to access content of a website from a UE over a wireless network; to obtain, in response to receiving the request, an authentication certificate for the website from a key server by providing an authentication certificate of the edge node device to the key server; and to establish a secure connection with the UE based at least in part on the authentication certificate for the website.

In one example, a non-transitory computer-readable medium storing computer-executable code for handling content requests at an edge node device of a CDN is described. The code may be executable by a processor to receive a request to access content of a website from a UE over a wireless network; to obtain, in response to receiving the request, an authentication certificate for the website from a key server by providing an authentication certificate of the edge node device to the key server; and to establish a secure connection with the UE based at least in part on the authentication certificate for the website.

In one example, a method for wireless communication at a UE is described. The method may include generating a request to access content of a website; processing the request to access the content of the website at a modem, the processing including associating mobile CDN content delivery acceleration information with the request to access the content of the website; and transmitting the request to access the content of the website and the associated mobile CDN content delivery acceleration information to a network access device.

In some examples, the method may include maintaining an authorized content provider list (ACPL), and processing the request to access the content of the website at the modem may include determining that information associated with the request to access the content of the website is included in the ACPL. In some examples, the ACPL may include at least one content provider entry, and each of the content provider entries may be associated with at least one of: a uniform resource locator (URL), a uniform resource identifier (URI), a domain name, a hypertext transfer protocol (HTTP) server internet protocol (IP) address, a port identifier, a protocol type, or a combination thereof. In some examples, determining that information associated with the request to access the content of the website is included in the ACPL may include determining a destination HTTP server IP address and a port associated with the request to access the content of the website is included in the ACPL. In some examples, determining that information associated with the request to access the content of the website is included in the ACPL may further include determining a URL or URI associated with the request to access the content of the website is included in the ACPL. In some examples, the ACPL may include at least one content provider entry including a domain name and a HTTP server IP address. In these examples, the method may include monitoring for HTTP server IP addresses associated with domain name system (DNS) requests and DNS responses processed by the modem, and dynamically updating the ACPL based at least in part on the HTTP server IP addresses. In some examples, the monitoring may be performed for DNS requests and DNS responses associated with a DNS user datagram protocol (UDP) port. In some examples, the monitoring may be performed based at least in part on a notification received by the modem from an application programming interface (API).

In some examples, the method may include querying the network access device to determine whether the network access device has locally cached the content of the website, and the mobile CDN content delivery acceleration information may be associated with the request to access the content of the website in response to determining that the network access device has locally cached the content of the website. In some examples, the querying may include transmitting a HTTP URL/URI request using a radio resource control (RRC) signaling extension.

In one example, an apparatus for wireless communication at a UE is described. The apparatus may include means for generating a request to access content of a website; means for processing the request to access the content of the website at a modem, the processing including associating mobile CDN content delivery acceleration information with the request to access the content of the website; and means for transmitting the request to access the content of the website and the associated mobile CDN content delivery acceleration information to a network access device.

In some examples, the apparatus may include means for maintaining an authorized content provider list (ACPL), and the means for processing the request to access the content of the website at the modem may include means for determining that information associated with the request to access the content of the website is included in the ACPL. In some examples, the ACPL may include at least one content provider entry, and each of the content provider entries is associated with at least one of: a URL, a URI, a domain name, a HTTP server IP address, a port identifier, a protocol type, or a combination thereof. In some examples, the means for determining that information associated with the request to access the content of the website is included in the ACPL may include means for determining a destination HTTP server IP address and a port associated with the request to access the content of the website is included in the ACPL. In some examples, the means for determining that information associated with the request to access the content of the website is included in the ACPL may further include means for determining a URL or URI associated with the request to access the content of the website is included in the ACPL. In some examples, the ACPL may include at least one content provider entry including a domain name and a HTTP server IP address. In these examples, the apparatus may further include means for monitoring for HTTP server IP addresses associated with DNS requests and DNS responses processed by the modem, and means for dynamically updating the ACPL based at least in part on the HTTP server IP addresses. In some examples, the monitoring may be performed for DNS requests and DNS responses associated with a DNS UDP port. In some examples, the monitoring may be performed based at least in part on a notification received by the modem from an API.

In some examples, the apparatus may include means for querying the network access device to determine whether the network access device has locally cached the content of the website, and the mobile CDN content delivery acceleration information may be associated with the request to access the content of the website in response to determining that the network access device has locally cached the content of the website. In some examples, the means for querying may include means for transmitting a HTTP URL/URI request using a RRC signaling extension.

In one example, another apparatus for wireless communication at a UE is described. The apparatus may include a processor, and memory in electronic communication with the processor. The processor and the memory may be configured to generate a request to access content of a website: to process the request to access the content of the website at a modem, the processing including associating mobile CDN content delivery acceleration information with the request to access the content of the website; and to transmit the request to access the content of the website and the associated mobile CDN content delivery acceleration information to a network access device.

In one example, a non-transitory computer-readable medium storing computer-executable code for wireless communication at a UE is described. The code may be executable by a processor to generate a request to access content of a website; to process the request to access the content of the website at a modem, the processing including associating mobile CDN content delivery acceleration information with the request to access the content of the website; and to transmit the request to access the content of the website and the associated mobile CDN content delivery acceleration information to a network access device.

In one example, a method for managing ticket keys at a ticket key server is described. The method may include periodically generating a ticket key, and periodically transmitting the periodically generated ticket key to each edge node device of a plurality edge node devices. In some examples, at least one of the plurality of edge node devices may be associated with a network access device of a mobile CDN.

In one example, an apparatus for managing ticket keys at a ticket key server is described. The apparatus may include means for periodically generating a ticket key, and means for periodically transmitting the periodically generated ticket key to each edge node device of a plurality edge node devices. In some examples, at least one of the plurality of edge node devices is associated with a network access device of a mobile CDN.

In one example, another apparatus for managing ticket keys at a ticket key server is described. The apparatus may include a processor, and memory in electronic communication with the processor. The processor and the memory may be configured to periodically generate a ticket key, and to periodically transmit the periodically generated ticket key to each edge node device of a plurality edge node devices.

In one example, a non-transitory computer-readable medium storing computer-executable code for managing ticket keys at a ticket key server is described. The code may be executable by a processor to periodically generate a ticket key, and to periodically transmit the periodically generated ticket key to each edge node device of a plurality edge node devices.

In one example, a method for wireless communication within a CDN is described. The method may include setting up a RRC connection between a UE and a target edge node device associated with a target network access device; and resuming or continuing, between the UE and the target edge node device, a transport layer security (TLS) session established between the UE and a source edge node device associated with a source network access device.

In some examples, the method may include transmitting from the UE to the target edge node device, after setting up the RRC connection and before resuming or continuing the TLS session, a TLS session ticket including an encrypted TLS session key for the TLS session established between the UE and the source edge node device. In some examples, the method may include receiving from the UE at the target edge node device, after setting up the RRC connection and before resuming or continuing the TLS session, a TLS session ticket including an encrypted TLS session key for the TLS session established between the UE and the source edge node device; and decrypting the encrypted TLS session key at the target edge node device, based at least in part on a ticket key received by the target edge node device and the source edge node device. In some examples, the method may include receiving at the UE, after setting up the RRC connection between the UE and the target edge node device, a TLS message transmitted by the target edge node device; and transmitting from the UE to the target edge node device, in response to receiving the TLS message and before resuming or continuing the TLS session, a TLS session ticket including an encrypted TLS session key for the TLS session established between the UE and the source edge node device. In some examples, the method may include transmitting from the target edge node device to the UE, after setting up the RRC connection between the UE and the target edge node device, a TLS message; receiving from the UE at the target edge node device, in response to transmitting the TLS message and before resuming or continuing the TLS session, a TLS session ticket including an encrypted TLS session key for the TLS session established between the UE and the source edge node device; and decrypting the encrypted TLS session key at the target edge node device, based at least in part on a ticket key received by the target edge node device and the source edge node device.

In some examples, the method may include receiving from the source edge node device at the target edge node device, prior to setting up the RRC connection, a TLS session ticket including an encrypted TLS session key for the TLS session established between the UE and the source edge node device; and decrypting the encrypted TLS session key at the target edge node device, based at least in part on a ticket key received by the target edge node device and the source edge node device. In some examples, the method may include performing a TLS handshake between the UE and the target edge node device in a single round-trip message transfer. In some examples, the CDN may include a mobile CDN between the UE and a packet gateway, and at least one of the source edge node device or the target edge node device may be within the mobile CDN. In some examples, the CDN may include a mobile CDN between the UE and a packet gateway, and at least one of the source edge node device or the target edge node device may be within the CDN and outside the mobile CDN.

In one example, an apparatus for wireless communication within a CDN is described. The apparatus may include means for setting up a RRC connection between a UE and a target edge node device associated with a target network access device; and means for resuming or continuing, between the UE and the target edge node device, a TLS session established between the UE and a source edge node device associated with a source network access device.

In some examples, the apparatus may include means for transmitting from the UE to the target edge node device, after setting up the RRC connection and before resuming or continuing the TLS session, a TLS session ticket including an encrypted TLS session key for the TLS session established between the UE and the source edge node device. In some examples, the apparatus may include means for receiving from the UE at the target edge node device, after setting up the RRC connection and before resuming or continuing the TLS session, a TLS session ticket including an encrypted TLS session key for the TLS session established between the UE and the source edge node device; and means for decrypting the encrypted TLS session key at the target edge node device, based at least in part on a ticket key received by the target edge node device and the source edge node device. In some examples, the apparatus may include means for receiving at the UE, after setting up the RRC connection between the UE and the target edge node device, a TLS message transmitted by the target edge node device; and means for transmitting from the UE to the target edge node device, in response to receiving the TLS message and before resuming or continuing the TLS session, a TLS session ticket including an encrypted TLS session key for the TLS session established between the UE and the source edge node device. In some examples, the apparatus may include means for transmitting from the target edge node device to the UE, after setting up the RRC connection between the UE and the target edge node device, a TLS message; means for receiving from the UE at the target edge node device, in response to transmitting the TLS message and before resuming or continuing the TLS session, a TLS session ticket including an encrypted TLS session key for the TLS session established between the UE and the source edge node device; and means for decrypting the encrypted TLS session key at the target edge node device, based at least in part on a ticket key received by the target edge node device and the source edge node device.

In some examples, the apparatus may include means for receiving from the source edge node device at the target edge node device, prior to setting up the RRC connection, a TLS session ticket including an encrypted TLS session key for the TLS session established between the UE and the source edge node device; and means for decrypting the encrypted TLS session key at the target edge node device, based at least in part on a ticket key received by the target edge node device and the source edge node device. In some examples, the apparatus may include means for performing a TLS handshake between the UE and the target edge node device in a single round-trip message transfer. In some examples, the CDN may include a mobile CDN between the UE and a packet gateway, and at least one of the source edge node device or the target edge node device may be within the mobile CDN. In some examples, the CDN may include a mobile CDN between the UE and a packet gateway, and at least one of the source edge node device or the target edge node device may be within the CDN and outside the mobile CDN.

In one example, another apparatus for wireless communication within a CDN is described. The apparatus may include a processor, and memory in electronic communication with the processor. The processor and the memory configured to set up a RRC connection between a UE and a target edge node device associated with a target network access device; and to resume or continue, between the UE and the target edge node device, a TLS session established between the UE and a source edge node device associated with a source network access device.

In one example, a non-transitory computer-readable medium storing computer-executable code for wireless communication within a CDN is described. The code may be executable by a processor to set up a RRC connection between a UE and a target edge node device associated with a target network access device; and to resume or continue, between the UE and the target edge node device, a TLS session established between the UE and a source edge node device associated with a source network access device.

In one example, a method for wireless communication at a source network access device within a CDN is described. The method may include transmitting, to a target network access device, a request for handover of a UE from the source network access device to the target network access device; receiving an acknowledgement of the request for handover of the UE; transmitting to the UE, based at least in part on receiving the acknowledgement of the request for handover of the UE, an indication to close an established TLS session with a source edge node device associated with the source network access device; and transmitting to the UE, after transmitting the indication to close the TLS session, a handover command.

In one example, an apparatus for wireless communication at a source network access device within a CDN is described. The apparatus may include means for transmitting, to a target network access device, a request for handover of a UE from the source network access device to the target network access device; means for receiving an acknowledgement of the request for handover of the UE; means for transmitting to the UE, based at least in part on receiving the acknowledgement of the request for handover of the UE, an indication to close an established TLS session with a source edge node device associated with the source network access device; and means for transmitting to the UE, after transmitting the indication to close the TLS session, a handover command.

In one example, another apparatus for wireless communication at a source network access device within a CDN is described. The apparatus may include a processor, and memory in electronic communication with the processor. The processor and the memory may be configured to transmit, to a target network access device, a request for handover of a UE from the source network access device to the target network access device; to receive an acknowledgement of the request for handover of the UE; to transmit to the UE, based at least in part on receiving the acknowledgement of the request for handover of the UE, an indication to close an established TLS session with a source edge node device associated with the source network access device; and to transmit to the UE, after transmitting the indication to close the TLS session, a handover command.

In one example, a non-transitory computer-readable medium storing computer-executable code for wireless communication at a source network access device within a CDN is described. The code may be executable by a processor to transmit, to a target network access device, a request for handover of a UE from the source network access device to the target network access device; to receive an acknowledgement of the request for handover of the UE; to transmit to the UE, based at least in part on receiving the acknowledgement of the request for handover of the UE, an indication to close an established TLS session with a source edge node device associated with the source network access device; and to transmit to the UE, after transmitting the indication to close the TLS session, a handover command.

The foregoing has outlined rather broadly the techniques and technical advantages of examples according to the disclosure in order that the detailed description that follows may be better understood. Additional techniques and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present invention may be realized by reference to the following drawings. In the appended figures, similar components or functions may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with various aspects of the present disclosure;

FIG. 2 shows an example CDN, in accordance with various aspects of the present disclosure;

FIG. 3 shows an example CDN, in accordance with various aspects of the present disclosure;

FIG. 4 shows an example CDN, in accordance with various aspects of the present disclosure;

FIG. 5 shows a message flow for configuring an HTTPs session (e.g., performing a SSL handshake based on RSA) between a browser of a UE and a content server (e.g., a web server), in accordance with various aspects of the present disclosure;

FIG. 6 shows a certificate verification procedure, in accordance with various aspects of the present disclosure;

FIG. 7 shows example protocol stacks of a UE, a network access device, a PGW/serving gateway (SGW), and a content server, and illustrates an example of a single HTTPs session (e.g., a single TLS/SSL session) within a CDN, in accordance with various aspects of the present disclosure;

FIG. 8 shows example protocol stacks of a UE, a network access device and edge node device, a router/switching network, and a content server, and illustrates an example of front-end and back-end HTTPs sessions (e.g., a front-end TLS/SSL session and a back-end TLS/SSL session) within a CDN, in accordance with various aspects of the present disclosure;

FIG. 9 shows a diagram of a browser of a UE requesting content that the browser does not know to be cached at an edge node device of a mobile CDN, in accordance with various aspects of the present disclosure;

FIG. 10 shows a first custom certificate HTTPs authentication scenario, in accordance with various aspects of the present disclosure;

FIG. 11 shows a second custom certificate HTTPs authentication scenario, in accordance with various aspects of the present disclosure;

FIG. 12 shows a shared certificate HTTPs authentication scenario, in accordance with various aspects of the present disclosure;

FIG. 13 shows a keyless HTTPs authentication scenario, in accordance with various aspects of the present disclosure;

FIG. 14 shows a message flow in which a client, edge node device, and customer key server employ keyless HTTPs authentication, in accordance with various aspects of the present disclosure;

FIG. 15 shows a message flow in which a client, edge node device, and customer key server employ keyless HTTPs authentication, in accordance with various aspects of the present disclosure;

FIG. 16 shows a certificateless HTTPs authentication scenario, in accordance with various aspects of the present disclosure;

FIG. 17 shows example protocol stacks of a UE and a content-server, and illustrates a process of dynamically updating an HTTP server IP address included in an ACPL, in accordance with various aspects of the present disclosure;

FIG. 18 shows example protocol stacks of a UE, a network access device, and an edge node device, and illustrates an example of UE-assisted selective content delivery acceleration based on an ACPL, in accordance with various aspects of the present disclosure;

FIG. 19 shows a message flow in which a UE employs UE-assisted selective content delivery acceleration based on an ACPL, accordance with various aspects of the present disclosure;

FIG. 20 shows a message flow in which a UE employs UE-assisted selective content delivery acceleration based on out-of-band messaging, using HTTPs, in accordance with various aspects of the present disclosure;

FIG. 21 shows a message flow in which a UE employs UE-assisted selective content delivery acceleration based on out-of-band messaging, using HTTP, in accordance with various aspects of the present disclosure;

FIG. 22 shows a wireless communication system including a, in accordance with various aspects of the present disclosure;

FIG. 23 shows a message flow for resuming a TLS session using a TLS session ticket, in accordance with various aspects of the present disclosure;

FIG. 24 shows a block diagram of a ticket key server (e.g., a central key server), in accordance with various aspects of the present disclosure;

FIG. 25 shows a message flow in which a change of serving network access device and change of serving edge node device is made for a UE in an RRC connected state or RRC idle state, with a closed TLS session, in accordance with various aspects of the present disclosure;

FIG. 26 shows a message flow in which a change of serving network access device and change of serving edge node device is made for a UE in an RRC idle state, with an established TLS session, in accordance with various aspects of the present disclosure;

FIG. 27 shows a message flow in which a handover is performed for a UE in an RRC connected state, with an established TLS session, in accordance with various aspects of the present disclosure;

FIG. 28 shows a message flow in which a handover is performed for a UE in an RRC connected state, with an established TLS session, in accordance with various aspects of the present disclosure;

FIG. 29 shows a message flow in which a handover is performed for a UE in an RRC connected state, with an established TLS session, in accordance with various aspects of the present disclosure;

FIG. 30 shows a block diagram of an apparatus for handling content requests at an edge node device of CDN, in accordance with various aspects of the present disclosure;

FIG. 31 shows a block diagram of an apparatus for use in wireless communication at a UE, in accordance with various aspects of the present disclosure;

FIG. 32 shows a block diagram of an apparatus for managing ticket keys at a ticket server, in accordance with various aspects of the present disclosure;

FIG 33 shows a block diagram of an apparatus for wireless communication within a CDN, in accordance with various aspects of the present disclosure;

FIG. 34 shows a block diagram of an apparatus for use in wireless communication at a source network access device, in accordance with various aspects of the present disclosure;

FIG. 35 shows a block diagram of a UE for use in wireless communication, in accordance with various aspects of the present disclosure;

FIG. 36 shows a block diagram of a base station (e.g., a base station forming part or all of an eNB) for use in wireless communication, in accordance with various aspects of the present disclosure;

FIG. 37 shows a block diagram of an edge node device (e.g., an edge node device above or below a PGW) for use in wireless communication, in accordance with various aspects of the present disclosure;

FIG. 38 is a flow chart illustrating an example of a method for handling content requests at an edge node device of a CDN, in accordance with various aspects of the present disclosure;

FIG. 39 is a flow chart illustrating an example of a method for handling content requests at an edge node device of a CDN, in accordance with various aspects of the present disclosure;

FIG. 40 is a flow chart illustrating an example of a method for wireless communication at a UE, in accordance with various aspects of the present disclosure;

FIG. 41 is a flow chart illustrating an example of a method for wireless communication at a UE, in accordance with various aspects of the present disclosure;

FIG. 42 is a flow chart illustrating an example of a method for wireless communication at a UE, in accordance with various aspects of the present disclosure;

FIG. 43 is a flow chart illustrating an example of a method for wireless communication at a UE, in accordance with various aspects of the present disclosure;

FIG. 44 is a flow chart illustrating an example of a method for managing ticket keys at a ticket server, in accordance with various aspects of the present disclosure;

FIG. 45 is a flow chart illustrating an example of a method for wireless communication within a CDN, in accordance with various aspects of the present disclosure;

FIG. 46 is a flow chart illustrating an example of a method for wireless communication within a CDN, in accordance with various aspects of the present disclosure;

FIG. 47 is a flow chart illustrating an example of a method for wireless communication within a CDN, in accordance with various aspects of the present disclosure;

FIG. 48 is a flow chart illustrating an example of a method for wireless communication within a CDN, in accordance with various aspects of the present disclosure;

FIG. 49 is a flow chart illustrating an example of a method for wireless communication within a CDN, in accordance with various aspects of the present disclosure;

FIG. 50 is a flow chart illustrating an example of a method for wireless communication within a CDN, in accordance with various aspects of the present disclosure; and

FIG. 51 is a flow chart illustrating an example of a method for wireless communication at a source network access device within a CDN, in accordance with various aspects of the present disclosure.

### DETAILED DESCRIPTION

The present disclosure describes techniques for managing secure content transmissions in a CDN. In some examples, the techniques may mitigate issues pertaining to authentication, encryption, or mobility when caching content retrieved from an Internet CDN, with in a mobile CDN.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

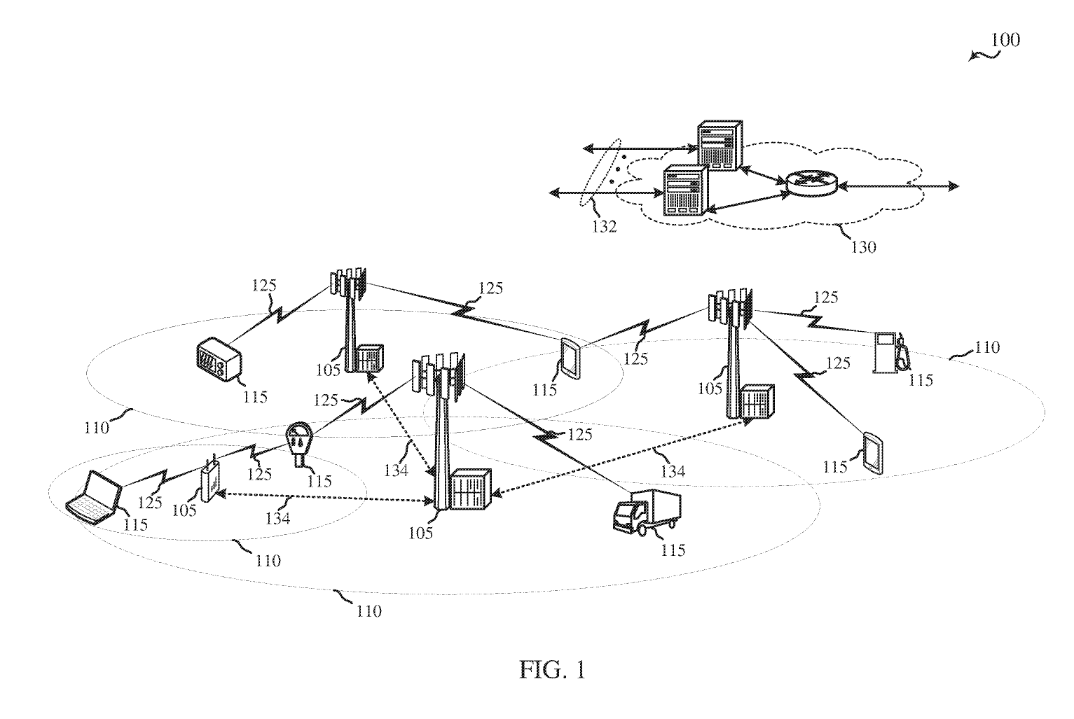

FIG. 1 illustrates an example of a wireless communication system 100, in accordance with various aspects of the present disclosure. The wireless communication system 100 may include network access devices (e.g., base stations 105), UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may include an LTE/LTE-A network. In LTE/LTE-A networks, the term evolved NodeB (eNB) may be used to describe the base stations 105, while the term UE may be used to describe the UEs 115. The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., licensed, shared, etc.) radio frequency spectrum bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment, including macro eNBs, small cell eNBs, relay base stations, and the like.

The communication links 125 shown in wireless communication system 100 may include downlinks (DLs), from a base station 105 to a UE 115, or uplinks (ULs), from a UE 115 to a base station 105. The downlinks may also be called forward links, while the uplinks may also be called reverse links.

In some examples, each communication link 125 may include one or more carriers, where each carrier may be a signal made up of multiple sub-carriers (e.g., waveform signals of different frequencies) modulated according to the various radio technologies described above. Each modulated signal may be transmitted on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a TDD operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may also be referred to as a component carrier (CC), a layer, a channel, etc. The terms “carrier,” “component carrier,” “cell,” and “channel” may be used interchangeably herein. Carrier aggregation may be used with both FDD and TDD component carriers.

In an LTE/LTE-A network, a UE 115 may be configured to communicate using up to five CCs when operating in a carrier aggregation mode or dual-connectivity mode. One or more of the CCs may be configured as a DL CC, and one or more of the CCs may be configured as a UL CC. Also, one of the CCs allocated to a UE 115 may be configured as a primary CC (PCC), and the remaining CCs allocated to the UE 115 may be configured as secondary CCs (SCCs).

Both the quantity of high-bandwidth traffic being delivered to UEs through mobile CDNs, and the percentage of all mobile CDN traffic that is high-bandwidth traffic, are increasing. Currently, a significant portion of the high-bandwidth traffic is video traffic.

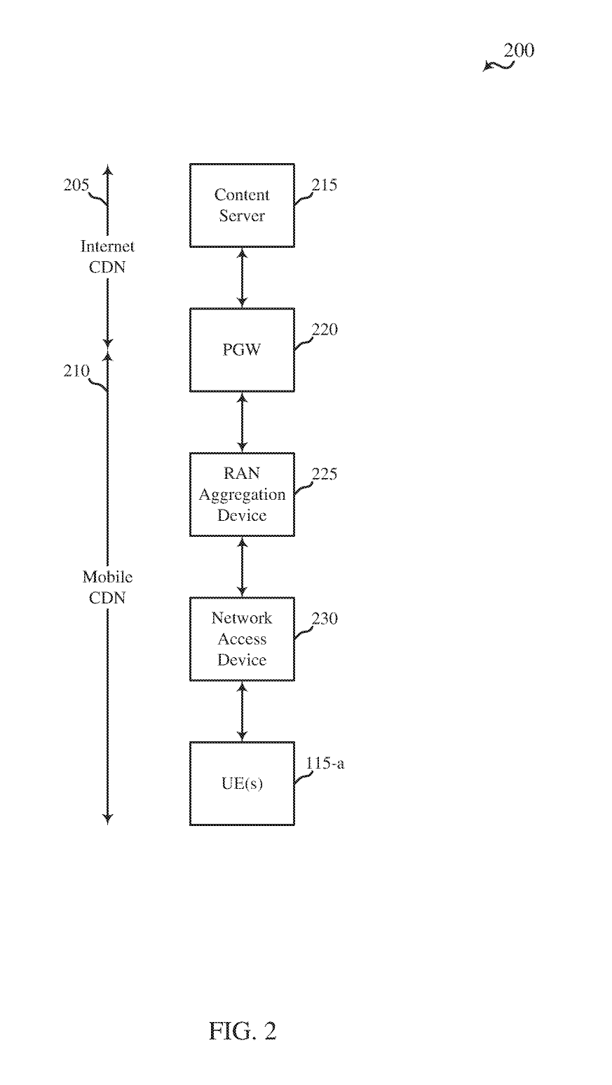

FIG. 2 shows an example CDN 200, in accordance with various aspects of the present disclosure. The CDN 200 includes an Internet CDN 205 (or Over-the-Top (OTT) CDN) and a mobile CDN 210. The Internet CDN 205 may extend between a content server 215 and a packet gateway (PGW 220), and the mobile CDN 210 may extend between the PGW 220 and a number of UEs 115-a. The mobile CDN 210 may include a radio access network (RAN) aggregation device 225, a network access device 230 (e.g., a base station or eNB), and the UEs 115-a. The PGW 220 may be considered part of the Internet CDN 205, and may provide a demarcation point between the Internet CDN 205 and the mobile CDN 210. The network access device 230 may be an example of aspects of the base stations 105 described with reference to FIG. 1, and the UEs 115-a may be an example of aspects of the UEs 115 described with reference to FIG. 1.

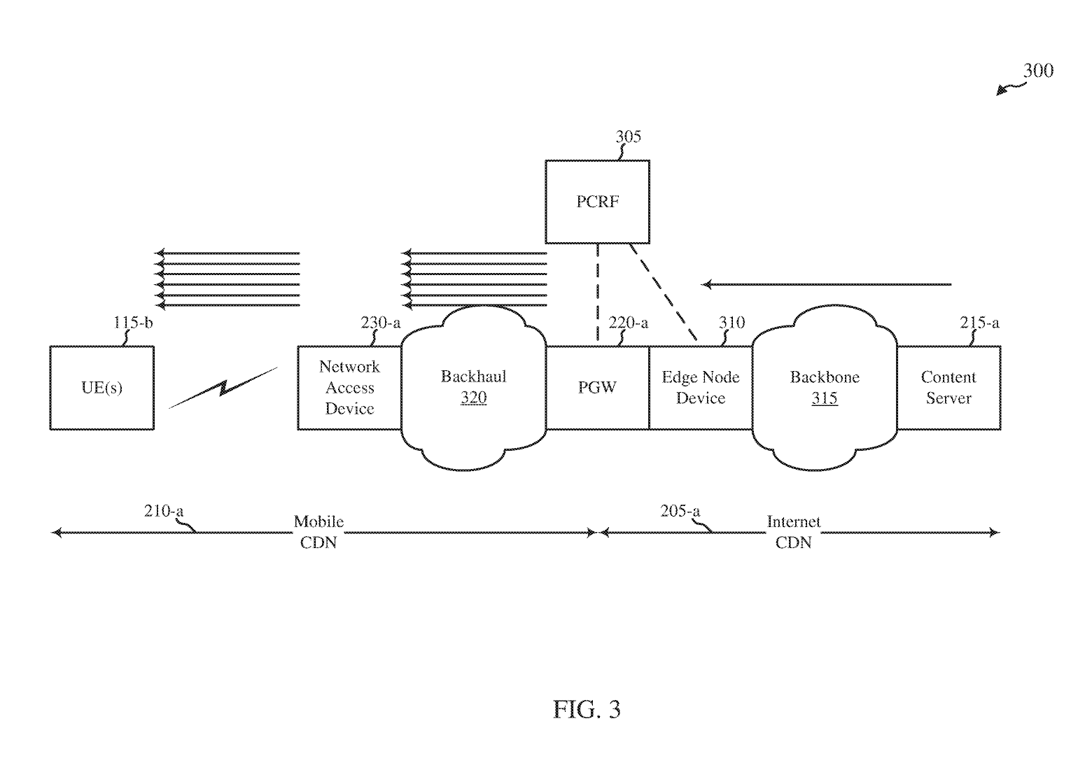

FIG. 3 shows an example CDN 300, in accordance with various aspects of the present disclosure. The CDN 300 may be an example of aspects of the CDN 200 described with reference to FIG. 2, and may include an Internet CDN 205-a and a mobile CDN 210-a. The Internet CDN 205-a may include a content server 215-a and a policy server (PCRF) 305, and the mobile CDN 210-a may include a PGW 230-a, a network access device 230-a (e.g., a base station or eNB), and a number of UEs 115-b. The PCRF 305 may connect to the PGW 220-a and an edge node device 310 over a control interface, and may provide policies for managing the PGW 220-a and the edge node device 310. The network access device 230-a may be an example of aspects of the base stations 105 or network access device 230 described with reference to FIGS. 1 and 2, and the UEs 115-a may be an example of aspects of the UEs 115 described with reference to FIGS. 1 and 2.

To reduce the number of times content is requested from the content server 215-a, over a backbone 315 of the Internet CDN 205-a, content stored at the content server 215-a may be cached at the edge node device 310 (e g., a server). As shown in FIG. 3, the edge node device 310 may be located at or near the PGW 220-a. In some examples, the edge node device 310 may share resources with the PGW 220-a.

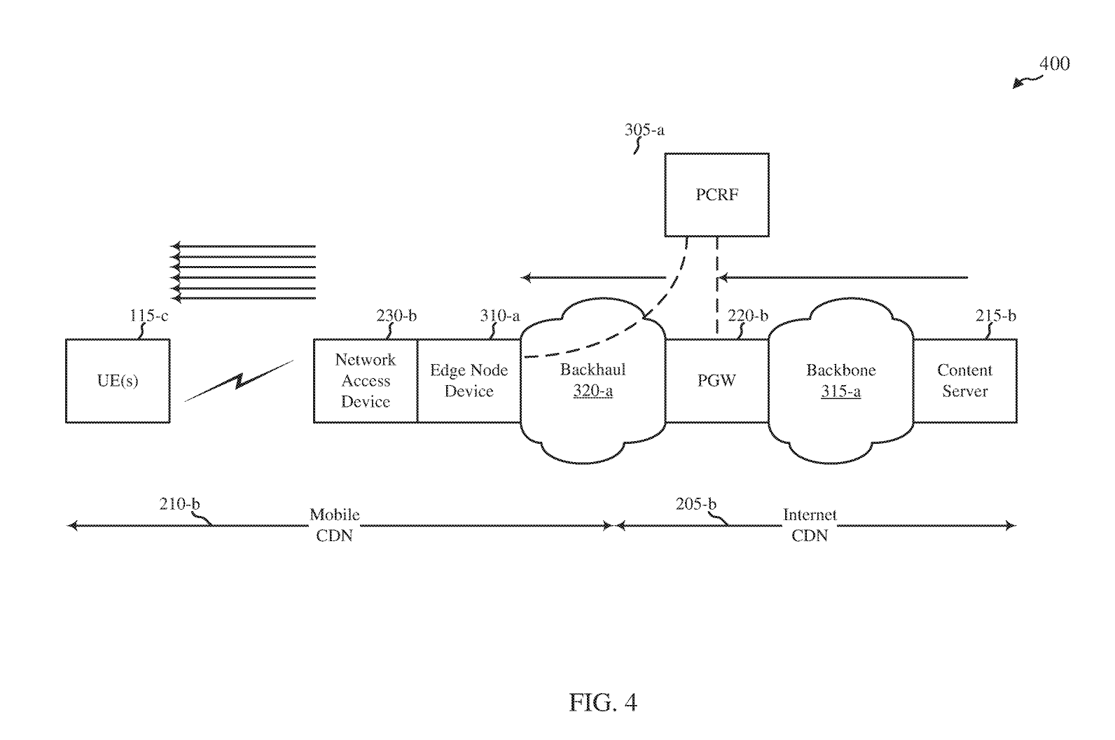

Traffic between the UEs 115-b and the network access device 230-a, and traffic between the network access device 230-a and the edge node device 310 (e.g., the traffic over a backhaul 320 of the mobile CDN 210-a), may increase more or less linearly with the number of content requests received from the UEs 115-b at the network access device 230-a. As illustrated by arrows showing the flow of content from the content server 215-a to the UEs 115-b, the volume of content transferred over the backhaul 320 and to the UEs 115-b (e.g., over the backhaul 320 of the mobile CDN 21-a) may be significantly greater than the volume of content transferred between the content server 215-a and the PGW 220-a (e.g., over the backbone 315 of the Internet CDN 205-a). One solution for managing congestion of the backhaul 320 is to deploy more backhaul resources (increasing cost). Another solution for managing congestion of the backhaul 320 is described with reference to FIG. 4.

FIG. 4 shows an example CDN 400, in accordance with various aspects of the present disclosure. The CDN 400 may be an example of aspects of the CDN 200 described with reference to FIG. 2, and may include an internet CDN 205-b and a mobile CDN 210-b. The Internet CDN 205-b may include a content server 215-b and a policy server (PCRF) 305-a, and the mobile CDN 210-b may include a PGW 220-b, a network access device 230-b (e.g., a base station or eNB), and a number of UEs 115-c. The PCRF 305-a may connect to the PGW 220-b and an edge node device 310-a over a control interface, and may provide policies for managing the PGW 220-b and the edge node device 310-a. The network access device 230-b may be an example of aspects of the base stations 105 or network access device 230 described with reference to FIGS. 1 and 2, and the UEs 115-b may be an example of aspects of the UEs 115 described with reference to FIGS 1 and 2.

To reduce the number of times content is requested from the content server 215-b, over a backbone 315-a of the Internet CDN 205-b, or over a backhaul 320-a of the mobile CDN 210-b, content stored at the content server 215-b may be cached at the edge node device 310-a (e.g., a server). As shown in FIG. 4, the edge node device 310-a may be located at or near the network access device 230-b. In some examples, the edge node device 310-a may share resources with the network access device 230-b.

Traffic between the UEs 115-c and the network access device 230-b may increase more or less linearly with the number of content requests received from the UEs 115-c at the network access device 230-b. As illustrated by arrows showing the flow of content from the content server 215-b to the UEs 115-c, the volume of content transferred to the UEs 115-c may be significantly greater than the volume of content transferred between the content server 215-b and the PGW 220-b (e.g., over the backbone 315-a of the Internet CDN 205-b) and the volume of content transferred between the PGW 210-b and the network access device 230-b (e.g., over the backhaul 320-a of the mobile CDN 210-b).

Caching content at the edge node device 310-a, at or near the network access device 230-b, can reduce content delivery delays (e.g., by reducing content transmission latencies), and can decrease the probability of content playback interruptions, thereby improving end-user experiences, at the UEs 115-c. Caching content at the edge node device 310-a can also decrease the probability of having to make duplicate content transmissions over the backhaul 320-a. To enable the UEs 115-c to obtain the content cached at the edge node device 310-a, the UEs 115-c may be configured to include mobile CDN content delivery acceleration information with their requests to access content. The mobile CDN content delivery acceleration information may assist the network access device 230-b in routing content requests to the edge node device 310-a instead of the content server 215-b.

For purposes of this description, the edge node device 310 described with reference to FIG. 2 may be considered an example of an edge node device located at or above a PGW, within an Internet CDN, or at an edge of an Internet CDN. The edge node device 310-a described with reference to FIG. 3 may be considered an example of an edge node device located below a PGW or within a mobile CDN.

HTTPs (e.g., HTTP over SSL or HTTP Secure) may be used to securely transfer content from device-to-device within a CDN. HTTPs may be used to authorize and secure transactions over SSL/TLS. HTTPs may be used to encrypt and decrypt user requests to access content (e.g., websites or webpages and the content associated therewith), as well as the content that is returned to the user from a content server (e.g., a web server). The use of HTTPs may protect against eavesdropping and man-in-the-middle attacks, for example. The use of HTTPs may be indicated to a user in various ways, such as, by a lock icon in a browser bar, or a website address starting with https:// and/or a website address displayed in green text.

HTTPs may be associated with different levels of validation, including domain validation (DV), organization validation (OV), or extended validation (EV). Domain validation may include a certificate authority (CA) only validating the ownership of a domain name through simple channels, such as E-mail, and issuing a validation certificate (certificate) that includes “no O” (no organization) in the subject of the certificate. Organization validation may include a CA validating the ownership of a domain name and issuing a certificate that includes an “O” (organization) in the subject of the certificate. Extended validation may include a CA validating additional aspects of the ownership of a domain name.

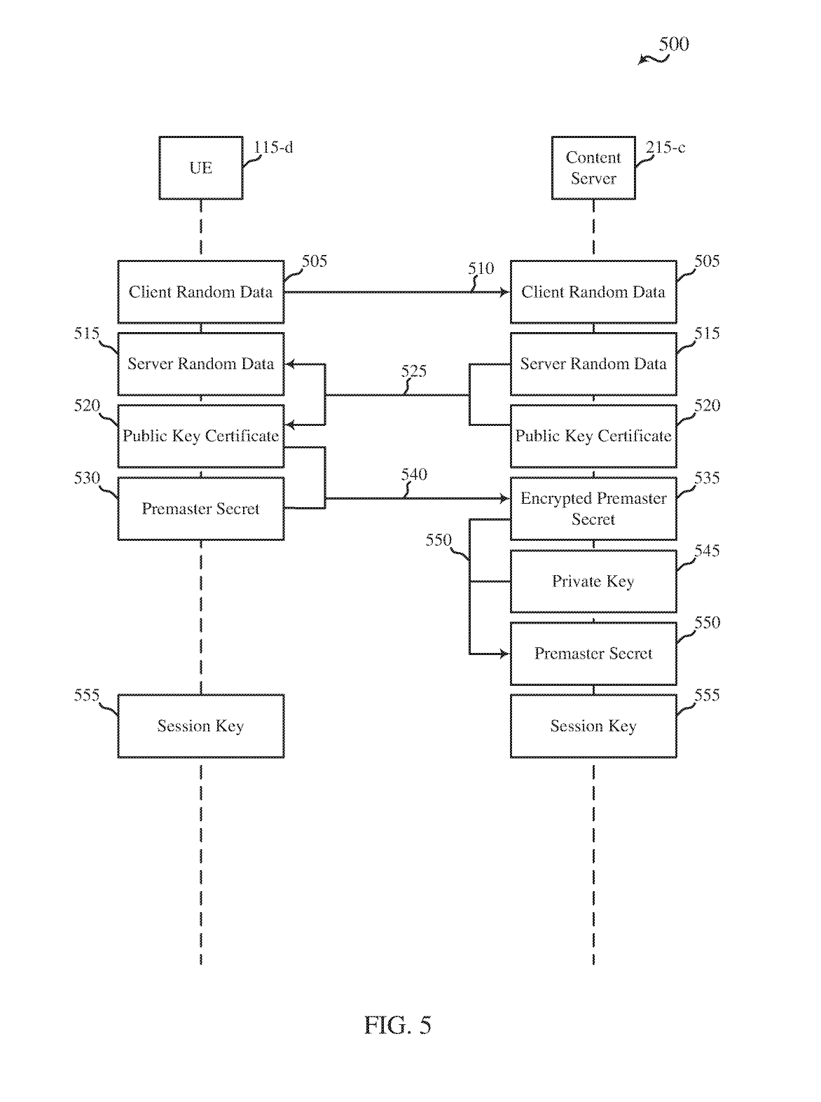

FIG. 5 shows a message flow 500 for configuring an HTTPs session (e.g., performing a SSL handshake based on RSA) between a browser of a UE 115-d and a content server 215-c (e.g., a web server), in accordance with various aspects of the present disclosure. The UE 115-d may be an example of aspects of the UEs 115 described with reference to FIGS. 1-4. The content server 215-c may be an example of aspects of the content servers 215 described with reference to FIGS. 2-4.

To initiate configuration of the HTTPs session, the browser of the UE 115-d may transmit to the content server 215-c, in a message 510, client random data 505, a hello, and an indication of cipher suites supported by the browser of the UE 115-d. In response to receiving the client random data 505, the content server 215-c may transmit to the browser of the UE 115-d, in a message 525, server random data 515, a public key certificate 520, and a session ID for session resumption.

In response to receiving the server random data 515, the browser of the UE 115-d may encrypt a premaster secret 530 using the public key certificate 520 and transmit an encrypted premaster secret 535 to the content server 215-c in a message 540. In response to receiving the encrypted premaster secret 535, the content server 215-c may use a private key 545 corresponding to the public key certificate 520 to decrypt the encrypted premaster secret 535 at 550.

The browser of the UE 115-d and the content server 215-c may each generate a session key 550 based at least in part on the client random data 505, the server random data 515, and the premaster secret 530. Following generation of the session key 555, the browser of the UE 115-d may securely request content from the content server 215-c. In some examples, the content server 215-c may transmit to the browser of the UE 115-d a session ticket corresponding to the session key 555, which session ticket may be used for session resumption or continuance.

The content server 215-c may obtain the public key certificate from a CA that validates (verifies) the identity and/or authenticity of the content (e.g., a website) provided by the content server 215-c. The content server 215-c (or content owner) may be required to periodically update the public key certificate.

As previously mentioned, a CA may provide different kinds of certificates, such as a DV certificate, an OV certificate, or an EV certificate. A CA may also provide certificates for different numbers of domains. For example, a CA may provide a single domain certificate, a wildcard certificate, or a multi-domain certificate. A wildcard certificate may correspond to a domain such as “*.youdomain.com”, where the wildcard “*” may indicate an unlimited number of prefix or subdomain names sharing the same domain name. A multi-domain certificate (also referred to as a Subject Alternative Name (SAN) certificate or Single Communication Certificate (UCC)) may include multiple Fully Qualified Domain Names (FQDNs) in one certificate. A multi-domain certificate may include a standard Subject Name field which supports a single primary web-based service name. A CA may also provide certificates for different numbers of customers, such as a custom certificate for a single customer or a shared certificate shared by multiple customers.

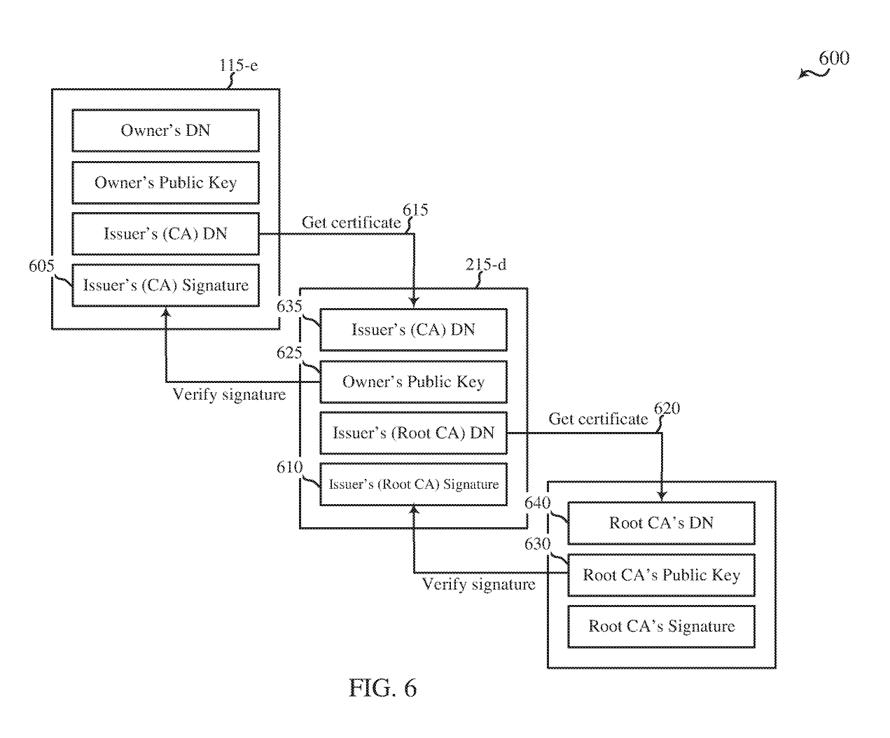

FIG. 6 shows a certificate verification procedure 600, in accordance with various aspects of the present disclosure. In accordance with the certificate verification procedure 600, a client (e.g., a UE 115-e or content server 215-d) may apply a signature algorithm in a server certificate to sign the server certificate excluding the certificate issuer's signature (e.g., the Issuer's (CA) signature 605 or Issuer's (Root CA) signature) 610. The client may then get the issuer's certificate (at 615 or 620), apply the owner's public key 625 or 630 in the Issuer's (CA) domain name (DN) certificate 635 or Root CA's DN certificate 640, and decrypt the issuer's signature (e.g., the Issuer's (CA) signature 605; or Issuer's (Root CA) signature 610) in the server certificate. The client may then compare the signature part of the server certificate to the decrypted issuer's signature. If there is a match, the server certificate may be trusted, and the owner's public key in the server certificate can be used to setup a TLS session (e.g., to encrypt a client-generated premaster secret (or premaster key)). If there is no match, the server certificate may not be trusted.

When HTTPs is applied to a CDN including both an Internet CDN and a mobile CDN, and when content stored at a content server of the Internet CDN is cached at an edge node device within the mobile CDN, HTTPs may include a front-end HTTPs session (e.g., a front-end TLS/SSL session) between a UE and the edge node device, and a back-end HTTPs session (e.g., a back-end TLS/SSL session) between the edge node device and the content server.

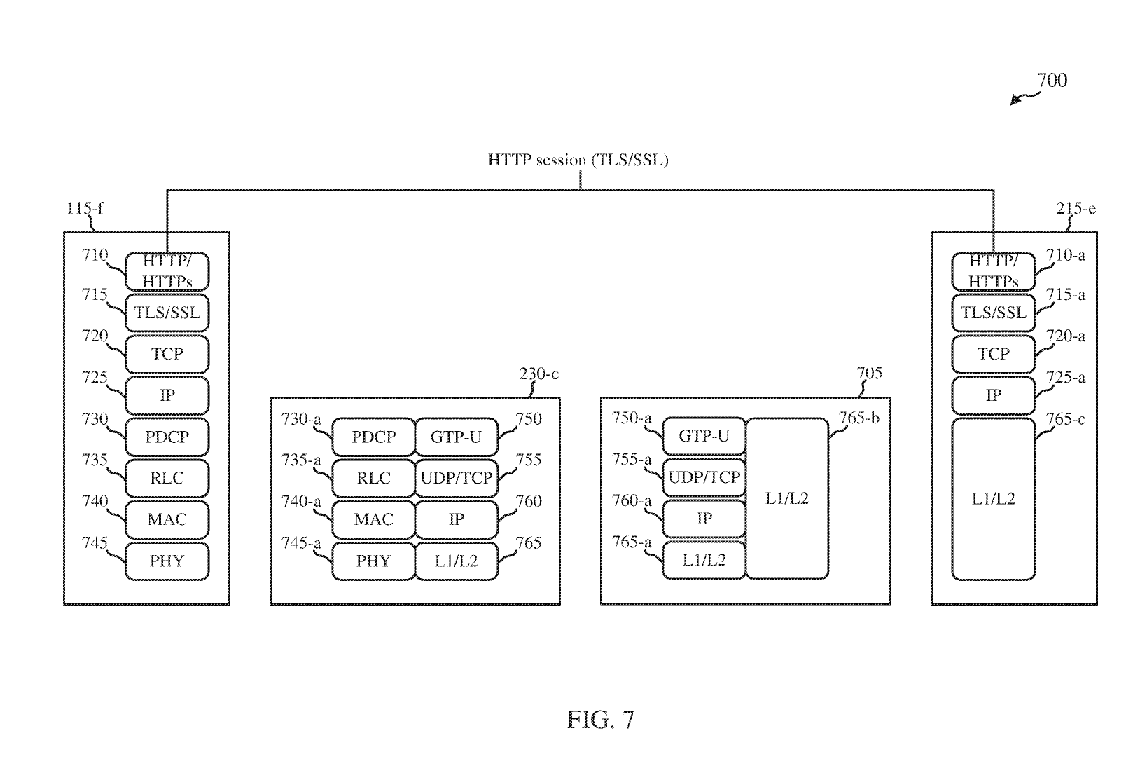

FIG. 7 shows example protocol stacks 700 of a UE 115-f, a network access device 230-c, a PGW/serving gateway (SGW) 705, and a content server 215-e, and illustrates an example of a single HTTPs session (e.g., a single TLS/SSL session) within a CDN, in accordance with various aspects of the present disclosure. The UE 115-f may be an example of aspects of the UEs described with reference to FIGS. 1-6. The network access device 230-c may be an example of aspects of the base stations 105 or network access device 230 described with reference to FIGS. 1-4. The PGW/SGW 705 may be an example of aspects of the PGW 220 described with reference to FIGS. 2-4. The content server 215-e may be an example of aspects of the content servers 215 described with reference to FIGS. 2-6.

The protocol stack of the UE 115-f may include higher level layers (e.g., UE operating system (OS)/browser layers) for communicating with the content server 215-e in an HTTPs session (e.g., a TLS/SSL session), and lower level layers (e.g., modem layers) for communicating with the network access device 230-c. The higher level layers may include an HTTP/HTTPs layer 710, a TLS/SSL layer 715, a TCP layer 720, and an IP layer 725. The lower level layers may include a PDCP layer 730, a RLC layer 735, a MAC layer 740, and a PHY layer 745. The protocol stack of the network access device 230-c may include lower level layers for communicating with the UE 115-f, and lower level layers for communicating with the PGW/SGW 705. The lower level layers for communicating with the UE 115-f may include a PDCP layer 730-a, a RLC layer 735-a, a MAC layer 740-a, and a PHY layer 745-a. The lower level layers for communicating with the PGW/SGW 705 may include a GTP-U layer 750, a UPP/TCP layer 735, an IP layer 760, and L1/L2 layers 765. The protocol stack of the PGW/SGW 705 may include lower level layers for communicating with the network access device 230-c, and lower level layers for communicating with the content server 215-e. The lower level layers for communicating with the network access device 230-c may include a GTP-U layer 756-a, a UDP/TCP layer 755-a, an IP layer 760-a, and L1/L2 layers 765-a. The lower level layers for communicating with the content server 215-e may include L1/L2 layers 765-b. The content server 215-e may include lower level layers for communicating with the PGW/SGW 705, and higher level layers for communicating with the UE 115-f in an HTTPs session (e.g., a TLS/SSL session). The lower level layers may include L1/L2 layers 765-c. The higher level layers may include an HTTP/HTTPS layer 710-a, a TLS/SSL layer 715-a, a TCP layer 720-a, and an IP layer 725-a.

A single HTTPs session (e.g., a single TLS/SSL session) may be negotiated between the UE 115-f and the content server 215-e using the higher level layers (e.g., the HTTP/HTTPs layer 710/710-a, the TLS/SSL layer 715/715-a, the TCP layer 720/720-a, and the IP layer 725/25-a). The network access device 230-c and PGW/SGW 705 may be largely unaware of the communications at the higher level layers.

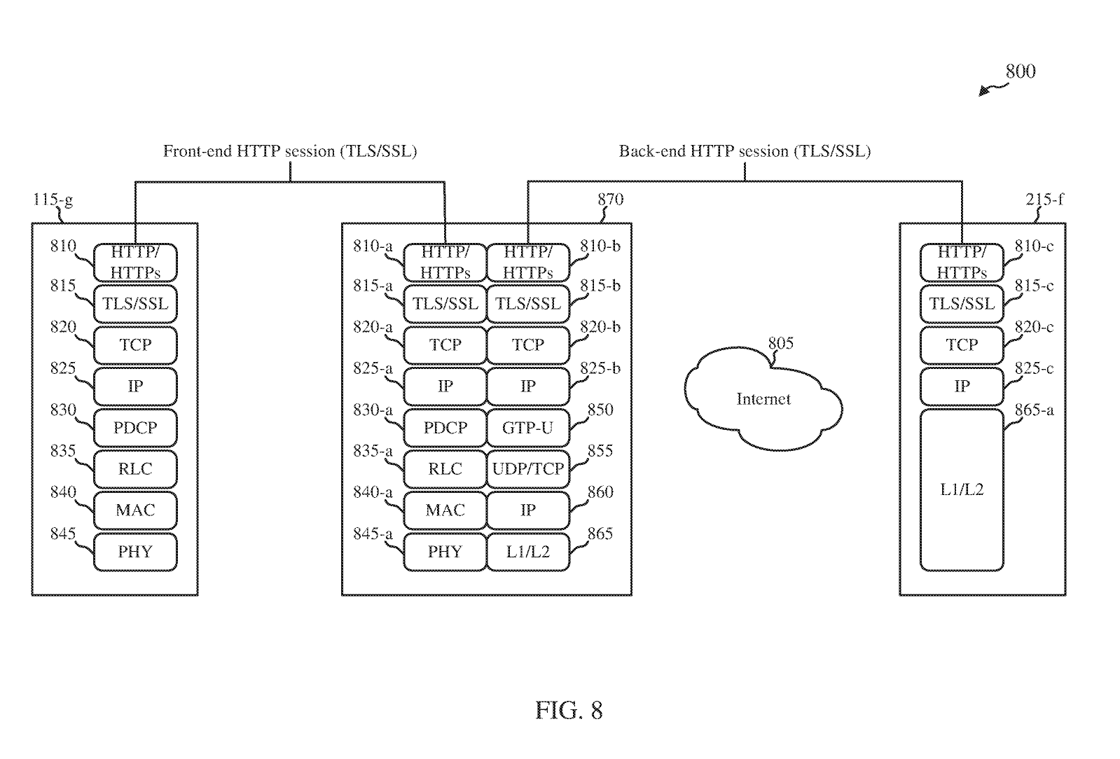

FIG. 8 shows example protocol stacks 800 of a UE 115-g, a network access device and edge node device 870, a router/switching network 805, and a content server 215-f, and illustrates an example of front-end and back-end HTTPs sessions (e.g., a front-end TLS/SSL session and a back-end TLS/SSL session) within a CDN, in accordance with various aspects of the present disclosure. The UE 115-g may be an example of aspects of the UEs described with reference to FIGS. 1-6. The network access device and edge node device 870 may be an example of aspects of the base stations 105 or network access device 230 described with reference to FIGS. 1-4 and aspects of the edge node devices 310 described with reference to FIGS. 2-4. The network access device and edge node device may be collocated (as shown) or separately located. The content server 215-f may be an example of aspects of the content servers 215 described with reference to FIGS. 2-6.

The protocol stack of the UE 115-g may include higher level layers (e.g., UE OS/browser layers) for communicating with the network access device and edge node device 870 in a front-end HTTPs session (e.g., a front-end TLS/SSL session), and lower level layers (e.g., modem layers) for communicating with the network access device and edge node device 870. The higher level layers may include an HTTP/HTTPs layer 810, a TLS/SSL layer 815, a TCP layer 820, and an IP layer 825. The lower level layers may include a PDCP layer 830, a RLC layer 835, a MAC layer 840, and a PHY layer 845. The protocol stack of the network access device and edge node device 870 may include higher level layers and lower level layers for communicating with the UE 115-g, and higher level layers and lower level layers for communicating with the content server 215-f. The lower level layers for communicating with the UE 15-g may include a PDCP layer 830-a, a RLC layer 835-a, a MAC layer 840-a, and a PHY layer 843-a. The higher level layers for communicating with the UE 115-g may include an HTTP/HTTPs layer 810-a, a TLS/SSL layer 815-a, a TCP layer 820-a, and an IP layer 825-a. The higher level layers for communicating with the content server 215-f may include an HTTP/HTTPs layer 810-b, a TLS/SSL layer 815-b, a TCP layer 820-b, and an IP layer 825-b. The lower level layers for communicating with the content server 215-f may include a GTP-U layer 850, a UDP/TCP layer 855, an IP layer 860, and L1/L2 layers 865. The content server 215-f may include higher level layers and lower level layers for communicating with the network access device and edge node device 870. The lower level layers may include L1/L2 layers 865-a. The higher level layers may include an HTTP/HTTPs layer 810-c, a TLS/SSL layer 815-c, a TCP layer 820-c, and an IP layer 825-c. The back-end HTTPs session (e.g., the back-end TLS/SSL session) may be established through a router/switching network 805 such as the Internet.

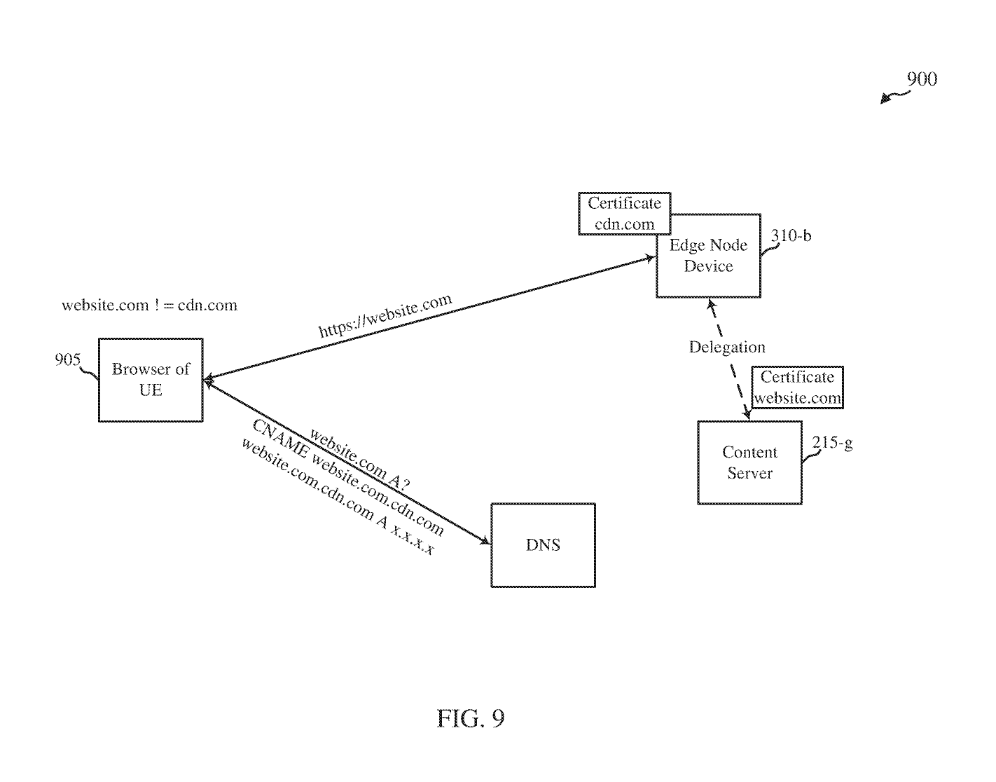

When HTTPs is applied to a CDN (e.g., a CDN including both an Internet CDN and a mobile CDN), various issues may arise. For example, there may be HTTPs authentication issues, HTTPs encryption issues, or TLS session resumption/continuation issues. An HTTPs authentication issue may arise as a result of HTTPs being divided into a front-end HTTPs session and a back-end HTTPs session, as described with reference to FIG. 9.

FIG. 9 shows a diagram 900 of a browser 905 of a UE requesting content that the browser 905 does not know to be cached at an edge node device 310-b of a mobile CDN, in accordance with various aspects of the present disclosure. The UE may be an example of aspects of the UEs 115 described with reference to FIGS. 1-8. The edge node device 310-b may be an example of aspects of the edge node devices 310 or network access device and edge node device 870 described with reference to FIGS. 2-4, 7, and 8. In some examples, the edge node device may be collocated with, or separate from, a network access device of the mobile CDN. A content server 215-g may be an example of aspects of the content servers 215 described with reference to FIGS. 2-8.

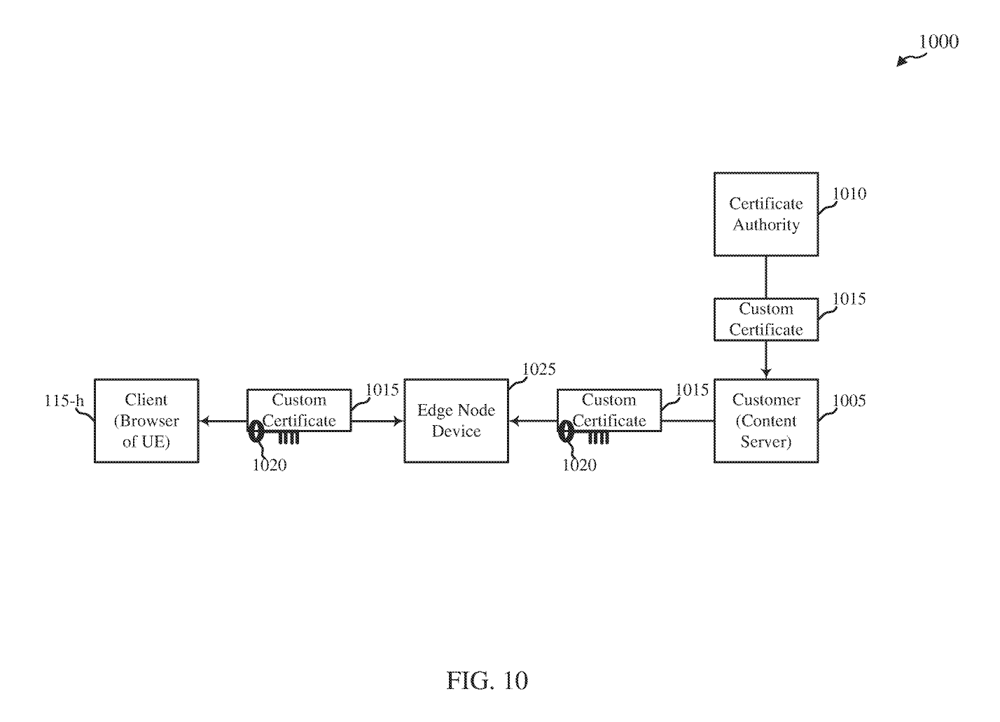

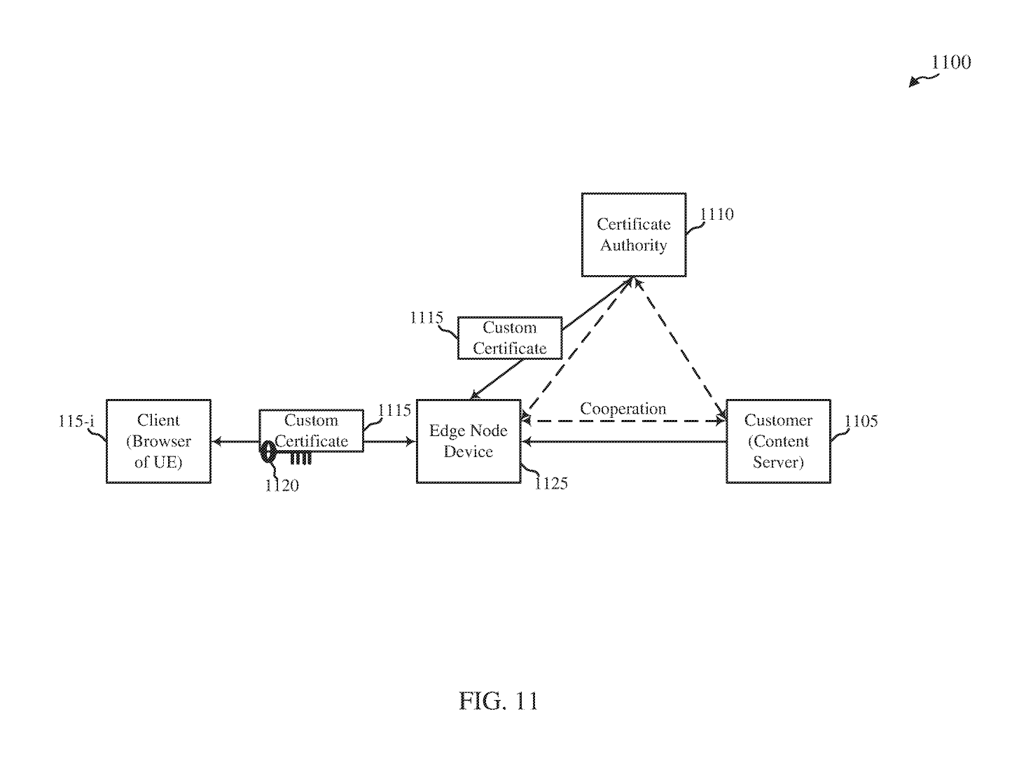

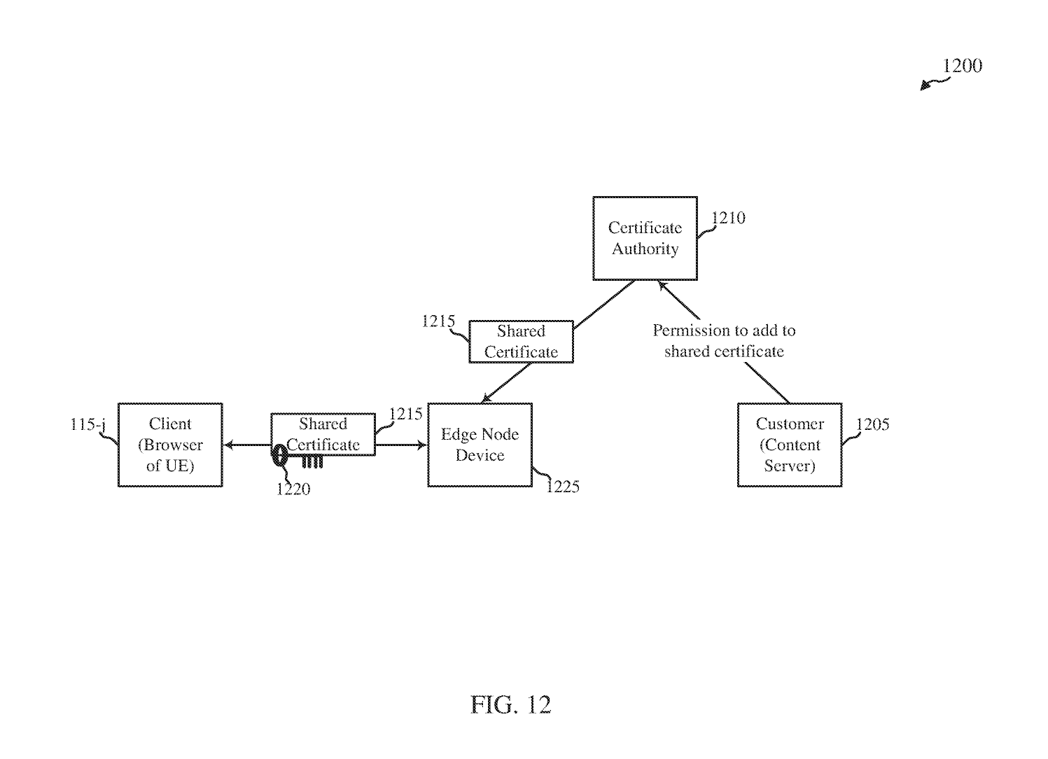

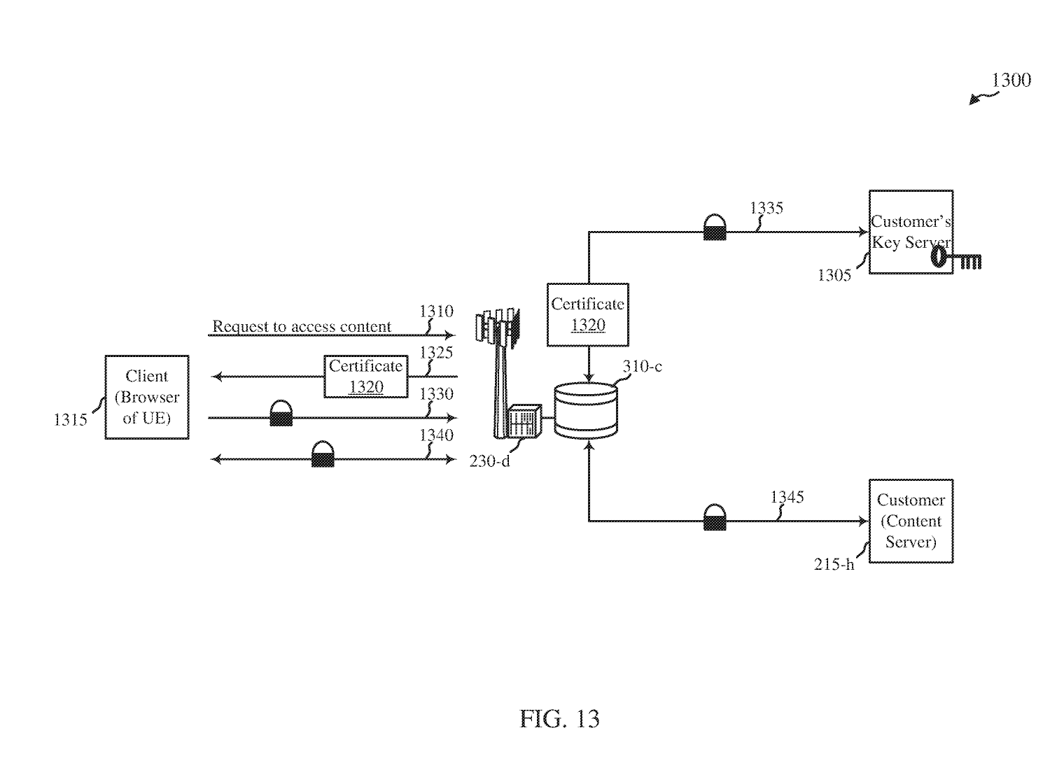

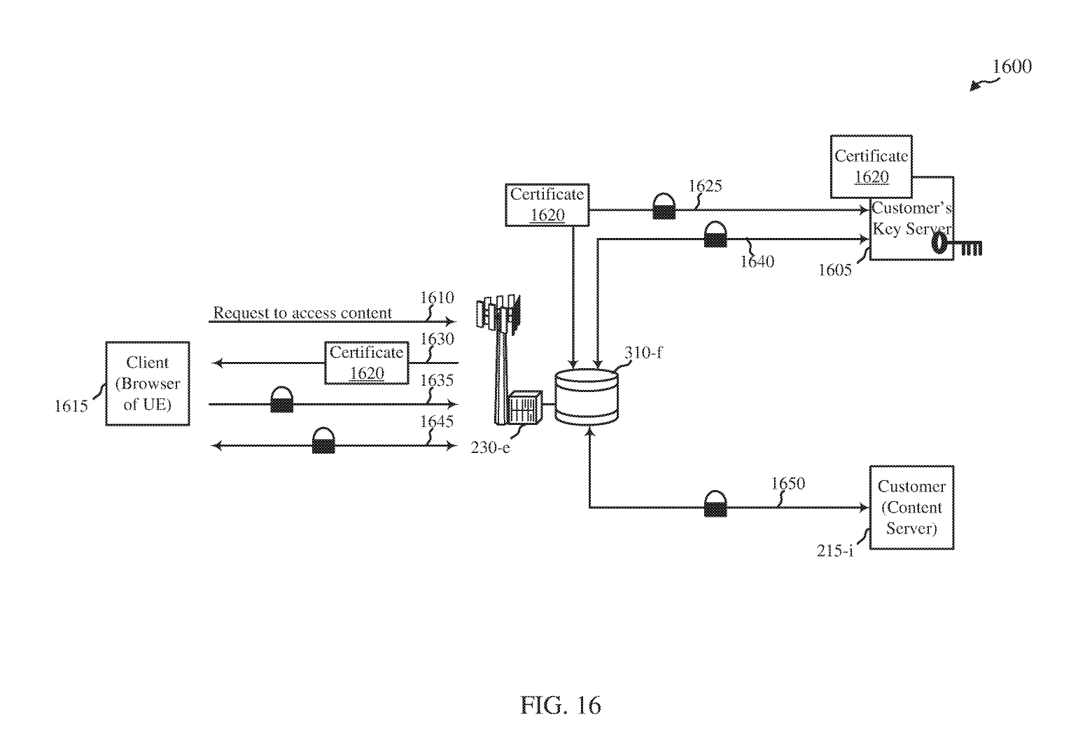

An HTTPs authentication issue may arise as a result of HTTPs being divided into a front-end HTTPs session (e.g., between the browser 905 of the UE and the edge node device 310-b) and a back-end HTTPs session (e.g., between the edge node device 310-b and the content server 215-g), and the browser not knowing that the content server 215-g (or a website hosted on the content server 215-g) has delegated the handling of requests for content to the edge node device 310-b. Thus, instead of the browser 905 issuing a request to access content to “website.com”, a website for which the handling of requests for content has been delegated to the edge node device 310-b, and instead of the browser 905 establishing an HTTPs session with the content server 215-g hosting “website.com”; the browser 905 should issue a request to access the content of “website.com.cdn.com” (associated with the HTTPs server IP address “x.x.x.x”), and should establish an HTTPs session with the edge node device 310-b. Such an HTTPs authentication issue may be mitigated in a number of ways, including: using custom certificate HTTPs authentication, as described with reference to FIGS. 10 and 11; using shared certificate HTTPs authentication, as described with reference to FIG. 12; using keyless HTTPs authentication, as described with reference to FIGS. 13-15; or using certificateless HTTPs authentication, as described with reference to FIG. 16.

FIG. 10 shows a first custom certificate HTTPs authentication scenario 1000, in accordance with various aspects of the present disclosure. The scenario 1000 assumes that a customer 1005 (e.g., a content server or content provider) applies to a CA 1010 for a certificate for its website, and receives a custom certificate 1015. The customer 1005 then generates a private key 1020 based on the custom certificate 1015, and maintains the custom certificate 1015 and private key 1020.

When delegating the handling of content requests to the edge node device 1025, which edge node device 1025 may be located above or below a PGW, the customer 1005 may transfer the custom certificate 1015 and private key 1020 to the edge node device 1025 (or to the operator of the edge node device 1025). When a browser of a UE 115-h issues a request to access content of the customer's website, the edge node device 1025 may handle the request, and may use the custom certificate 1015 and private key 1020 to authenticate itself as the UE 115-h attempts to establish an HTTPs session with the edge node device 1025.

A potential advantage of the scenario 1000 is that the customer 1005 may control the validation level (e.g., DV, OV, EV) associated with the custom certificate 1015. A potential disadvantage of the scenario 1000 is that the customer 1005 has to share a private key with the edge node device 1025, which may be undesirable if the edge node device is within a mobile CDN and not under the control of the customer 1005. Also, the scenario 1000 may involve heavy key management overhead (including heavy key revocation overhead).

FIG. 11 shows a second custom certificate HTTPs authentication scenario 1100, in accordance with various aspects of the present disclosure. The scenario 1100 assumes that an edge node device 1125 (or operator of the edge node device 1125) that has been delegated the task of handling content requests for a customer 1105 (e.g., a content server or content provider) cooperates with the customer 1105 to apply to a CA 1110 for a certificate for the customer's website, and that the edge node device 1125 (or operator of the edge node device 1125) receives a custom certificate 1115 from the CA 1110 for the customer's website. The edge node device 1125 (or operator of the edge node device 1125) then generates a private key 1120 based on the custom certificate 1115, and maintains the custom certificate 1115 and private key 1120. In some examples, the customer 1105 and edge node device 1125 (or operator of the edge node device 1125) may obtain different certificates from the CA 1110 and use different corresponding private keys.

The edge node device 1125 may be located above or below a PGW. When a browser of a 115-i issues a request to access content of the customer's website, the edge node device 1125 may handle the request, and may use the custom certificate 1115 and private key 1120 to authenticate itself as the UE 115-i attempts to establish an HTTPs session with the edge node device 1125.

A potential advantage of the scenario 1100 is that the private key 1120 corresponding to the custom certificate 1115 maintained by the edge node device 1125 (or operator of the edge node device 1125) differs from the private key used by the customer 1105. Furthermore, because of the cooperation between the edge node device 1125 (or operator of the edge node device 1125) and the customer 1105, the customer 1105 may control the validation level (e.g., DV, OV, EV) associated with the custom certificate 1115. A potential disadvantage of the scenario 1100 is that the scenario 1100 may involve heavy key management overhead (including heavy key revocation overhead). The scenario 1100 is similar to a scenario in which the customer 1105 applies to the CA 1110 for multiple certificates, and shares one of the certificates with the edge node device 1125 (or operator of the edge node device 1125).

FIG. 12 shows a shared certificate HTTPs authentication scenario 1200, in accordance with various aspects of the present disclosure. The scenario 1200 assumes that an edge node device 1225 (or operator of the edge node device 1225) that has been delegated the task of handling content requests for a customer 1205 (e.g., a content server or content provider) has been given authority to apply to a CA 1210 to add the domain name of the customer 1205 to a shared certificate 1215 of the edge node device 1225 (or to a shared certificate of an operator of the edge node device 1225). The certificate name (e.g., SAN/UCC certificate name) of the shared certificate 1215 is therefore associated with the edge mode device 1225 (or operator of the edge node device 1225), but the shared certificate 1215 references the domain name of the customer 1205. Assuming the shared certificate's name is “carol.com” and the customer's website is “alice.com”, a web address bar of a browser of a UE 115-j might show the web address “carol.com” in green when accessing the website “alice.com”.

The edge node device 1225 (or operator of the edge node device 1225) may generate a private key 1220 based on the shared certificate 1215, and may maintain the shared certificate 1215 and private key 1220.

The edge node device 1225 may be located above or below a PGW. When the browser of the UE 115-j issues a request to access content of the customer's website, the edge node device 1225 may handle the request, and may use the shared certificate 1215 and private key 1220 to authenticate itself as the UE 115-j attempts to establish an HTTPs session with the edge node device 1225.

A potential advantage of the scenario 1200 is that the shared certificate 1215 and private key 1220 are owned and maintained by the edge node device 1225 (or operator of the edge node device 1225), and the customer 1205 does not need to share its own private key with the edge node device 1225 (or operator of the edge node device 1225). A potential disadvantage of the scenario 1200 is that an improper security indicator may be displayed to a user of the UE 115-j (e.g., a website may use EV, but the edge node device 1225 may use DV/OV. Thus, using a shared certificate could weaken the usefulness of certificates as a security indicator. Furthermore, and similar to a custom certificate, a customer 1205 that allows an edge node device 1225 (or operator of the edge node device 1225) to add its domain name to a shared certificate may not delegate the handling of content requests, or revoke the handling of content requests, independently and efficiently (e.g., because delegating and revoking the delegation of handling content requests involves three entities—the customer 1205, the edge node device 1225 (or operator of the edge node device 1225), and the CA 1210).

In some cases, a customer (e.g., a content server or content provider) that delegates the handling of content requests to an edge node device that is not controlled by the customer may not want to share its private key with the edge node device (e.g., due to company policy, technical obstacles, or security procedures). Keyless HTTPs authentication or certificateless HTTPs authentication may be used in these cases.

FIG. 13 shows a keyless HTTPs authentication scenario 1300, in accordance with various aspects of the present disclosure. The scenario 1300 enables a customer's key server 1305 to be hosted on the customer's infrastructure, giving a customer exclusive access to its private key(s).

At 1310, a client 1315 (e.g., a browser of a UE) may transmit a request to access content of a website (e.g., the website “alice.com”) to an edge node device 310-c. The request may include, for example, a “client hello” message addressed to alice.com. The request may be routed to the edge node device 310-c by a network access device 230-d of a mobile CDN. The edge node device 310-c may be collocated with, or separately located from, the network access device 230-d. In some examples, the request to access the content of the website may be routed to the edge node device 310-c, instead of the content server 215-h, because the request is associated with mobile CDN content delivery acceleration information that the network access device 230-d uses to route the request to the edge node device 310-c.

The edge node device 310-c may hold a certificate 1320 for alice.com, and at 1325 may transmit a “server hello” message with the certificate 1320 to the client 1315. The client 1315 may verify that the certificate 1320 is for alice.com. generate a premaster secret (for RSA), and encrypt the premaster secret based on a public key associated with the certificate 1320. At 1330, the encrypted premaster secret may be transmitted to the edge node device 310-c.

Upon receiving the encrypted premaster secret, and at 1335, the edge node device 310-c may contact the customer's key server 1305, authenticating itself with a certificate. The edge node device 310-c may then transmit the encrypted premaster secret to the customer's key server 1305. The customer's key server 1305 may decrypt the encrypted premaster secret and transmit the premaster secret to the edge node device 310-c over an encrypted tunnel.

At 1340, both the client 1315 and the edge node device 310-c may use the premaster secret to establish a secure connection (e.g., a front-end HTTPs session, including a front-end TLS/SSL session). The edge node device 310-c may then process the request received from the client 1315 at 1310 to access the content of the website. When the content has been cached at the edge node device 319-c, the edge node device 310-c may deliver the content directly to the client 1315. When the content has not been cached at the edge node device 310-c, the edge node device 310-c may request the content from the website (e.g., from the content server 215-h), at 1345, and deliver the content to the client 1315 upon receiving the content from the website. The edge node device 310-c may also cache the content at the edge node device 310-c, and may report the client visit event to the website so that the website may update its access statistics.

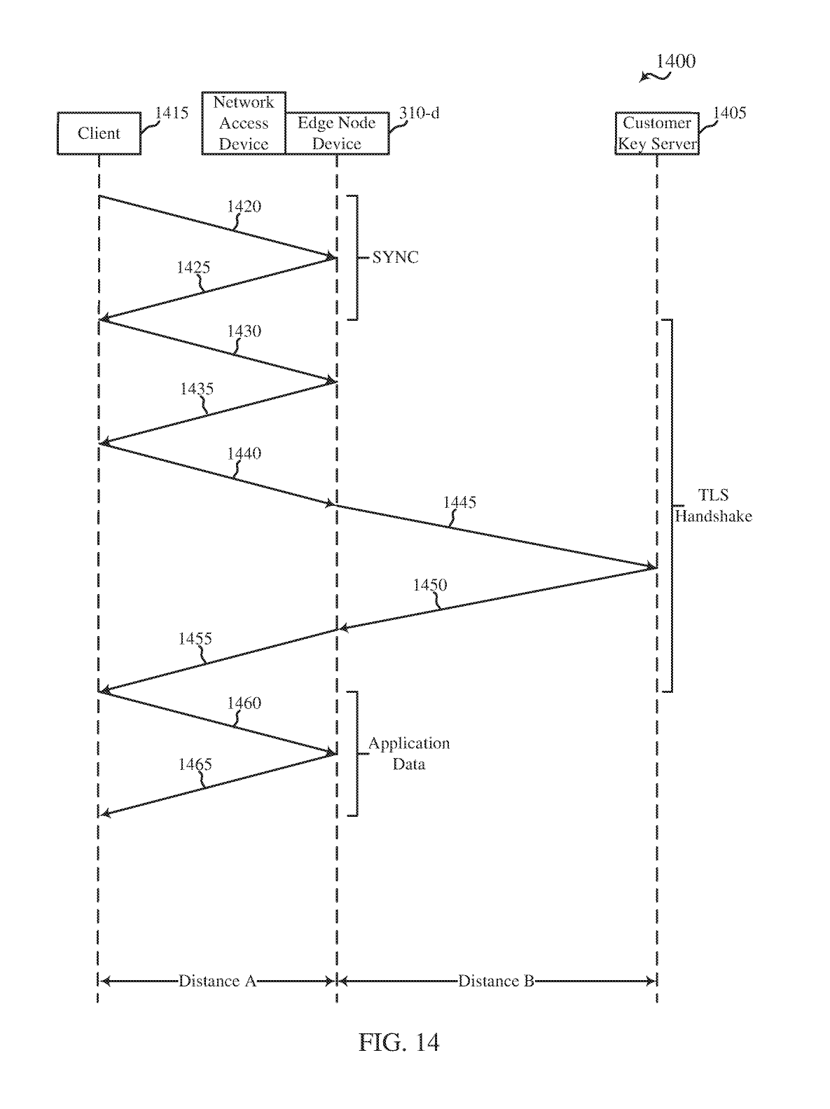

FIG. 14 shows a message flow 1400 in which a client 1415, edge node device 310-d, and customer key server 1405 employ keyless HTTPs authentication, in accordance with various aspects of the present disclosure. By way of example, the edge node device 310-d may be collocated with a network access device located close to the client 1415 (e.g., at a distance A from the client 1415, where A may be 0.5 kilometers (km)), and the customer key server 1405 may be located far front the edge node device 310-d (e.g., at a distance B from the edge node device 310-d, where B may be 150 km).

At 1420 and 1425, the client 1415 and edge node device 310-d may perform a TCP synchronization procedure in which the client 1415 transmits a synchronization (SYNC) signal to the edge node device 310-d (at 1420), and the edge node device 310-d transmits a SYNC signal to the client 1415 (at 1425).

Following the TCP synchronization procedure, the client 1415 and edge node device 310-d may perform a TLS handshake. At 1430, the client 1415 may transmit a client hello message, with a request to access the content of a website, to the edge node device 310-d. At 1435, the edge node device 310-d may transmit a server hello message, with a certificate for the website, to the client 1415. At 1440, the client 1415 may transmit an encrypted premaster secret, based on a public key associated with the certificate for the website, to the edge node device 310-d. At 1445, the edge node device 310-d may forward the encrypted premaster secret to the customer key server 1305, which may return a decrypted premaster secret to the edge node device 310-d at 1450. At 1455, the edge node device 310-d may acknowledge to the client 1415 that the TLS handshake successfully completed. The client 1415 may thereafter request and receive data from the edge node device 310-d (e.g., at 1460 and 1465).

In the message flow 1400, the TCP synchronization and TLS handshake include the transmission of six messages over distance A and the transmission of two messages over distance B, for a total message trip distance of 303 km (i.e., 0.5*6+150*2=303 km).

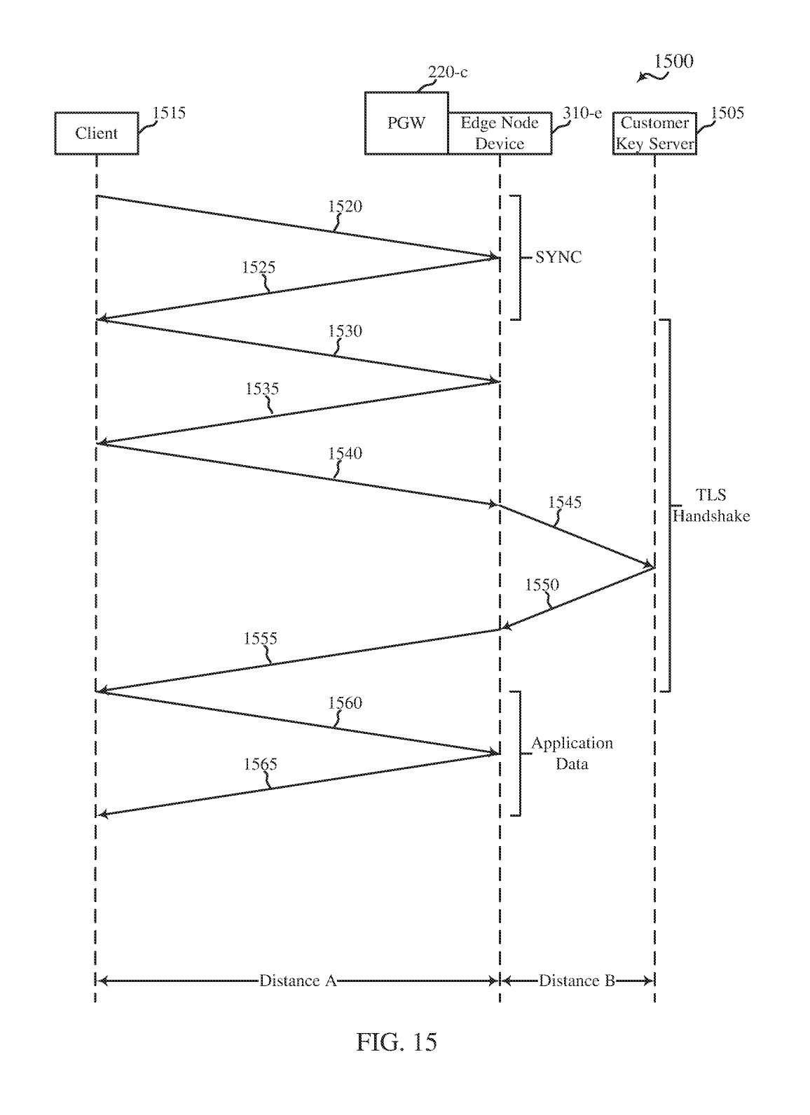

FIG. 15 shows a scenario 1500 in which a client 1515, edge node device 310-e, and customer key server 1505 employ keyless HTTPs authentication, in accordance with various aspects of the present disclosure. By way of example, the edge node device 310-e may be collocated with a PGW 320-c located far from the client 1515 (e.g., at a distance A from the client 1515, where A may be 150 km), and the customer key server 1505 may be located close to the edge node device 310-e (e.g., at a distance B from the edge node device 310-e, where B may be approximately 0 km).

At 1520 and 1525, the client 1515 and edge node device 310-e may perform a TCP synchronization procedure in which the client 1515 transmits a SYNC signal to the edge node device 310-e (at 1520), and the edge node device 310-e transmits a SYNC signal to the client 1515 (at 1525).

Following the TCP synchronization procedure, the client 1515 and edge node device 310-e may perform a TLS handshake. At 1530, the client 1515 may transmit a client hello message, with a request to access the content of a website, to the edge node device 310-e. At 1535, the edge node device 310-e may transmit a server hello message, with a certificate for the website, to the client 1515. At 1540, the client 1515 may transmit an encrypted premaster secret, based on a public key associated with the certificate for the website, to the edge node device 310-e. At 1545, the edge node device 310-e may forward the encrypted premaster secret to the customer key server 1505, which may return a decrypted premaster secret to the edge node device 316-e at 1550. At 1555, the edge node device 310-e may acknowledge to the client 1515 that the TLS handshake successfully completed. The client 1515 may thereafter request and receive data from the edge node device 310-e (e.g., at 1560 and 1565).

In the scenario 1500, the TCP synchronization and TLS handshake include the transmission of six messages over distance A and the transmission of two messages over distance B, for a total message trip distance of 900 km (i.e., 150*6+0*2=900 km). Thus, caching the content of a website at an edge node device located at or near a network access device of a mobile CDN, when using keyless HTTPs authentication, can reduce the duration of the keyless HTTPs authentication significantly (e.g., by approximately 200% with respect to the examples described with reference to FIGS. 14 and 15.

FIG. 16 shows a certificateless HTTPs authentication scenario 1600, in accordance with various aspects of the present disclosure. Similar to the keyless HTTPs authentication scenario 1300, the scenario 1600 enables a customer's key server 1605 to be hosted on the customer's infrastructure, giving a customer exclusive access to its private key(s). In contrast to the scenario 1500, the scenario 1600 also enables the customer's certificate 1620 to be held at the key server 1605.

At 1610, a client 1615 (e.g., a browser of a UE) may transmit a request to access content of a website (e.g., the website “alice.com”) to an edge node device 310-f. The request may include, for example, a “client hello” message addressed to alice.com. The request may be routed to the edge node device 310-f by a network access device 230-e of a mobile CDN. The edge node device 310-f may be collocated with, or separately located from, the network access device 230-e. In some examples, the request to access the content of the website may be routed to the edge node device 310-f, instead of the content server 215-i, because the request is associated with mobile CDN content delivery acceleration information that the network access device 230-e uses to route the request to the edge node device 310-f.

Because the certificate 1620 for alice.com is held at the customer's key server 1605, the edge node device 310-f may authenticate itself with the customer's key server 1605 using a certificate, at 1625, and may request the certificate 1620 for alice.com. The customer's key server 1605 may return the certificate 1620 to the edge node device 310-f. At 1630, the edge node device 310-f may transmit a “server hello” message with the certificate 1620 to the client 1615. The client 1615 may verify that the certificate 1620 is for alice.com, generate a premaster secret (for RSA), and encrypt the premaster secret based on a public key associated with the certificate 1620. At 1635, the encrypted premaster secret may be transmitted to the edge node device 310-f.

Upon receiving the encrypted premaster secret, and at 1640, the edge node device 310-f may transmit the encrypted premaster secret to the customer's key server 1605. The customer's key server 1605 may decrypt the encrypted premaster secret and transmit the premaster secret to the edge node device 310-f over an encrypted tunnel.

At 1645, both the client 1615 and the edge node device 310-f may use the premaster secret to establish a secure connection (e.g., a front-end HTTPs session, including a front-end TLS/SSL session). The edge node device 310-f may then process the request received from the client 1615 at 1610 to access the content of the website. When the content has been cached at the edge node device 310-f, the edge node device 310-f may deliver the content directly to the client 1615. When the content has not been cached at the edge node device 310-f, the edge node device 310-f may request the content from the website (e.g., from the content server 215-i), at 1650, and deliver the content to the client 1615 upon receiving the content from the website. The edge node device 310-f may also cache the content at the edge node device 310-f, and may report the client visit event to the website so that the website may update its access statistics.

When HTTPs is applied to a CDN (e.g., a CDN including both an Internet CDN and a mobile CDN), and when content stored at a content server of the Internet CDN is cached at an edge node device within the mobile CDN, another issue that may arise is an HTTPs encryption issue. An HTTPs encryption issue may arise as a result of a TLS session key being generated above the TCP layer, at a TLS/SSL layer which is invisible to a UE's modem. For mobile CDN content delivery acceleration information (e.g., uplink assistant information) to be selectively associated with such requests, so that selected requests can be routed to an edge node device that caches the content closer to the UE (instead of to a content server (e.g., a web server) that stores the content), a UE's modem needs to know the uplink HTTP content of such requests. For example, the UE's modem needs to know whether the HTTP content includes an HTTP Get message for a URL for which content is cached at the edge node device. One way to expose the HTTP content to the modem, so that the modem can selectively associate mobile CDN content delivery acceleration information with requests to access the content of websites, is to employ UE-assisted selective content delivery acceleration based on an authorized content provider list (ACPL). Another way to expose the HTTP content to the modem is to employ UE-assisted selective content delivery acceleration based on out-of-band messaging.

With UE-assisted selective content delivery acceleration based on an ACPL, a UE may maintain an ACPL. The ACPL may be pre-configured to the UE by a PLMN via an OMA-DM, by RRC/NAS signaling (e.g., a RRC/NAS message), or broadcast information. In some examples, the ACPL may include a number of content provider entries, and each content provider entry may be associated with one or more parameters such as: a uniform resource locator (URL), a uniform resource identifier (URI), a domain name, a hypertext transfer protocol (HTTP) server internet protocol (IP) address, a port identifier, a protocol type, or a combination thereof. The UE may process requests to access the content of websites at a modem of the UE, and upon determining that information associated with a request is included in the ACPL, may associate mobile CDN content delivery acceleration information with the request. The UE may then transmit the request and the associated mobile CDN content delivery acceleration information to a base station.

In some embodiments of UE-assisted selective content delivery acceleration based on ACPL, an HTTP server IP address included in the ACPL may be pre-configured by a PLMN. In some embodiments, an HTTP server IP address included in the ACPL may be dynamically updated. For example, a modem of a UE may monitor HTTP server IP addresses associated with DNS requests and DNS responses processed at the modem, and may dynamically update the ACPL based at least in part on the HTTP server IP addresses. In some examples, the DNS monitoring may be performed for DNS requests and DNS responses on an access control list (ACL), which ACL may include domain names (or URLs) from the ACPL and identify a monitored antenna port (e.g., DNS UDP port 43). In some embodiments, an HTTP server IP address included in the ACPL may be provided by an application programming interface (API). For example, an OS of the UE (e.g., a UE OS) may provide an API for domain name resolution (e.g., an API such as the getaddrinfo API or gethostbyname API in Windows).

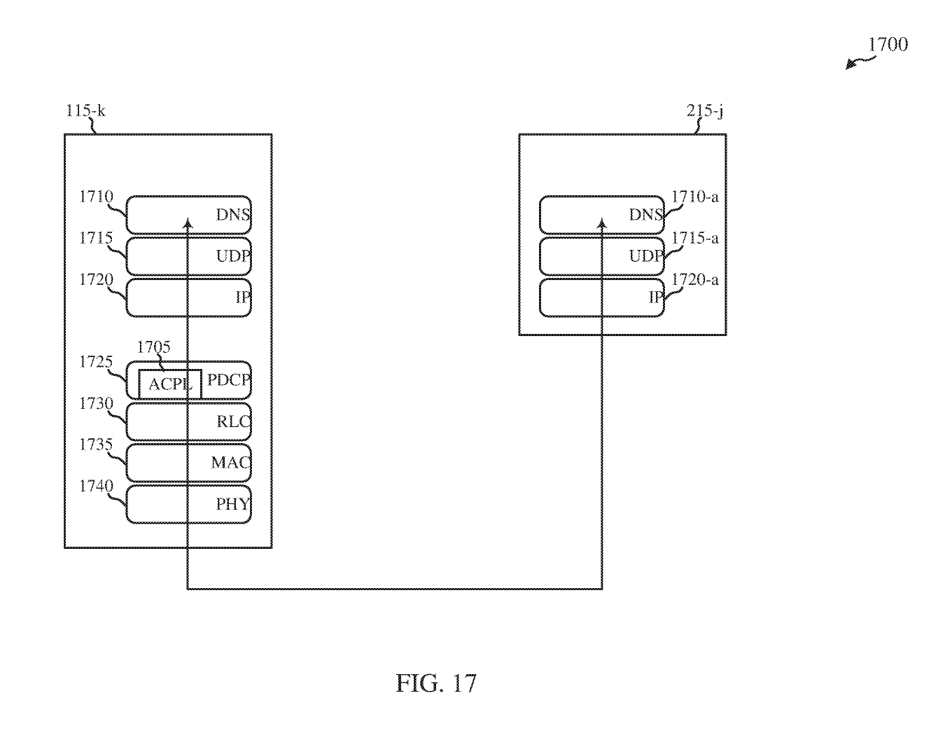

FIG. 17 shows example protocol stacks of a UE 115-k and a content server 215-j, and illustrates a process of dynamically updating an HTTP server IP address included in an ACPL 1705, in accordance with various aspects of the present disclosure. The UE 115-k may be an example of aspects of the UEs 115 described with reference to FIGS. 1-8 and 10-12. The content server 215-j may be an example of aspects of the content servers 215 described with reference to FIGS. 2-9, 13, and 16.

The protocol stack of the UE 115-k may include both higher level layers (e.g., UE OS/browser layers) and lower level layers (e.g., modem layers). The higher level layers may include a DNS layer 1710, a UDP layer 1715, and an IP layer 1720. The lower level layers may include a PDCP layer 1725, a RLC layer 1730, a MAC layer 1735, and a PHY layer 1740. The protocol stack of the content server 215-j may include at least the same higher level layers as the UE 115-k (e.g., a DNS layer 1710-a, a UDP layer 1715-a, and an IP layer 1720-a). A modem of the UE 115-k may be configured to monitor DNS UDP port 43 for DNS requests and DNS responses associated with content providers listed in an ACPL 1705. By way of example, the ACPL 1705 may have a content provider entry associated with the domain name (or host name) v.youku.com. When the UE 115-k generates a DNS request to access a website associated with the domain name v.youku.com, and then receives a DNS response associated with the domain name v.youku.com, the modem may identify the HTTP server IP address in the DNS response (e.g., 101.227.10.18) and dynamically update the ACPL 1705 content provider entry associated with the domain name v.youku.com with the HTTP server IP address 101.227.10.18.

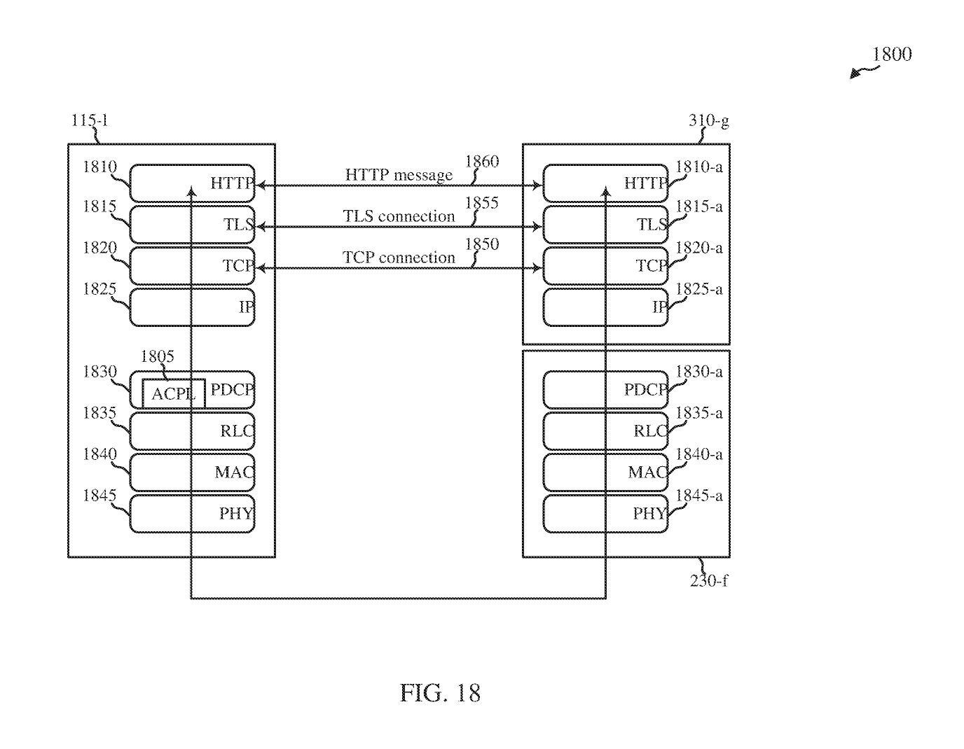

FIG. 18 shows example protocol stacks of a UE 115-l, a network access device 230-f, and an edge node device 310-g, and illustrates an example of UE-assisted selective content delivery acceleration based on an ACPL 1805, in accordance with various aspects of the present disclosure. The UE 115-l may be an example of aspects of the UEs 115 described with reference to FIGS. 1-8, 10-12, and 17. The network access device (e.g., a base station or eNB) may be an example of aspects of the base stations 105 or network access devices 230 described with reference to FIGS. 1-4, 7, 8, 13, and 16. The edge node device 310-g may be an example of aspects of the edge node devices 310 described with reference to FIGS. 2-4, 9, and 13-16.

The edge node device 310-g may be collocated with or separate from, the network access device 230-f. The interface between the edge node device 310-g and the network access device 230-f may be a standardized interface or a vendor-specific interface. In some examples, the edge node device 310-g may serve multiple network access devices 230-f.

The protocol stack of the UE 115-l may include both higher level layers (e.g., UE OS/browser layers) and lower level layers (e.g., modem layers). The higher level layers may include an HTTP layer 1810, a TLS layer 1815, a TCP layer 1820 and an IP layer 1825. The lower level layers may include a PDCP layer 1830, a RLC layer 1835, a MAC layer 1840, and a PHY layer 1845. The protocol stack of the network access device 230-f may include at least the same lower level layers as the UE 115-l (e.g., a PDCP layer 1830-a, a RLC layer 1835-a, a MAC layer 1840-a, and a PHY layer 1845-a), and the protocol stack of the edge node device 310-g may include at least the same higher level layers as the UE 115-l (e.g., an HTTP layer 1810-a, a TLS layer 1815-a, a TCP layer 1820-a and an IP layer 1825-a).

A modem of the UE 115-l may process requests made by an OS/Browser of the UE 115-l to access the content of websites, and upon determining that information associated with a request is included in the ACPL 1805, may associate mobile CDN-content delivery acceleration information with the request. The ACPL check and association of mobile CDN content delivery acceleration information with requests may be performed at the PDCP layer 1830 of the UE 115-l. In some examples, the modem may perform DNS monitoring and dynamically update HTTP server IP addresses included in the ACPL 1805, as described with reference to FIG. 17.

When the modem of the UE 115-l receives a request to access the content of a website (e.g., an HTTP request in an IP packet), and the modem determines that information associated with the request is included in the ACPL 1805, the modem may associate mobile CDN content delivery acceleration information with the request and transmit the request and associated mobile CDN content delivery acceleration information to the network access device 230-f in a PDCP packet. The network access device 230-f may deliver the request, in the form of an IP packet, to the edge node device 310-g. In some examples, the edge node device 310-g may first setup a TCP connection 1850 with the UE 115-l, and then setup a TLS connection 1855 with the UE 115-l (which in some cases may require accessing a central key server and/or key server operated by the website owner). After setting up the TLS connection 1855, the edge node device 110-g may interpret the request to access the content of the website and transmit the requested content to the UE 115-l from a local cache of the edge node device 310-g (when the content is cached at the edge node device 310-g), or fetch the content from a content server and transmit the requested content to the UE 115-l (when the content is not cached at the edge node device 310-g). The content may be transmitted in an HTTP message 1860.

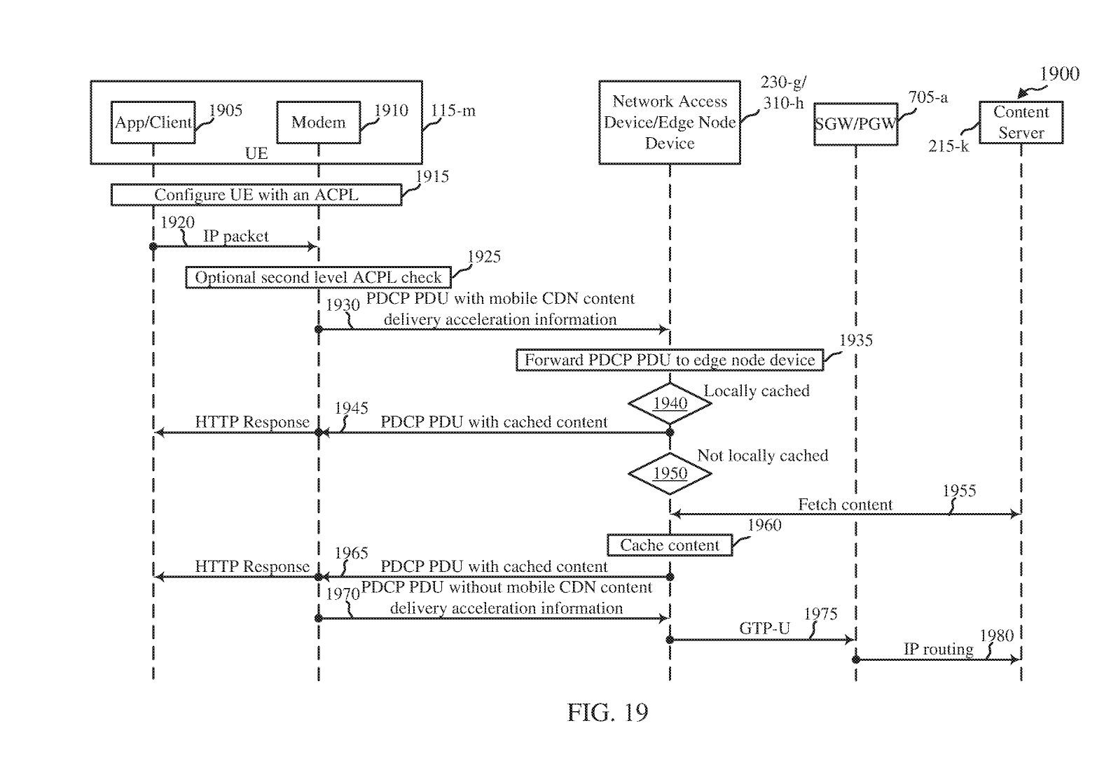

FIG. 19 shows a message flow 1900 in which a UE 115-m employs UE-assisted selective content delivery acceleration based on an ACPL, in accordance with various aspects of the present disclosure. As shown, the UE 115-m may include an application and/or client (App/Client 1905) and a modem 1910. Other devices included in the message flow 1900 include a network access device 230-g (e.g., a base station or eNB) and an edge node device 310-h (shown collocated with the network access device 230-g, for example) of a mobile CDN, and a SGW/PGW 705-a and content server 215-k of an Internet CDN. By way of example, the UE 115-m may be an example of aspects of the UEs 115 described with reference to FIGS. 1-8, 10-12, 17, and 18. The network access device 230-g may be an example of aspects of the base stations 105 or network access devices 230 described with reference to FIGS. 1-4, 7, 8, 13, and 16. The edge node device 310-h may be an example of aspects of the edge node devices 310 described with reference to FIGS. 2-4, 9, 13-16, and 18. The SGW/PGW 705-a may be an example of aspects of the PGW/SGW 705 described with reference to FIG. 7. The content server 215-k may be an example of aspects of the content servers 215 described with reference to FIGS. 2-9, 13, 16, and 17.

At 1915, a HPLMN for the UE 115-m may configure the UE 115-m with an ACPL (including, for example, a number of content provider entries, with each content provider entry including information, such as domain name, URL/URI, HTTP server IP address, port identifier, protocol type, or a combination thereof).

The App/Client 1905 (e.g., a browser of the UE 115-m) may generate an IP packet including a request to access the content of a website (e.g., an IP packet including an HTTP GET(URL1) request). At 1920, the IP packet may be routed to the modem 1910. The modem 1910 may pass the IP packet through a first level ACPL filter (e.g., an HTTP server IP address and port check). The first level ACPL filter may be based on an ACL and/or traffic flow template (TFT). For a content provider specified by a domain name but no HTTP server IP address, the modem 1910 may convert the domain name into an HTTP server IP address based on DNS monitoring, as described, for example, with reference to FIG. 17.

At 1925, the modem 1910 may process the IP packet received from the App/Client 1905 through a second level ACPL filter (e.g., a URL/URI check). The second level ACPL filter may include checking a URL or URI of the IP packet to determine whether the URL or URI is included in the ACPL. The second level ACPL filter may be performed for HTTP requests, but not HTTPs requests.

Mobile CDN content delivery acceleration information may be associated with the IP packet when information associated with the IP packet is identified by the first level ACPL filter (for an HTTP request) or by the first level and second level ACPL filters (for an HTTPs request). In some examples, mobile CDN content delivery acceleration information may be associated with an IP packet in an uplink (UL) packet (e.g., in a PDCP header of a PDCP protocol data unit (PDU), or in a MAC header of a MAC PDU). At 1930, the UL packet (e.g., PDCP PDU) may be transmitted to the network access device 230-g. At 1935, the network access device 230-g may forward the received UP packet to the edge node device 310-h based on the UP packet's inclusion of mobile CDN content delivery acceleration information.

The edge node device 310-h may use the mobile CDN content delivery acceleration information to determine where to obtain the content of the website referenced in the IP packet. When the edge node device 310-h determines, at 1940, that the content is cached at the edge node device 310-h (i.e., locally cached), the edge node device 310-h may provide the cached content to the UE 115-m, via the network access device 230-g, at 1945. The cached content may be provided, for example, in a response packet (e.g., a PDCP PDU including an HTTP Response (URL1)). When the edge node device 310-h determines, at 1950, that the content is not cached at the edge node device 310-h, the edge node device 310-h may fetch the content from the content server 215-k at 1955, cache the content at the edge node device 310-h at 1960, and provide the content to the UE 115-m, via the network access device 230-g, at 1965. The content may be provided, for example, in a response packet (e.g., a PDCP PDU including an HTTP Response (URL1)).

When the network access device 230-g receives a UP packet without mobile CDN content delivery acceleration information, at 1970, the network access device 230-g may fetch the content referenced in the UP packet from the content server 215-k (e.g., at 1975 and 1980), and may provide the content to the UE 115-m.

With UE-assisted selective content delivery acceleration based on out-of-band messaging, a UE may query a network access device (e.g., a serving base station or eNB) to determine whether content of a website is locally cached. In some examples, the query may be transmitted in an HTTP URL/URI request using an RRC signaling extension (e.g., RRC extension(http)/PDCP/RLC/MAC/PHY). The network access device may determine whether the content is locally cached by querying an edge node device collocated with (or located near) the network access device, and may provide a query response to the UE. When the query response indicates the content is locally cached, the UE may setup an HTTPs/HTTP session with the edge node device. In some examples, the network access device may determine which uplink packets received from the UE need to be interpreted by the edge node device based on the network access device being an IP-aware network access device. In some examples, the network access device may determine which uplink packets received from the UE need to be interpreted by the edge node device based on UE-assisted content delivery acceleration information received with the uplink packets. When the network access device is an IP-aware network access device, the network access device may determine that a destination HTTP server IP address associated with an uplink packet corresponds to an IP address of the edge node device or an anycast IP address, interpret the uplink request to the IP layer, and forward the uplink packet to the edge node device. The edge node device may then setup a TCP connection (and TLS session and TLS security key if HTTPs is leveraged) with the UE. When the UE transmits uplink packets associated with UE-assisted content delivery acceleration information, the UE may set an uplink assistant indication to the network access device in a PDCP header extension for the network access device to interpret. The network access device may then operate as the edge node device, or may forward the uplink packet to the edge node device, to process a content fetch request. The user stratum HTTP/TCP/IP/PDCP/RLC/MAC/PHY or HTTP/TCP/TLS/IP/PDCP/RLC/MAC/PHY may be carried over. The destination HTTP server IP address associated with an uplink packet may correspond to an IP address of the edge node device or an anycast IP address. A special destination IP address (e.g., an anycast IP address) may enable the UE to more easily identify uplink packets that should be associated with uplink assistant information (e.g., mobile CDN content delivery acceleration information). When a query response received by the UE, from a network access device, indicates that requested content is not locally cached, the UE may request the content from a content server of an Internet IDN via the network access device. UE-assisted selective content delivery acceleration based on out-of-band messaging can be more precise than UE-assisted selective content delivery acceleration based on an ACPL.

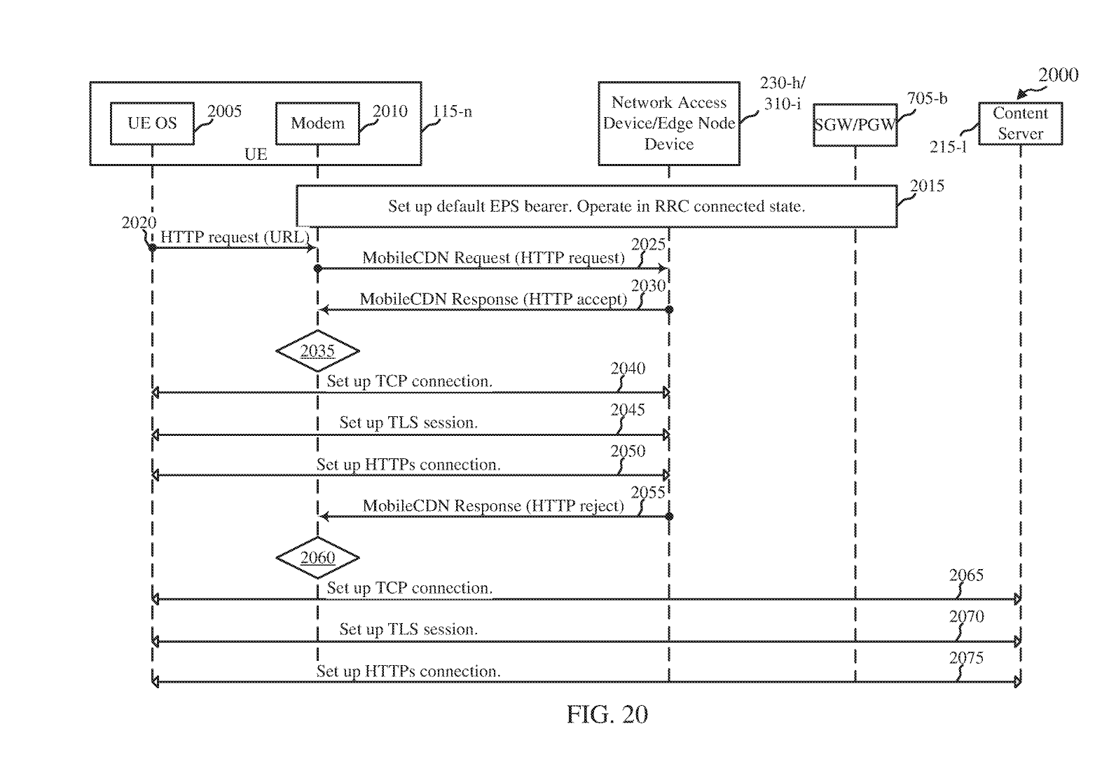

FIG. 20 shows a message flow 2000 in which a UE 115-n employs UE-assisted selective content delivery acceleration based on out-of-band messaging, using HTTPs, in accordance with various aspects of the present disclosure. As shown, the UE 115-n may include a UE OS 2005 and a modem 2010. Other devices included in the message flow 2000 include a network access device 230-h and an edge node device 310-i (shown collocated with the network access device 230-h, for example) of a mobile CDN, and a SGW/PGW 705-b and content server 215-l of an Internet CDN. By way of example, the UE 115-n may be an example of aspects of the UEs 115 described with reference to FIGS. 1-8, 10-12, and 17-19. The network access device 230-h may be an example of aspects of the base stations 105 or network access devices 230 described with reference to FIGS. 1-4, 7, 8, 13, 16, and 19. The edge node device 340-i may be an example of aspects of the edge node devices 310 described with reference to FIGS. 2-4, 9, 13-16, 18, and 19. The SGW/PGW 705-b may be an example of aspects of the PGW/SGWs 705 described with reference to FIGS. 7 and 19. The content server 215-l may be an example of aspects of the content servers 215 described with reference to FIGS. 2-9, 13, 16, 17, and 19.

At 2015, the UE 115-n, network access device 230-h, and SGW/PGW 705-b may setup a default Evolved Packet switched System (EPS) bearer, and the UE 115-n may operate in an RRC connected state.

At 2020, the UE OS 2005 may forward an HTTP request (e.g., a request associated with a URL) to the modem 2010. In response to receiving the HTTP request, the modem 2010 may query the network access device 230-h (e.g., transmit a MobileCDN Request (HTTP request)) to determine whether the requested content is locally cached at the edge node device 310-i. Following transmission of the query, at 2025, the message flow 2000 may continue at 2030 or 2055.

At 2030, the network access device 230-h may return a query response (e.g., a MobileCDN Response(HTTP accept)) indicating that the requested content is locally cached, and the modem 2010 of the UE 115-n may determine, at 2035, to request the content from the edge node device 310-i. The UE 115-n and edge node device 310-i may then setup a TCP connection with the edge node device 310-i at 2040, a TLS session with the edge node device 310-i at 2045, and an HTTPs connection with the edge node device 310-i at 2050, and the UE 115-n may request the content from the edge node device 310-i. The destination HTTP server IP address associated with the request may be the IP address of the edge node device 310-i or an anycast IP address. In some examples, the network access device 230-h may be an IP-aware network access device 230-h. In some examples, the modem 2010 of the UE 115-n may associate mobile CDN content delivery acceleration information with the request to access the content.

At 2055, the network access device 230-h may return a query response (e.g., a MobileCDN Response(HTTP reject)) indicating that the requested content is not locally cached, and the modem 2010 of the UE 115-n may determine, at 2060, to request the content from the content server 215-l. The UE 115-n and content server 215-l may then setup a TCP connection with the content server 245-l at 2065, a TLS session with the content server 215-l at 2070, and an HTTPs connection with the content server 215-l at 2075, and the UE 115-n may request the content from the content server 215-l. The destination HTTP server IP address associated with the request may be the IP address of the content server 215-l.

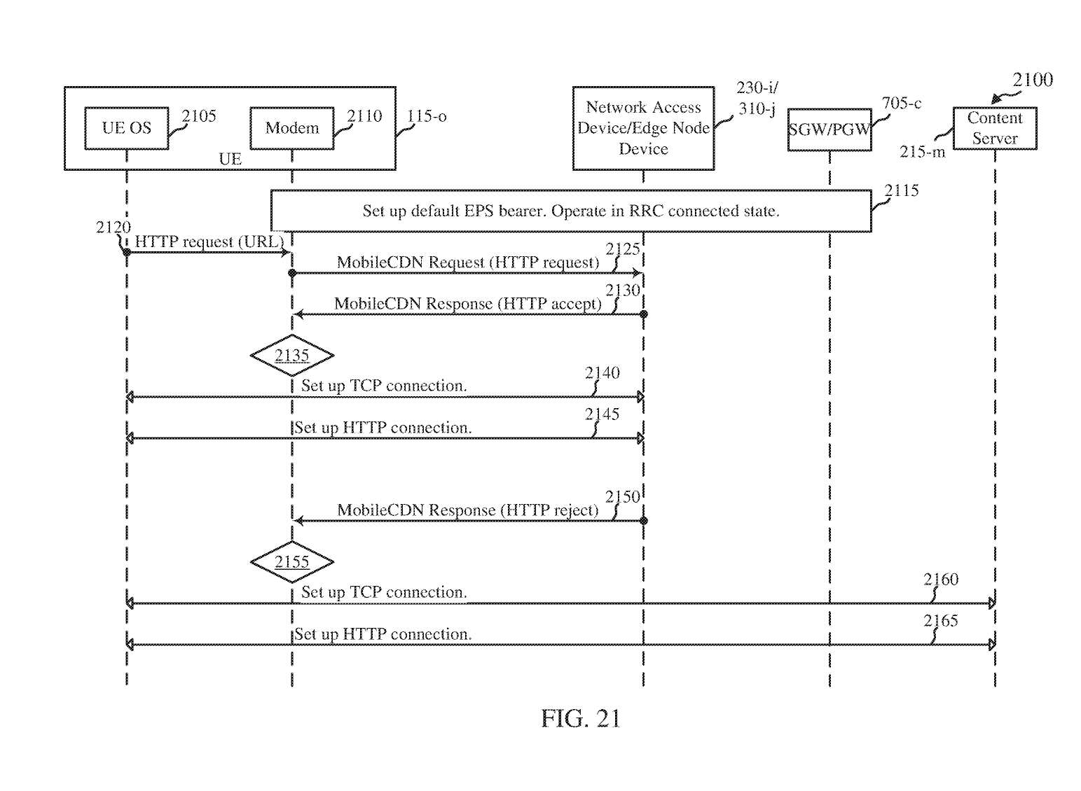

FIG. 21 shows a message flow 2100 in which a UE 115-o employs UE-assisted selective content delivery acceleration based on out-of-band messaging, using HTTP, in accordance with various aspects of the present disclosure. As shown, the UE 115-o may include a UE OS 2105 and a modem 2110. Other devices included in the message flow 2100 include a network access device 230-i and an edge node device 310-j (shown collocated with the network access device 230-i, for example) of a mobile CDN, and a SGW/PGW 705-c and content server 215-m of an Internet CDN. By way of example, the UE 115-o may be an example of aspects of the UEs 115 described with reference to FIGS. 1-8, 10-12, and 17-20. The network access device 230-i may be an example of aspects of the base stations 105 or network access devices 230 described with reference to FIGS. 1-4, 7, 8, 13, 16, 19, and 20. The edge node device 310-j may be an example of aspects of the edge node devices 310 described with reference to FIGS. 2-4, 9, 13-16, and 18-20. The SGW/PGW 705-c may be an example of aspects of the PGW/SGWs 705 described with reference to FIGS. 7, 19, and 20. The content server 215-m may be an example of aspects of the content servers 215 described with reference to FIGS. 2-9, 13, 16, 17, 19, and 20.

At 2115, the UE 115-o, network access device 230-i, and SGW/PGW 705-c may setup a default EPS) bearer, and the UE 115-o may operate in an RRC connected state.

At 2120, the UE OS 2105 may forward an HTTP request (e.g., a request associated with a URL) to the modem 2110. In response to receiving the HTTP request the modem 2110 may query the network access device 230-i (e.g., transmit a MobileCDN Request (HTTP request)), at 2125, to determine whether the requested content is locally cached at the edge node device 310-j. Following transmission of the query, the message flow 2100 may continue at 2130 or 2150.

At 2130, the network access device 230-i may return a query response (e.g., a MobileCDN Response(HTTP accept)) indicating that the requested content is locally cached, and the modem 2110 of the UE 115-o may determine, at 2135, to request the content from the edge node device 310-j. The UE 115-o and edge node device 310-j may then setup a TCP connection with the edge node device 310-j at 2140, and an HTTP connection with the edge node device 310-j at 2145, and the UE 115-o may request the content from the edge node device 310-j. The destination HTTP server IP address associated with the request may be the IP address of the edge node device 310-j or an anycast IP address. In some examples, the network access device 230-i may be an IP-aware network access device 230-i. In some examples, the modem 2110 of the UE 115-o may associate mobile CDN content delivery acceleration information with the request to access the content.

At 2150, the network access device 230-i may return a query response (e.g., a MobileCDN Response(HTTP reject)) indicating that the requested content is not locally cached, and the modem 2110 of the UE 115-o may determine, at 2155, to request the content from the content server 215-m. The UE 115-o and content server 215-m may then setup a TCP connection with the content server 215-m at 2160, and an HTTP connection with the content server 215-m at 2165, and the UE 115-o may request the content from the content server 215-m. The destination HTTP server IP address associated with the request may be the IP address of the content server 215-m.

When HTTPs is applied to a CDN (e.g., a CDN including both an Internet CDN and a mobile CDN), another issue that may arise is a TLS session resumption/continuation issue. A TLS session resumption/continuation issue may arise as a result of UE mobility.

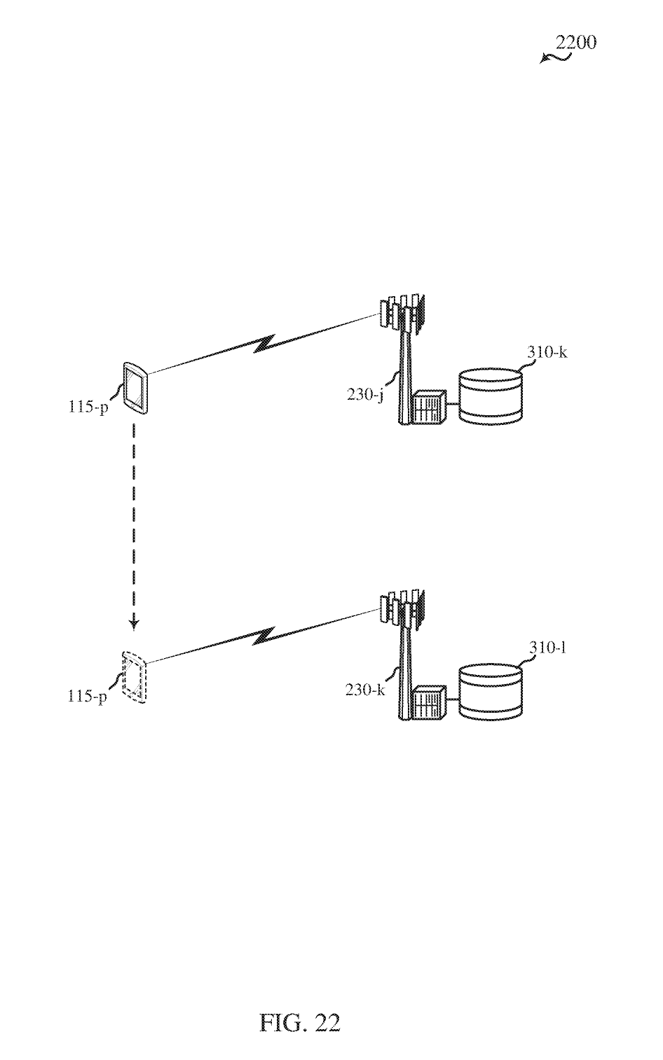

FIG. 22 shows a wireless communication system 2200 including a UE 115-p, in accordance with various aspects of the present disclosure. The UE 115-p may move within the wireless communication system 2200, and in some cases may be served by a source network access device 230-j (e.g., a first base station or eNB), and then a target network access device 230-k (e.g., a second base station or eNB). By way of example, the UE 115-p may be an example of aspects of the UEs 115 described with reference to FIGS 1-8, 10-12, and 17-21. The source network access device 230-j and target network access device 230-k may be examples of aspects of the bass stations 105 or network access devices 230 described with reference to FIGS. 1-4, 7, 8, 13, 16, and 19-21.

When served by the source network access device 230-j, the UE 115-p may receive content over a mobile CDN including a source edge node device 310-k. The source edge node device 310-k may be collocated or non-collocated with the source network access device 230-j. Before receiving content cached at the source edge node device 310-k, the UE 115-p (e.g., a client/app/browser of the UE 115-p) may establish a TLS session with the source edge node device 310-k, and each of the UE 115-p and the source edge node device 310-k may hold a TLS session key for the TLS session.

When the UE 115-p moves within the wireless communication system 2200 and begins to be served by the target network access device 230-k, the UE 115-p may request content cached at a target edge node device 310-l. The target edge node device 310-l may be collocated or non-collocated with the target network access device 230-k. In some cases, the UE 115-p may begin receiving content from the target edge node device 310-l more quickly by resuming or continuing the TLS session established with the source edge node device 310-k at the target edge node device 310-l. However, to resume or continue the TLS session established with the source edge node device 310-k, the TLS session key for the established TLS session needs to be transferred to the target edge node device 310-l.

The source edge node device 310-k and target edge node device 310-l may be examples of aspects of the edge node devices 310 described with reference to FIGS. 2-4, 9, 13-16, and 18-21.

In various examples, the UE 115-p may be associated with the source network access device 230-j in an RRC connected state or an RRC idle state, and may have an established or closed TLS session with the source edge node device 310-k via the source network access device 230-j. The UE 115-p may be in a RRC idle state, for example, because of expiration of an activity timer. When UE mobility necessitates that the UE 115-p associate with the target network access device 230-k and receive content from the target edge node device 310-l, the serving network access device for the UE 115-p may be changed from the source network access device 230-j to the target network access device 230-k, and the serving edge node device may be changed from the source edge node device 310-k to the target edge node device 310-l, while the UE 115-p is in a RRC idle state of an RRC connected state, and while the UE 115-p has an established or closed TLS session with the source edge node device 310-k. Four mobility scenarios are therefore possible: a change of serving network access device while the UE 115-p is in an RRC idle state and has a closed TLS session; a change of serving network access device while the UE 115-p is in an RRC connected state and has an established TLS session; a change in serving network access device while the UE 115-p is in an RRC idle state and has an established TLS session; or a change in serving network access device while the UE 115-p is in an RRC connected state and has an established TLS session.

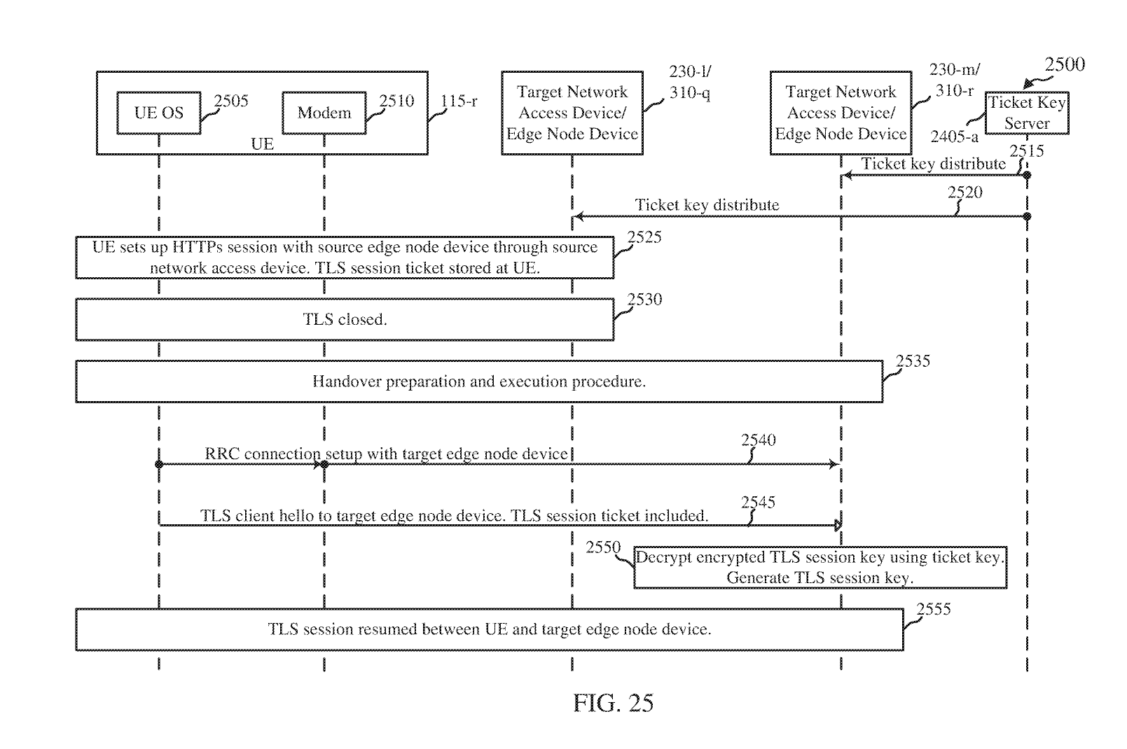

When the serving edge node device for the UE 115-p is changed while the UE 115-p is in an RRC idle state and has a closed TLS session (e.g., during idle mode mobility), or while the UE 115-p is in an RRC connected state and has a closed TLS session (e.g., during a handover), the closed TLS session may be resumed at the target edge node device 310-l. TLS session resumption is the resumption (or reuse) of a TLS session that has been closed as a result of a CDN server or UE sending a TLS close command to notify the other party to the TLS session that the TLS session is closed, or the resumption (or reuse) of a TLS session that is inactive as a result of no TLS session activity, without the issuance of a new session key. An example of TLS session resumption when a UE is in an RRC idle state or RRC connected state and has a closed TLS session is described with reference to FIG. 25.

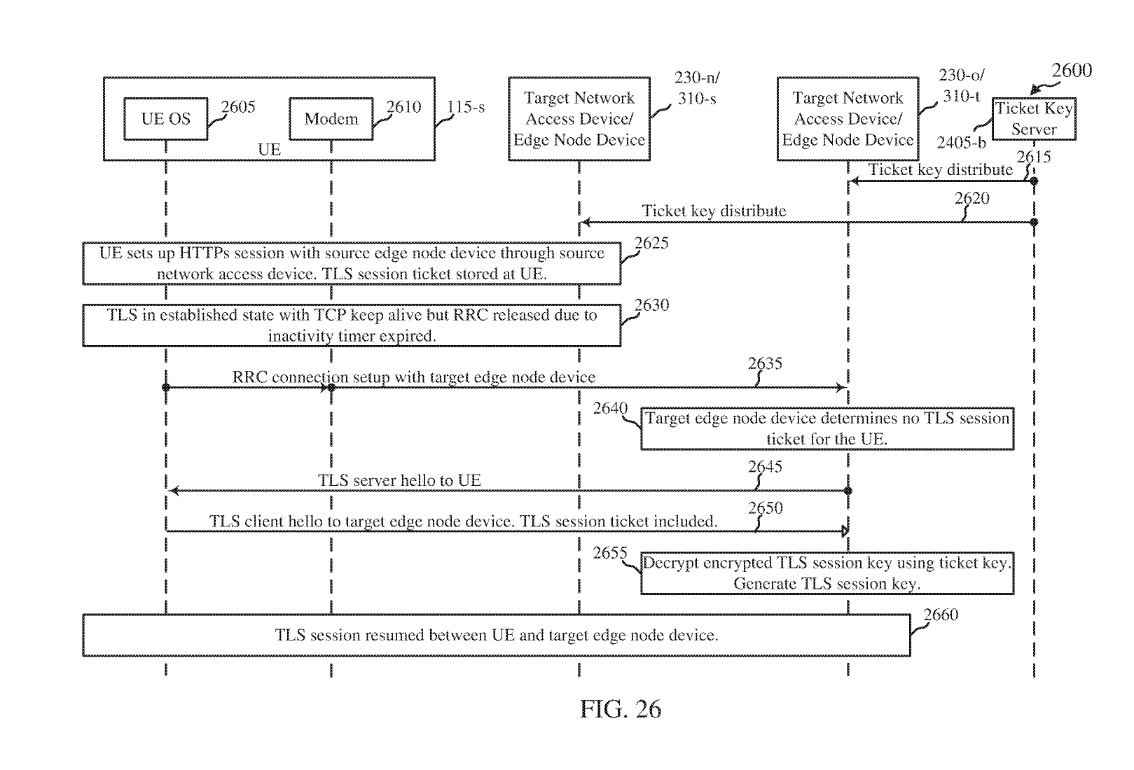

When the serving edge node device for the UE 115-p is changed while the UE 115-p is in an RRC idle state and has an established TLS session (e.g., during idle mode mobility), the established TLS session may be resumed at the target edge node device 310-l. An example of TLS session resumption when a UE is in an RRC idle state and has an established TLS session is described with reference to FIG. 26.

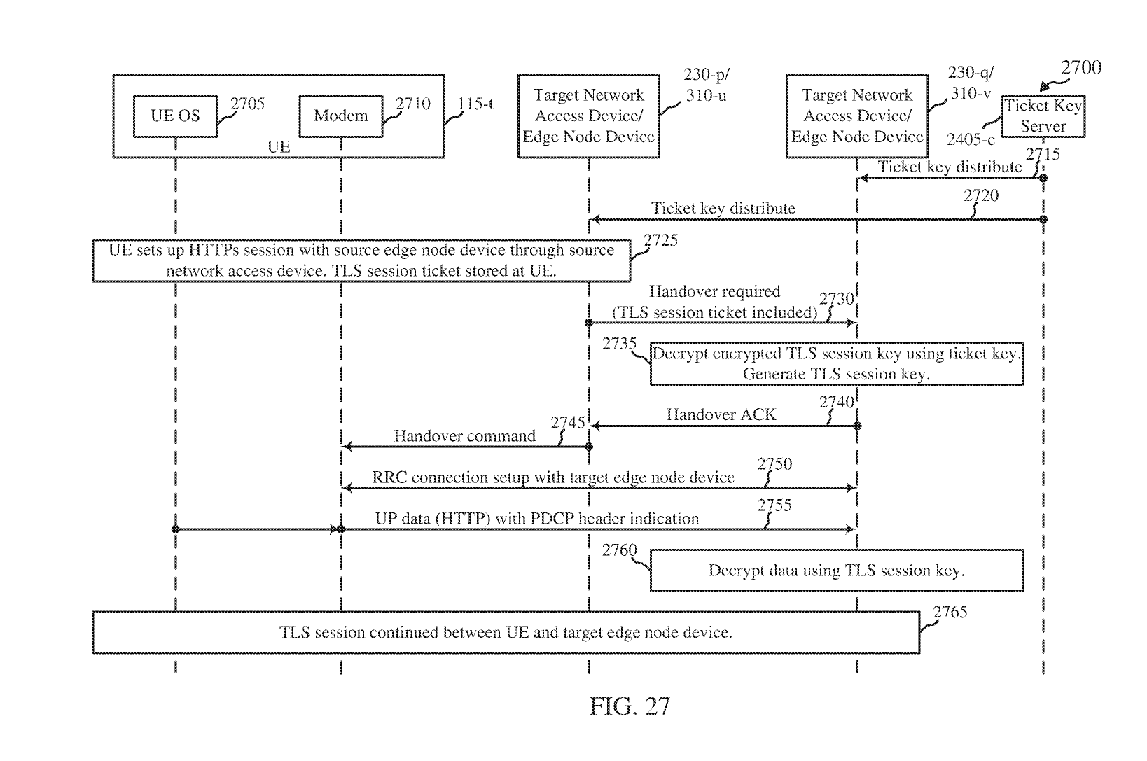

When the serving edge node device for the UE 115-p is changed while the UE 115-p is in an RRC connected state and has an established TLS session (e.g., during a handover), the established TLS session may be continued at the target edge node device 310-l. TLS session continuity is the continuation of an established and ongoing (active) TLS session without the issuance of a new session key. Examples of TLS session continuity when a UE is in an RRC connected state and has an established TLS session are described with reference to FIGS. 27, 28, and 29.

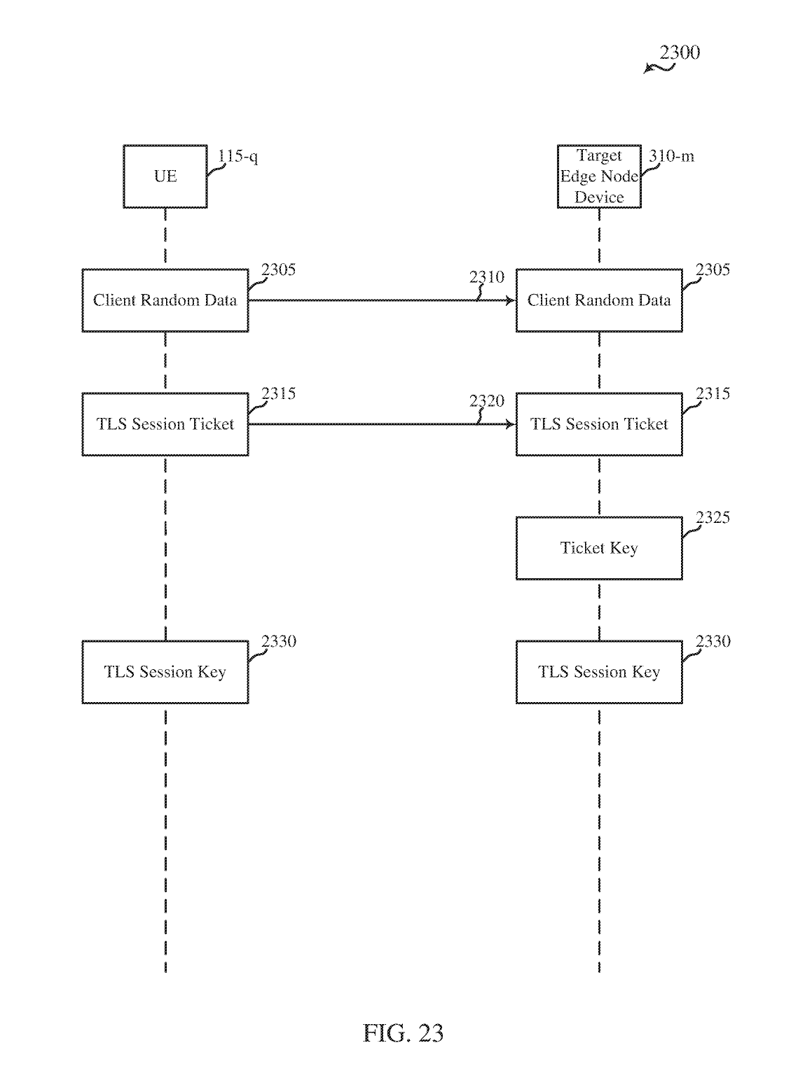

FIG. 23 shows a message flow 2300 for resuming a TLS session using a TLS session ticket, in accordance with various aspects of the present disclosure. The message flow 2300 occurs between a UE 115-q and a target edge node device 310-m (e.g., an edge node device at which a TLS session previously established with a source edge node device is being resumed). The UE 115-q may be an example of aspects of the UEs 115 described with reference to FIGS. 1-8, 10-12, and 17-22. The target edge node device 310-m may be example of aspects of the edge node devices 310 described with reference to FIGS. 2-4, 13-16, and 18-22.

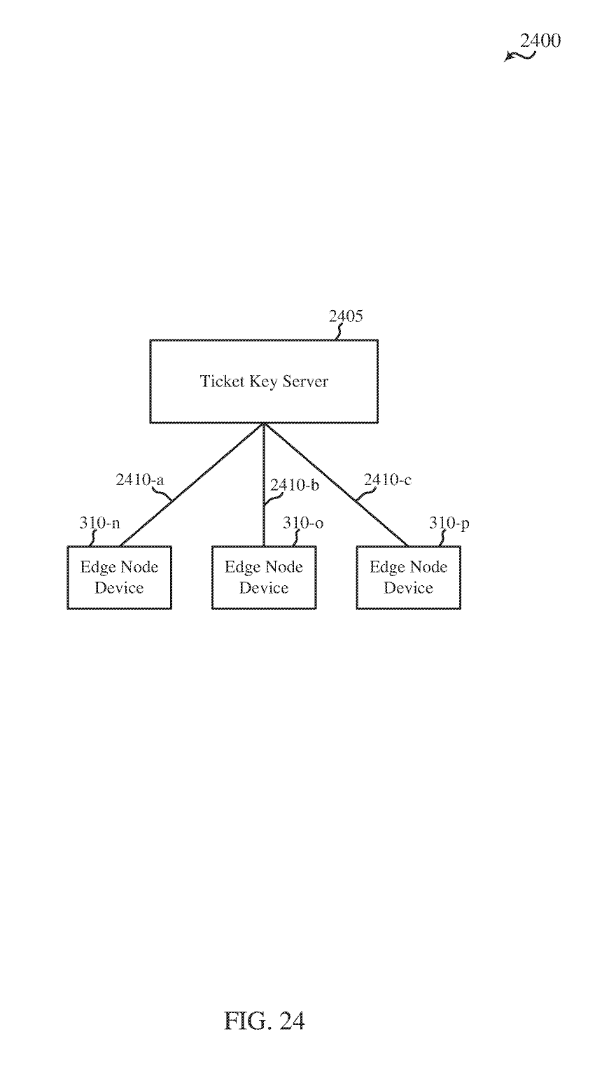

To initiate resumption of a TLS session established at a source edge node device, at the target edge node device 310-m, the UE 115-q may transmit to the target edge node device 310-m, in a message 2310, client random data 2305, a hello, and an indication of cipher suites supported by the UE 115-q. The UE 115-q may also transmit, to the target edge node device 310-m, in a message 2320, a TLS session ticket 2315 including an encrypted TLS session key for the TLS session established between the UE 115-q and the source edge node device. The target edge node device 310-m may decrypt the encrypted TLS session key, based at least in part on a ticket key 2325 received by the target edge node device 310-m and the source edge node device (e.g., a ticket key received from a ticket key server such as the ticket key server 2405 described with reference to FIG. 24). The TLS session established at the source edge node device may then be resumed, between the UE 115-q and the target edge node device 310-m, using the TLS session key 2330.

The message flow 2300 provides TLS session resumption with an abbreviated TLS handshake (e.g., a one round-trip TLS message transfer between the UE 115-q and the target edge node device 310-m) instead of a full TLS handshake (e.g., a two round-trip TLS message transfer between the UE 115-q and the target edge node device 310-m.

As described with reference to FIG. 23, the target edge node device 310-m may decrypt an encrypted TLS session key based at least in part on a ticket key 2325 received by the target edge node device 310-m and the source edge node device. FIG. 24 shows a block diagram 2400 of a ticket key server 2405 (e.g., a central key server), in accordance with various aspects of the present disclosure. In some examples, the ticket key server may be an Oracle Access Manager (OAM) server. As shown, the ticket server may communicate with a plurality of edge node devices 310-n, 310-o, 310-p (e.g., source edge node devices and target edge node devices, depending on context), over wired or wireless communication links 2410-a, 2410-b, 2410-c. Each edge node device 310 may be an edge node device of a CDN, and may be located within or outside a mobile CDN forming part or all of the CDN.

The ticket key server 2405 may periodically generate a ticket key, and may periodically transmit the periodically generated ticket key to each of the edge node devices 310. The edge node devices 310 may each use the same ticket key to decrypt an encrypted TLS session key transferred from one edge node device to another edge node device during TLS session resumption or continuation.

In each of the TLS session resumption and TLS session continuation examples described with reference to FIGS. 25, 26, 27, 28 and 29, the resumption or continuation of a TLS session, without the issuance of a new TLS session key, may be enabled by providing a TLS session ticket of an established or closed TLS session to a target edge node device. The TLS session ticket may be provided to the target edge node device, in some examples, by a UE. The TLS session ticket may be provided to the target edge node device, in other examples, by a source edge node device. In all of the examples, a central ticket key server may provide both the source edge node device and the target edge node device with a ticket key usable to decrypt an encrypted TLS session key included in the TLS session ticket. The resumption or continuation of a TLS session without the issuance of a new TLS session key enables TLS session resumption or TLS session continuation using an abbreviated TLS handshake (e.g., a one round-trip TLS message transfer between the UE and the target edge node device) instead of a full TLS handshake (e.g., a two round-trip TLS message transfer between the UE and the target edge node device).

FIG. 25 shows a message flow 2500 in which a change of serving network access device and change of serving edge node device is made for a UE 115-r in an RRC connected state or RRC idle state, with a closed TLS session, in accordance with various aspects of the present disclosure. The change of serving network access device may be from a source network access device 230-l to a target network access device 230-m, and the change in serving edge node device may be from a source edge node device 310-q to a target edge node device 310-r. The source edge node device 310-q may be associated with the source network access device 230-l, and the target edge node device 310-r may be associated with the target network access device 230-m. As shown, the UE 115-r may include a UE OS 2505 and a modem 2510. By way of example, the UE 115-r may be an example of aspects of the UEs 115 described with reference to FIGS. 1-8, 10-12, and 17-23. The source network access device 230-l and target network access device 230-m may be examples of the base stations 105 or network access devices 230 described with reference to FIGS. 1-4, 7, 8, 13, 16, and 19-22. The source edge node device 310-q and target edge node device 310-r may be examples of the edge node devices 310 described with reference to FIGS. 2-4, 9, 13-16, and 18-24.

At 2515 and 2520, a ticket key server 2405-a may provide a ticket key to each of a number of edge node devices, including the source edge node device 310-q and the target edge node device 310-r.

At 2525, the UE 115-r may set up an HTTPs session, including a TLS session, with the source edge node device 310-q through the source network access device 230-l. As part of setting up the HTTPs session, a TLS session key and TLS session ticket, based at least in part on the ticket key, may be generated for the TLS session and stored at the UE 115-r and source edge node device 310-q.

At 2530, the UE 115-r or source edge node device 310-q may close the TLS session.

At 2535, the source network access device 230-l, target network access device 230-m, and UE 115-r may participate in a handover preparation, and execution procedure, in which the source network access device 230-l may transmit a request for handover of the UE 115-r from the source network access device 230-l to the target network access device 230-m. In some examples, legacy data may be forwarded to the target network access device 230-m at 2535.

At 2540, an RRC connection may be set up between the UE 115-r and the target edge node device 310-r.

At 2545, the UE OS 2505 may transmit a TLS client hello message to the target edge node device 310-r. The TLS client hello message may include the TLS session ticket that was stored at the UE 115-r at 2525. The TLS session ticket may include an encrypted TLS session key. At 2550, the target edge node device 310-r may decrypt the encrypted TLS session key based at least in part on the ticket key received at 2515, and may generate a TLS session key for the TLS session that is to be resumed at the target edge node device 310-r. At 2555, the TLS session established between the UE 115-r and the source edge node device 310-q may be resumed between the UE 115-r and the target edge node device 310-r.

FIG. 26 shows a message flow 2600 in which a change of serving network access device and change of serving edge node device is made for a UE 115-s in an RRC idle state, with an established TLS session, in accordance with various aspects of the present disclosure. The change of serving network access device may be from a source network access device 230-n to a target network access device 230-o, and the change in serving edge node device may be from a source edge node device 310-s to a target edge node device 310-t. The source edge node device 310-s may be associated with the source network access device 230-n, and the target edge node device 340-t may be associated with the target network access device 230-o. As shown, the UE 115-s may include a UE OS 2605 and a modem 2610. By way of example, the UE 115-s may be an example of aspects of the UEs 115 described with reference to FIGS. 1-8, 10-12, 17-23, and 25. The source network access device 230-n and target network access device 230-o may be examples of the base stations 105 or network access devices 230 described with reference to FIGS. 1-4, 7, 8, 13, 16, 19-22, and 25. The source edge node device 310-s an d target edge node device 310-t may be examples of the edge node devices 310 described with reference to FIGS. 2-4, 9, 13-16, and 18-25.

At 2615 and 2620, a ticket key server 2405-b may provide a ticket key to each of a number of edge node devices, including the source edge node device 310-s and the target edge node device 310-t.

At 2625, the UE 115-s may set up an HTTPs session, including a TLS session, with the source edge node device 310-s through the source network access device 230-n. As part of setting up the HTTPs session, a TLS session key and TLS session ticket, based at least in part on the ticket key, may be generated for the TLS session and stored at the UE 115-s and source edge node device 310-s.

At 2630, the UE 115-s may transition to an RRC idle state due to expiration of an inactivity timer. However, the TLS session may remain in an established state using a TCP keep alive signal.

At 2635, an RRC connection may be set up between the UE 115-s and the target edge node device 310-t.

At 2640, the target edge node device 310-t may determine that it does not have a TLS session ticket for the UE 115-s, and at 2645, the target edge node device 310-t may transmit a TLS server hello message, requesting a TLS session ticket from the UE 115-s.

At 2650, the UE OS 2605 may transmit a TLS client hello message to the target edge node device 310-t. The TLS client hello message may include the TLS session ticket that was stored at the UE 115-s at 2625. The TLS session ticket may include an encrypted TLS session key. At 2655, the target edge node device 310-t may decrypt the encrypted TLS session key based at least in part on the ticket key received at 2615, and may generate a TLS session key for the TLS session that is to be resumed at the target edge node device 310-t. At 2660, the TLS session established between the UE 1115-s and the source edge node device 310-s may be resumed between the UE 115-s and the target edge node device 310-t.

FIG. 27 shows a message flow 2700 in which a handover is performed for a UE 115-t in an RRC connected state, with an established TLS session, in accordance with various aspects of the present disclosure. The handover of the UE 115-t may be from a source network access device 230-p to a target network access device 230-q, and the change in serving edge node device may be from a source edge node device 310-u to a target edge node device 310-v. The source edge node device 310-u may be associated with the source network access device 230-p, and the target edge node device 310-v may be associated with the target network access device 230-q. As shown, the UE 115-t may include a UE OS 2705 and a modem 2710. By way of example, the UE 115-t may be an example of aspects of the UEs 115 described with reference to FIGS. 1-8, 10-12, 17-23, 25, and 26. The source network access device 230-p and target network access device 230-q may be examples of the base stations 105 or network access devices 230 described with inference to FIGS. 1-4, 7, 8, 13, 16, 19-22, 25, and 26. The source edge node device 310-u and target edge node device 310-v may be examples of the edge node devices 310 described with reference to FIGS. 2-4, 9, 13-16, and 18-26.

At 2715 and 2720, a ticket key server 2405-c may provide a ticket key to each of a number of edge node devices, including the source edge node device 340-u and the target edge node device 310-v.

At 2725, the UE 115-t may set up an HTTPs session, including a TLS session, with the source edge node device 310-u through the source network access device 230-p. As part of setting up the HTTPs session, a TLS session key and TLS session ticket, based at least in part on the ticket key, may be generated for the TLS session and stored at the UE 115-t and source edge node device 310-u.

At 2730, the source network access device 230-p may transmit, to the target network access device 230-q, a request for handover of the UE 115-t from the source network access device 230-p to the target network access device 230-q. The request for handover may include the TLS session ticket that was stored at the UE 115-t at 2725. The TLS session ticket may include an encrypted TLS session key.

At 2735, the target edge node device 310-r may decrypt the encrypted TLS session key based at least in part on the ticket key received at 2515, and may generate a TLS session key for the TLS session that is to be resumed at the target edge node device 310-r.

At 2740, the target network access device 230-q may transmit a handover acknowledgement (ACK) to the source network access device 230-p, and at 2745, the source network access device 230-p may transmit a handover command to the modem 2710 of the UE 115-t. Following transmission of the handover command, and at 2750, an RRC connection may be set up between the UE 115-t and the target edge node device 310-v.

At 2755, the modem 2730 may transmit uplink (UP) data (e.g., HTTP data in an HTTPs message) with a PDCP header indication to the target edge node device 310-v. At 2760, the target edge node device 310-v may decrypt the data using the TLS session key generated at 2735, and at 2765, the TLS session established between the UE 115-t and the source edge node device 310-u may be continued between the UE 115-t and the target edge node device 310-v.

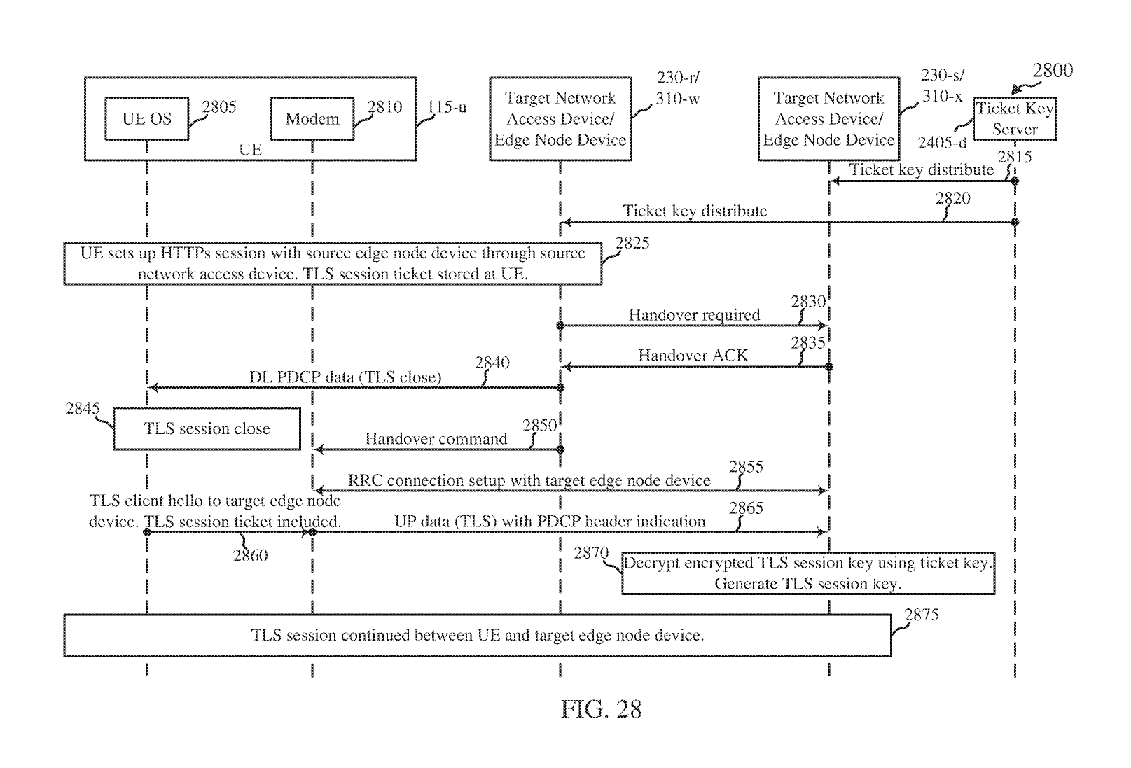

FIG. 28 shows a message flow 2800 in which a handover is performed for a UE 115-u in an RRC connected state, with an established TLS session, in accordance with various aspects of the present disclosure. The handover of the UE 115-u may be from a source network access device 230-r to a target network access device 230-s, and the change in serving edge node device may be from a source edge node device 310-w to a target edge node device 310-x. The source edge node device 310-w may be associated with the source network access device 230-r, and the target edge node device 310-x may be associated with the target network access device 230-s. As shown, the UE 115-u may include a UE OS 2805 and a modem 2810. By way of example, the UE 115-u may be an example of aspects of the UEs 115 described with reference to FIGS. 1-8, 10-12, 17-23, and 25-27. The source network access device 230-r and target network access device 230-s may be examples of the base stations 105 or network access devices 230 described with reference to FIGS. 1-4, 7, 8, 13, 16, 19-22, and 25-27. The source edge node device 310-w and target edge node device 310-x may be examples of the edge node devices 310 described with reference to FIGS. 2-4, 9, 13-16, and 18-27.

At 2815 and 2820, a ticket key server 2405-d may provide a ticket key to each of a number of edge node devices, including the source edge node device 310-w and the target edge node device 310-x.

At 2825, the UE 1115-u may set up an HTTPs session, including a TLS session, with the source edge node device 310-w through the source network access device 230-r. As part of setting up the HTTPs session, a TLS session key and TLS session ticket, based at least in part on the ticket key, may be generated for the TLS session and stored at the UE 115-u and source edge node device 310-w.

At 2830, the source network access device 230-r may transmit, to the target network access device 230-s, a request for handover of the UE 115-u from the source network access device 230-r to the target network access device 230-s. At 2835, the target network access-device 230-s may transmit a handover ACK to the source network access device 230-r.

At 2840, and based at least in part on receiving the handover ACK, the source network access device 230-r may trigger a TLS session close before handover of the UE 115-u to the target network access device 230-s. The TLS session close may be triggered by transmitting a TLS session close command (e.g., a TLS session close command included in downlink (DL) PDCP data) to the UE 115-u. The TLS session close command may be processed by the UE OS 2805, and in response to receiving the TLS session close command, the UE 115-u may, at 2845, close the TLS session established with the source edge node device 310-w.

At 2850, after transmitting the TLS session close command at 2840, the source network access device 230-r may transmit a handover command to the modem 2810 of the UE 115-u. Following transmission of the handover command, and at 2855, an RRC connection may be set up between the UE 115-u and the target edge node device 310-x.

At 2860, the UE OS 2805 may transmit a TLS client hello message to the target edge node device 310-x via the modem 2810. The TLS client hello message may include the TLS session ticket that was stored at the UE 115-u at 2825. The TLS session ticket may include an encrypted TLS session key. At 2865, the modem 2810 may transmit uplink (UP) data (e.g., the TLS client hellos message) with a PDCP header indication to the target edge node device 310-x. At 2870, the target edge node device 310-x may decrypt the encrypted TLS session key based at least in part on the ticket key received at 2815, and may generate a TLS session key for the TLS session that is to be resumed at the target edge node device 310-x. At 2875, the TLS session established between the UE 115-u and the source edge node device 310-w may be resumed between the UE 115-u and the target edge node device 310-x.

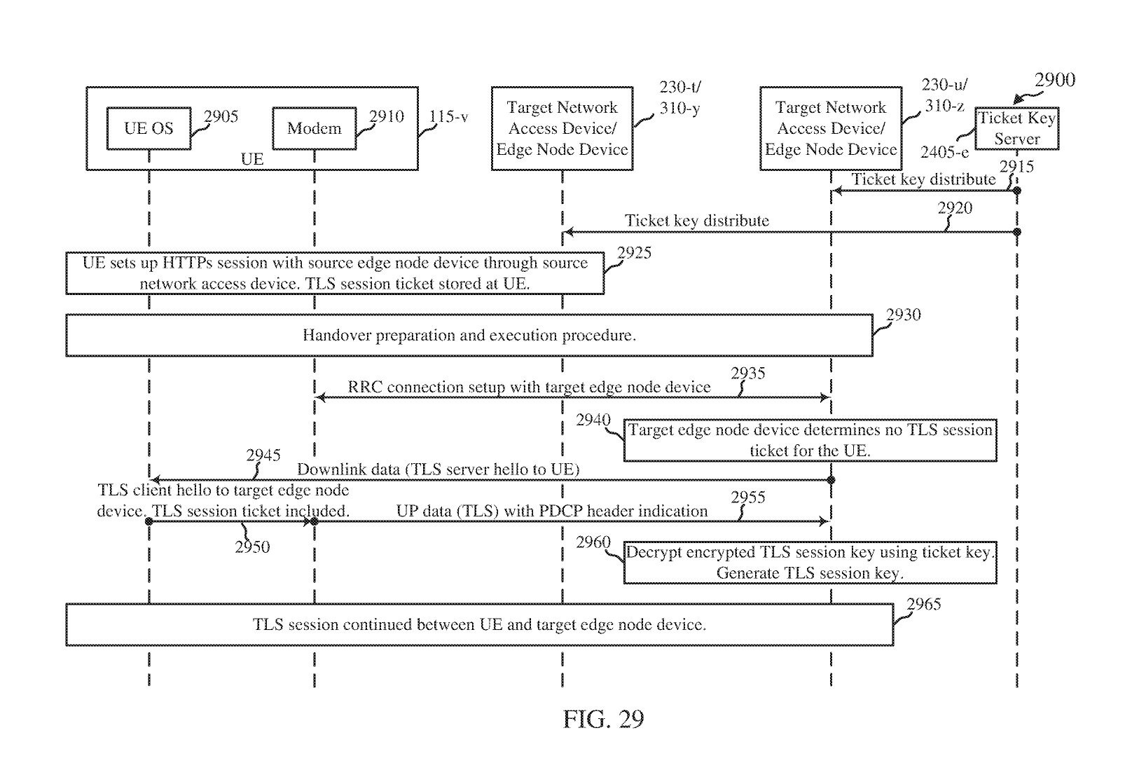

FIG. 29 shows a message flow 2900 in which a handover is performed for a UE 115-v in an RRC connected state, with an established TLS session, in accordance with various aspects of the present disclosure. The handover of the UE 115-v may be from a source network access device 230-t to a target network access device 230-u, and the change in serving edge node device may be from a source edge node device 310-y to a target edge node device 340-z. The source edge node device 310-y may be associated with the source network access device 230-t, and the target edge node device 310-z may be associated with the target network access device 230-u. As shown, the UE 115-v may include a UE OS 2905 and a modem 2910. By way of example, the UE 115-v may be an example of aspects of the UEs 115 described with reference to FIGS. 1-8, 10-12, 17-23, and 25-28. The source network access device 230-t and target network access device 230-u may be examples of the base stations 105 or network access devices 230 described with reference to FIGS. 1-4, 7, 8, 13, 16, 19-22, and 25-28. The source edge node device 310-y and target edge node device 310-z may be examples of the edge node devices 310 described with reference to FIGS. 2-4, 9, 13-16, and 18-28.

At 2915 and 2920, a ticket key server 2405-e may provide a ticket key to each of a number of edge node devices, including the source edge node device 310-y and the target edge node device 310-z.

At 2925, the UE 115-t may set up an HTTPs session, including a TLS session, with the source edge node device 310-y through the source network access device 230-t. As part of setting up the HTTPs session, a TLS session key and TLS session ticket, based at least in part on the ticket key, may be generated for the TLS session and stored at the UE 115-t and source edge node device 310-y.

At 2930, the source network access device 230-t, target network access device 230-u, and UE 115-v may participate in a handover preparation and execution procedure, in which the source network access device 230-t may transmit a request for handover of the UE 115-v from the source network access device 230-t to the target network access device 230-u. In some examples, legacy data may be forwarded to the target network access device 230-u at 2930.

At 2935, an RRC connection may be set up between the UE 115-v and the target edge node device 310-z.

At 2940, the target edge node device 310-z may determine that it does not have a TLS session ticket for the UE 115-v, and at 2945, the target edge node device 310-z may transmit a TLS message, requesting a TLS session ticket from the UE 115-v. In some examples, the TLS message may include a TLS server hello message included in downlink data. The TLS message may be processed by the UE OS 2905, and at 2950, the UE OS 2905 may transmit a TLS client hello message to the target edge node device 310-z via the modem 2910. The TLS client hello message may include the TLS session ticket that was stored at the UE 115-v at 2925. The TLS session ticket may include an encrypted TLS session key. At 2955, the modem 2910 may transmit uplink (UP) data (e.g., the TLS client hellos message) with a PDCP header indication to the target edge node device 310-z. At 2960, the target edge node device 310-z may decrypt the encrypted TLS session key based at least in part on the ticket key received at 2915, and may generate a TLS session key for the TLS session that is to be resumed at the target edge node device 310-z. At 2965, the TLS session established between the UE 115-v and the source edge node device 310-y may be resumed between the UE 115-v and the target edge node device 310-z.

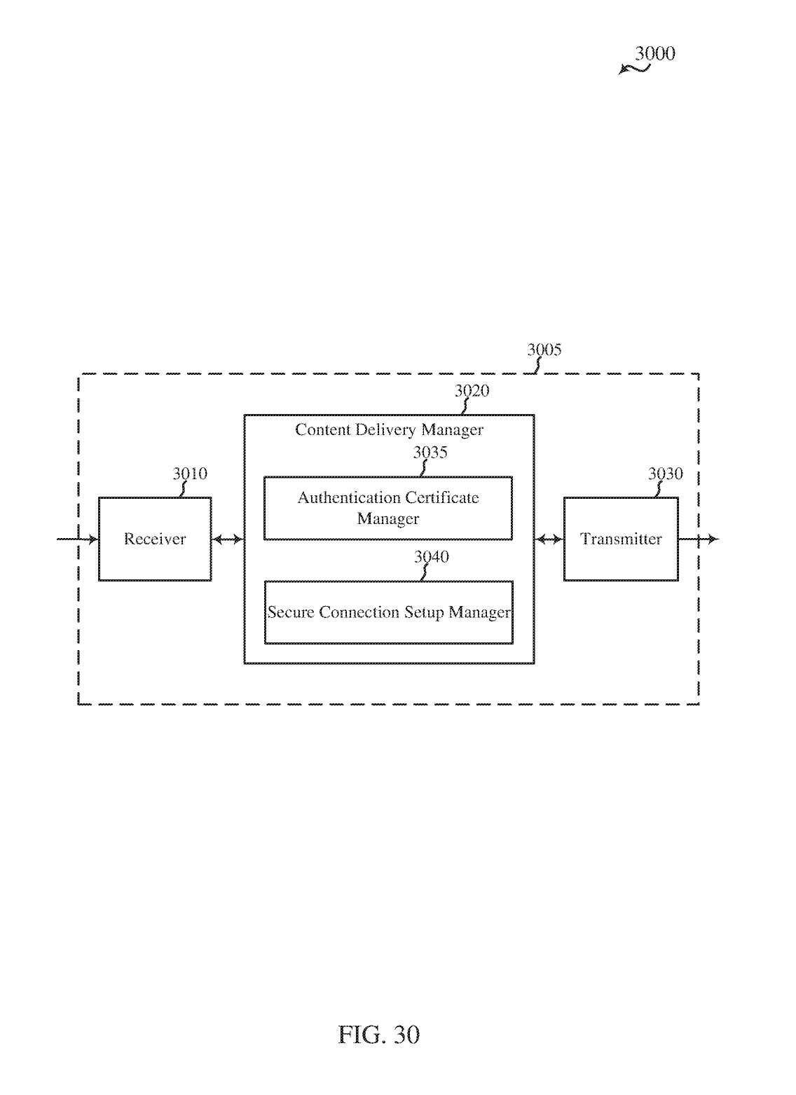

FIG. 30 shows a block diagram 3000 of an apparatus 3005 for handling content requests at an edge node device of a CDN, in accordance with various aspects of the present disclosure. In some examples, the CDN may include a mobile CDN between a UE and a PGW, and the edge node device may be within the mobile CDN. In other examples, the CDN may include the mobile CDN, and the edge node device may be within the CDN and outside the mobile CDN. The apparatus 3005 may be an example of aspects of one or more of the edge node devices 310 described with reference to FIGS. 2-4, 9, 13-16, and 18-29. The apparatus 3005 may also be or include a processor. The apparatus 3005 may include a receiver 3010, a content delivery manager 3020, or a transmitter 3030. Each of these components may be in communication with each other.

The components of the apparatus 3005 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, others of integrated circuits may be used (e.g., Structured/Platform ASICs, Field Programmable Gate Arrays (FPGAs), a System on Chip (SoC), and/or others of Semi-Custom ICs), which may be programmed in any manner known in the art. The functions of each component may also be implemented, in whole or in part, with instructions embodied in a memory, formatted to be executed by one or more general or application-specific processors.

In some examples, the receiver 3010 may include an interface with one or more network access devices (e.g., one or more base stations or eNBs) or other edge node devices. The receiver 3010 may be used to receive various data or control signals (i.e., transmissions). In some examples, the transmitter 3030 may include an interface with the one or more network access devices or other edge node devices. The transmitter 3030 may be used to transmit various data of control signals (i.e., transmissions).

In some examples, the content delivery manager 3020 may be used to manage the caching of content in a CDN, the delivery of content over the CDN, or one or more authentication procedures preceding content transmission or reception. In some examples, part of the content delivery manager 3020 may be incorporated into or shared with the receiver 3010 or the transmitter 3030. In some examples, the content delivery manager 3020 may include an authentication certificate manager 3035 or a secure connection setup manager 3040.

The content delivery manager 3020 may be used to receive a request to access content of a website, from a UE, over a wireless network. In some examples, the request to access the content of the website may be received through a network access device.

The authentication certificate manager 3035 may be used to obtain an authentication certificate for the website from a key server by providing an authentication certificate of the edge node device including the apparatus 3005 to the key server. The authentication certificate may be obtained in response to receiving the request to access content of the website. In some examples, the key server may be identified based at least in part on: the website to which the request to access content applies, an identified owner of the website, or a combination thereof.

The secure connection setup manager 3040 may be used to establish a secure connection with the UE based at least in part on the authentication certificate for the website. In some examples, establishing the secure connection with the UE may include transmitting the authentication certificate for the website to the UE; receiving an encrypted premaster secret from the UE; transmitting the encrypted premaster secret to the key server; receiving a decrypted premaster secret from the key server; and establishing the secure connection with the UE based at least in pair on the decrypted premaster secret. In some examples, the secure connection with the UE may be established through a network access device.

The content delivery manager 3020 may be used, after establishing the secure connection with the UE, to process the request to access the content of the website. In some examples, processing the request may include determining whether the content is cached at the edge node device including the apparatus 3005. Upon determining that the content is cached at the edge node device, based at least in part on mobile CDN content delivery acceleration information associated with the request to access the content, the content may be delivered to the UE. Upon determining that the content is not cached at the edge node device, based at least in part on mobile CDN content delivery acceleration information associated with the request to access the content, the content may be obtained from the website and delivered to the UE.

In some examples, the apparatus 3005 may be included in an edge node device involved in the certificateless HTTPs authentication scenario described with reference to FIG. 16.

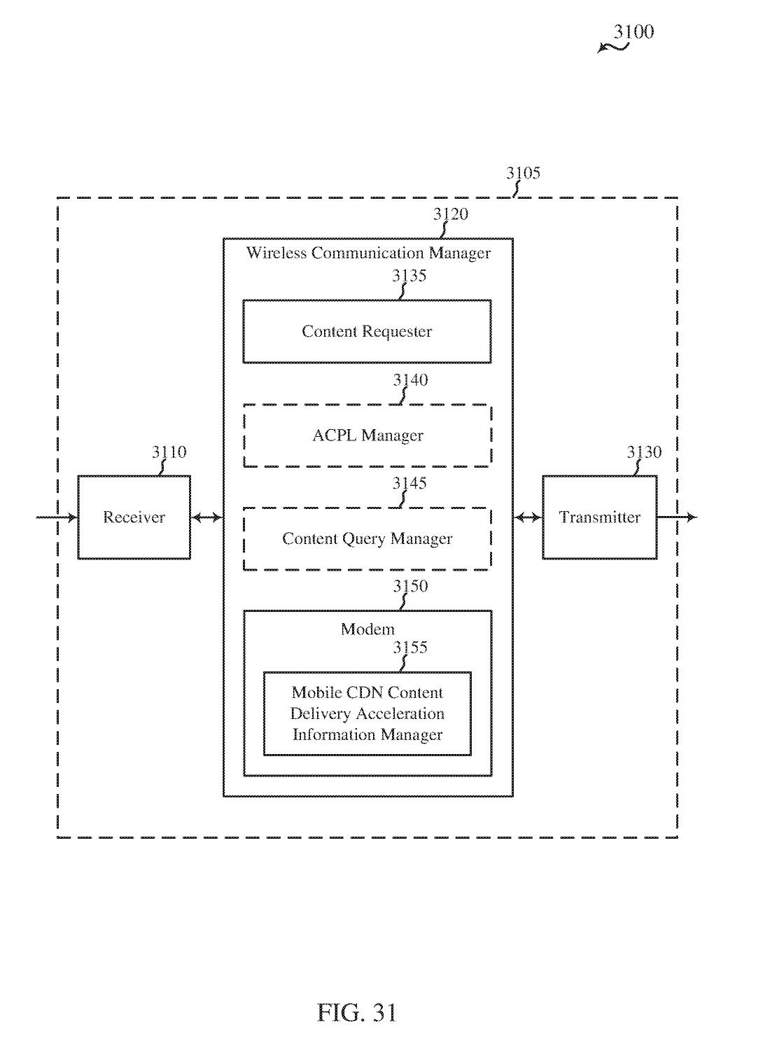

FIG. 31 shows a block diagram 3100 of an apparatus 3105 for use in wireless communication at a UE, in accordance with various aspects of the present disclosure. The apparatus 3105 may be an example of aspects of one or more of the UEs 115 described with reference to FIGS. 1-8, 10-12, 17-21, and 25-29. The apparatus 3105 may also be or include a processor. The apparatus 3105 may include a receiver 3110, a wireless communication manager 3120, or a transmitter 3130. Each of these components may be in communication with each other.

The components of the apparatus 3105 may, individually or collectively, be implemented using one or more ASICs adapted to perform some or all of the applicable functions in hardware. Alternatively, the functions may be performed by one or more other processing units (or cores), on one or more integrated circuits. In other examples, others of integrated circuits may be used (e.g., Structured/Platform ASICs, FPGAs, a SoC, and/or others of Semi-Custom ICs), which may be programmed in any manner known in the art. The functions of each component may also be implemented, in whole or in part, with instructions embodied in a memory, formatted to be executed by one or more general or application-specific processors.

In some examples, the receivers 3110 may include at least one radio frequency (RF) receiver, such as at least one RF receiver operable to receive transmissions over at least one radio frequency spectrum band. The receiver 3110 may be used to receive various data or control signals (i.e., transmissions) over one or more communication links of a wireless communication system.

In some examples, the transmitter 3130 may include at least one RF transmitter, such as at least one RF transmitter operable to transmit over at least one radio frequency spectrum band. The transmitter 3130 may be used to transmit various data or control signals (i.e., transmissions) over one or more communication links of a wireless communication system.

In some examples, the wireless communication manager 3120 may be used to manage one or more aspects of wireless communication for the apparatus 3105. In some examples, part of the wireless communication manager 3120 may be incorporated into or shared with the receiver 3110 or the transmitter 3130. In some examples, the wireless communication manager 3120 may include a content requester 3135, an optional ACPL manager 3140, an optional content query manager 3145, or a modem 3150.

The content requester 3135 may be used to generate a request to access content of a website. In some examples, the content requester 3135 may include an application or browser of a UE that includes the apparatus 3105.

The modem 3150 may include a mobile CDN content delivery acceleration information manager 3155. The mobile CDN content delivery acceleration information manager 3155 may be used to process the request to access the content of the website, and may in some cases associate mobile CDN content delivery acceleration information with a request to access content of a website.

The modem 3150 may be used to transmit requests to access content of a website, including requests associated with mobile CDN content delivery acceleration information, to a network access device.

The ACPL manager 3140 may be used to maintain an ACPL. The ACPL may include at least one content provider entry, with each of the content provider entries being associated with at least one of: a URL, a URI, a domain name, an HTTP server IP address, a port identifier, a protocol type, or a combination thereof. In some examples, the modem 3150 may be used to determine whether information associated with a request to access content of a website is included in the ACPL. Upon determining that information associated with the request to access content of a website is included in the ACPL, the mobile CDN content delivery acceleration information manager 3155 may be used to associate mobile CDN content delivery acceleration information with the request. In some examples, determining that information associated with a request to access content of a website is included in the ACPL may include determining a destination HTTP server IP address and a port associated with the request to access the content of the website is included in the ACPL. In some examples, determining that the information associated with the request to access the content of the website is included in the ACPL may further include determining a URL or URI associated with the request to access the content of the website is included in the ACPL.

In some examples, the modem 3150 may be used to monitor for HTTP server IP addresses associated with DNS requests and DNS responses processed at the modem 3150. In some examples, the monitoring may be performed for DNS requests and DNS responses associated with a DNS UDP port. In some examples, the monitoring may be performed based at least in part on a notification received at the modem 3150 from an API. In some examples, the ACPL manager 3140 may dynamically update the ACPL based at least in part on an HTTP server IP address.

The content query manager 3145 may be used to query a network access device to determine whether the network access device has locally cached the content of the website (e.g., at an edge node device associated with the network access device). In some examples, the querying may include transmitting an HTTP URL/URI request using an RRC signaling extension. In some examples, processing a request to access content of a website at the modem 3150 may include associating mobile CDN content delivery acceleration information with the request to access the content of the website in response to determining that the network access device has locally cached the content of the website.

In some examples, the apparatus 3105 may be included in a UE employing UE-assisted selective content delivery acceleration based on an ACPL or UE employing UE-assisted selective content delivery acceleration based on out-of-band messaging, as described with reference to FIG. 18, 19, 20, or 21. In some examples, the apparatus 3105 may be included in a UE that dynamically updates HTTP server IP addresses included in an ACPL, as described with reference to FIG. 17.

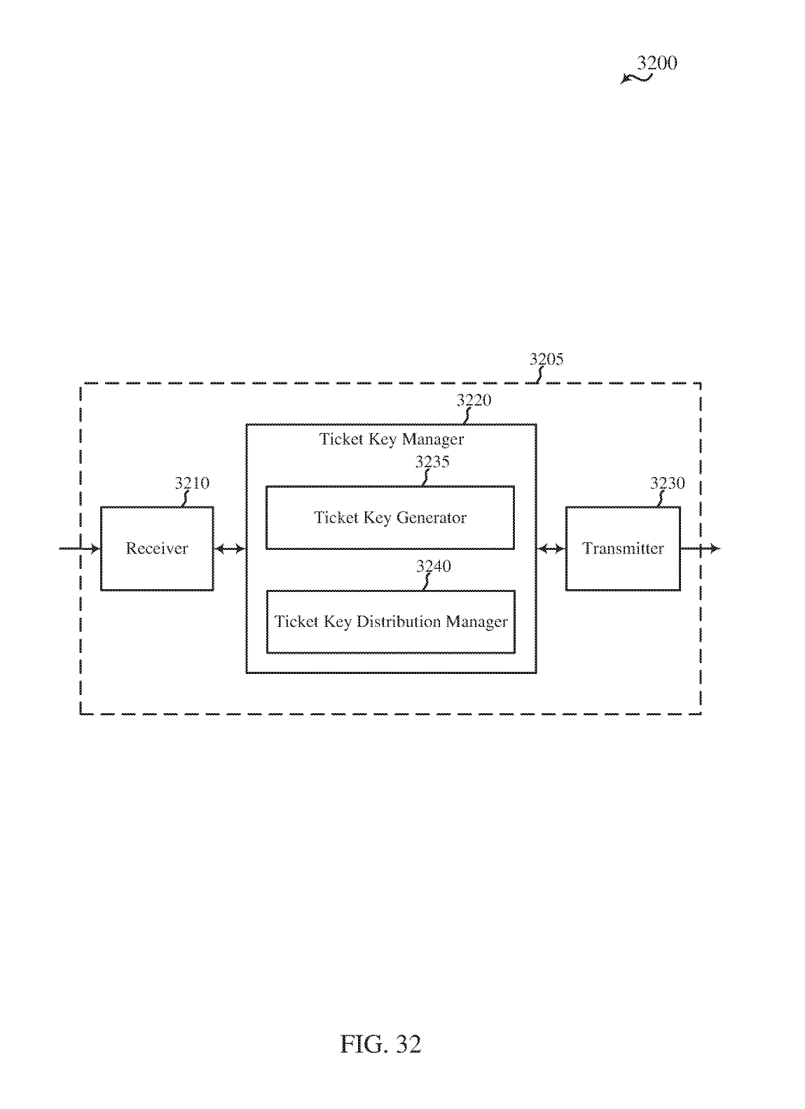

FIG. 32 shows a block diagram 3200 of an apparatus 3205 for managing ticket keys at a ticket server, in accordance with various aspects of the present disclosure. The apparatus 3205 may be an example of aspects of the ticket key server 2405 described with reference to FIG. 24. The apparatus 3205 may also be or include a processor. The apparatus 3205 may include a receiver 3210, a ticket key manager 3220, or a transmitter 3230. Each of these components may be in communication with each other.

The components of the apparatus 3205 may, individually or collectively, be implemented using one or more ASICs adapted to perform some or all of the applicable functions in hardware. Alternatively, the functions may be performed by one or more other processing units (or cores), on one or more integrated circuits. In other examples, others of integrated circuits may be used (e.g., Structured/Platform ASICs, FPGAs, a SoC, and/or others of Semi-Custom ICs), which may be programmed in any manner known in the art. The functions of each component may also be implemented, in whole or in part, with instructions embodied in a memory, formatted to be executed by one or more general or application-specific processors.

In some examples, the receiver 3210 may include an interface with one or more network access devices (e.g., one or more base stations or eNBs) or other edge node devices. The receiver 3210 may be used to receive various data or control signals (i.e., transmissions). In some examples, the transmitter 3230 may include an interface with the one or more network access devices or other edge node devices. The transmitter 3230 may be used to transmit various data or control signals (i.e., transmissions).

In some examples, the ticket key manager 3220 may be used to manage ticket keys. In some examples, part of the ticket key manager 3220 may be incorporated into or shared with the receiver 3210 or the transmitter 3230. In some examples, the ticket key manager 3220 may include a ticket key generator 3235 or a ticket key distribution manager 3240.

The ticket key generator 3235 may be used to periodically generating a ticket key. The ticket key distribution manager 3240 may be used to periodically transmit the periodically generated ticket key to each edge node device of a plurality edge node devices. In some examples, at least one of the plurality of edge node devices may be associated with a network access device of a mobile CDN.

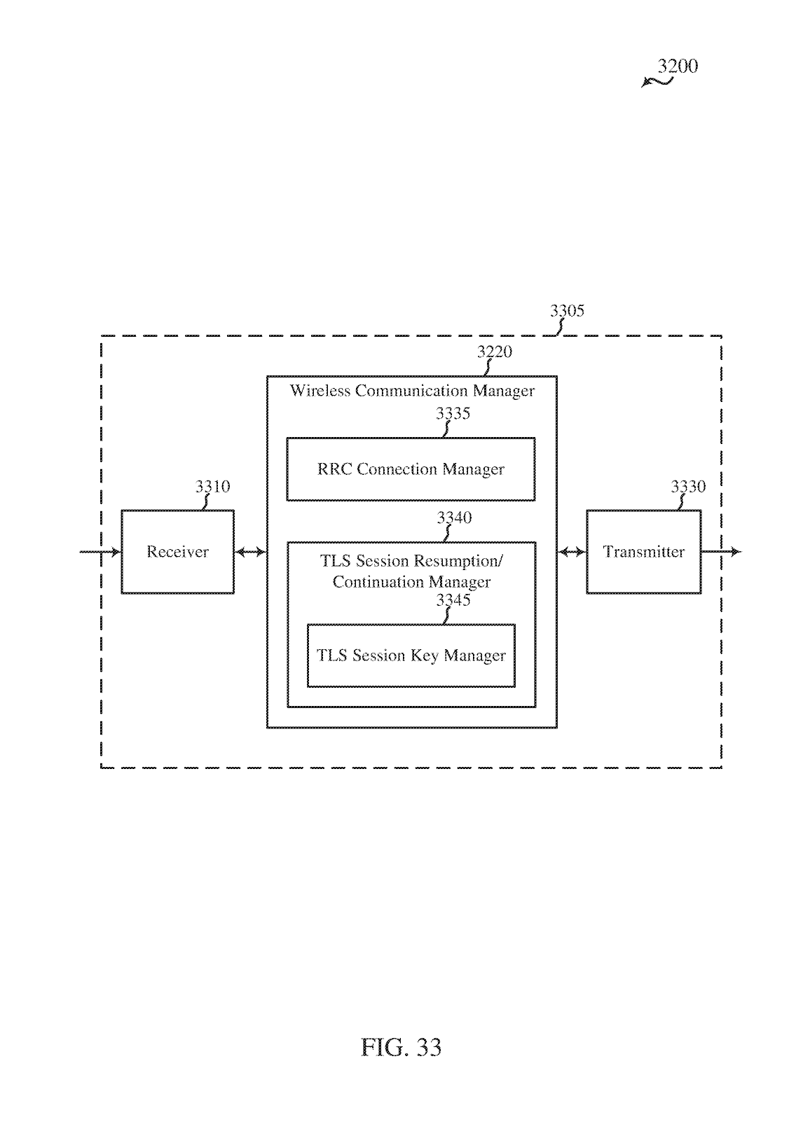

FIG. 33 shows a block diagram 3300 of an apparatus 3305 for wireless communication within a CDN, in accordance with various aspects of the present disclosure. The apparatus 3305 may be an example of aspects of one or more of the UEs 115 described with reference to FIGS. 1-8, 10-12, 17-21, and 25-29, or aspects of one or more of the edge node devices 310 described with reference to FIGS. 2-4, 9, 13-16, and 18-29. The apparatus 3305 may also be or include a processor. The apparatus 3305 may include a receiver 3310, a wireless communication manager 3320, or a transmitter 3330. Each of these components may be in communication with each other.

The components of the apparatus 3305 may, individually or collectively, be implemented using one or more ASICs adapted to perform some or all of the applicable functions in hardware. Alternatively, the functions may be performed by one or more other processing units (or cores), on one or more integrated circuits. In other examples, others of integrated circuits may be used (e.g., Structured/Platform ASICs, FPGAs, a SoC, and/or others of Semi-Custom ICs), which may be programmed in any manner known in the art. The functions of each component may also be implemented, in whole or in part, with instructions embodied in a memory, formatted to be executed by one or more general or application-specific processors.

In examples in which the apparatus 3305 is included in a UE, the receiver 3310 may include at least one RF receiver, such as at least one RF receiver operable to receive transmissions over at least one radio frequency spectrum band, and the transmitter 3330 may include at least one RF transmitter, such as at least one RF transmitter operable to transmit over at least one radio frequency spectrum band. The receiver 3310 may be used to receive various data or control signals (i.e., transmissions) over one or more communication links of a wireless communication system, and the transmitter 3330 may be used to transmit various data or control signals (i.e., transmissions) over one or more communication links of a wireless communication system.

In examples in which the apparatus 3305 is included in an edge node device, the receiver 3310 may include an interface with one or more network access devices (e.g., one or more base stations or eNBs) or other edge node devices, and the transmitter 3330 may include an interface with the one or more network access devices or other edge node devices. The receiver 3310 may be used to receive various data or control signals (i.e., transmissions), and the transmitter 3330 may be used to transmit various data or control signals (i.e., transmissions).

In some examples, the wireless communication manager 3320 may be used to manage wireless communication within a CDN. In some examples, part of the wireless communication manager 3320 may be incorporated into or shared with the receiver 3310 or the transmitter 3330. In some examples, the wireless communication manager 3320 may include an RRC connection manager 3335 or a TLS session resumption/continuation manager 3340.

The RRC connection manager 3335 may be used to set up an RRC connection between a UE and a target edge node device. The target edge node device may be associated with a target network access device, and the UE and target edge node device may communicate through the target network access device.

The TLS session resumption/continuation manager 3340 may be used to resume or continue, between the UE and the target edge node device, a TLS session established between the UE and a source edge node device associated with a source network access device. The UE and the source edge node device may communicate through the source network access device.

The TLS session resumption/continuation manager 3340 may include a TLS session key manager 3345. In some examples in which the apparatus 3305 is included in a UE (e.g., the UE involved in the message flow 2500, 2700, or 2800 described with reference to FIG. 25, 27, or 28), the TLS session key manager 3345 may be used to transmit, to the target edge node device, and after setting up the RRC connection with the target edge node device, a TLS session ticket including an encrypted TLS session key for a TLS session established between the UE and the source edge node device.

In some examples in which the apparatus 3305 is included in a UE (e.g., the UE involved in the message flow 2600 or 2900 described with reference to FIG. 26 or 29), the TLS session key manager 3345 may be used to receive, after setting up the RRC connection with the target edge node device, a TLS message transmitted by the target edge node device. The TLS session key manager 3345 may also be used to transmit to the target edge node device, in response to receiving the TLS message, a TLS session ticket including an encrypted TLS session key for a TLS session established between the UE and the source edge node device.

In some examples in which the apparatus 3305 is included in a target edge node device (e.g., the target edge node device involved in the message flow 2500, 2700, or 2800 described with reference to FIG. 25, 27, or 28), the TLS session key manager 3345 may be used to receive from the UE, after setting up the RRC connection with the UE, a TLS session ticket including an encrypted TLS session key for a TLS session established between the UE and the source edge node device. The TLS session key manager 3345 may also be used to decrypt the encrypted TLS session key, based at least in part on a ticket key received by the target edge node device and the source edge node device (e.g., from a ticket server).

In some examples in which the apparatus 3305 is included in a target edge node device (e.g., the target edge node device involved in the message flow 2700 described with reference to FIG. 27), the TLS session key manager 3345 may be used to receive, from a source edge node device, a TLS session ticket including an encrypted TLS session key for a TLS session established between a UE and the source edge node device. In some examples, the TLS session ticket may be received with a request for handover of the UE from the source network access device to the target network access device, before the RRC connection is established with the UE. The TLS session key manager 3345 may also be used to decrypt the encrypted TLS session key, based at least in part on a ticket key received by the target edge node device and the source edge node device (e.g., from a ticket server).

In some examples in which the apparatus 3305 is included in a target edge node device (e.g., the target edge node device involved in the message flow 2600 or 2900 described with reference to FIG. 26 or 29), the TLS session key manager 3345 may be used to transmit to the UE, after setting up the RRC connection with the UE, a TLS message. The TLS session key manager 3345 may also be used to receive from the UE, in response to transmitting the TLS message, a TLS session ticket including an encrypted TLS session key for a TLS session established between the UE and a source edge node device. The TLS session key manager 3345 may also be used to decrypt the encrypted TLS session key, based at least in part on a ticket key received by the target edge node device and the source edge node device (e.g., from a ticket server).

In some examples of the apparatus 3305, the CDN may include a mobile CDN between the UE and a PGW, and at least one of the source edge node device of the target edge node device may be within the mobile CDN. In other examples, the CDN may include the mobile CDN, and at least one of the source edge node device or the target edge node device may be within the CDN and outside the mobile CDN. In some examples, the TLS session resumption/continuation manager 3340 may perform a TLS handshake between the UE and the target edge node device in a single round-trip message transfer.

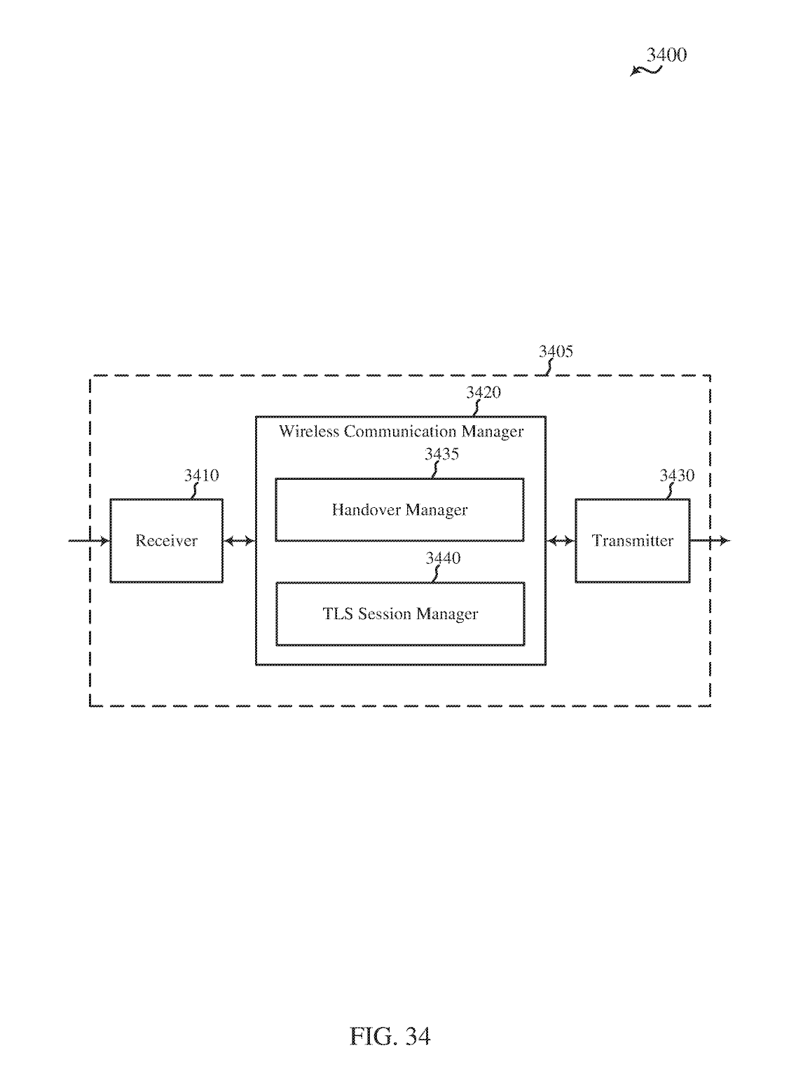

FIG. 34 shows a block diagram 3400 of an apparatus 3405 for use in wireless communication at a source network access device, in accordance with various aspects of the present disclosure. The apparatus 3405 may be an example of aspects of one or more of the network access devices 230 described with reference to FIGS. 1-4, 7, 8, 13, 16, 19-22, and 25-29. The apparatus 3405 may also be or include a processor. The apparatus 3405 may include a receiver 3410, a wireless communication manager 3420, or a transmitter 3430. Each of these components may be in communication with each other.

The components of the apparatus 3405 may, individually or collectively, be implemented using one or more ASICs adapted to perform some or all of the applicable functions in hardware. Alternatively, the functions may be performed by one or more other processing emits (or cores), on one or more integrated circuits. In other examples, others of integrated circuits may be used (e.g., Structured/Platform ASICs, FPGAs, a SoC, and/or others of Semi-Custom ICs), which may be programmed in any manner known in the art. The functions of each component may also be implemented, in whole or in part, with instructions embodied in a memory, formatted to be executed by one or more general or application-specific processors.

In some examples, the receiver 3410 may include at least one RF receiver, such as at least one RF receiver operable to receive transmissions over at least one radio frequency spectrum band. The receiver 3410 may be used to receive various data or control signals (i.e., transmissions) over one or more communication links of a wireless communication system.

In some examples, the transmitter 3430 may include at least one RF transmitter, such as at least one RF transmitter operable to transmit over at least one radio frequency spectrum band. The transmitter 3430 may be used to transmit various data or control signals (i.e., transmissions) over one or more communication links of a wireless communication system.

In some examples, the wireless communication manager 3420 may be used to manage one or more aspects of wireless communication for the apparatus 3405. In some examples, part of the wireless communication manager 3420 may be incorporated into or shared with the receiver 3410 or the transmitter 3430. In some examples, the wireless communication manager 3420 may include a handover manager 3435 or a TLS session manager 3440.

The handover manager 3435 may be used to transmit, to a target network access device, a request for handover of a UE from the source network access device to the target network access device. The handover manager 3435 may also receive an acknowledgement of the request for handover of the UE (e.g., from the target network access device).

The TLS session manager 3440 may be used to transmit to the UE, based at least in part on receiving the acknowledgement of the request for handover of the UE, an indication to close an established TLS session with a source edge node device associated with the source network access device.

The handover manager 3435 may be used to transmit a handover command to the UE, after transmitting the indication to close the TLS session.

In some examples, the apparatus 3405 may be included in the source network access device described with reference to FIG. 27.

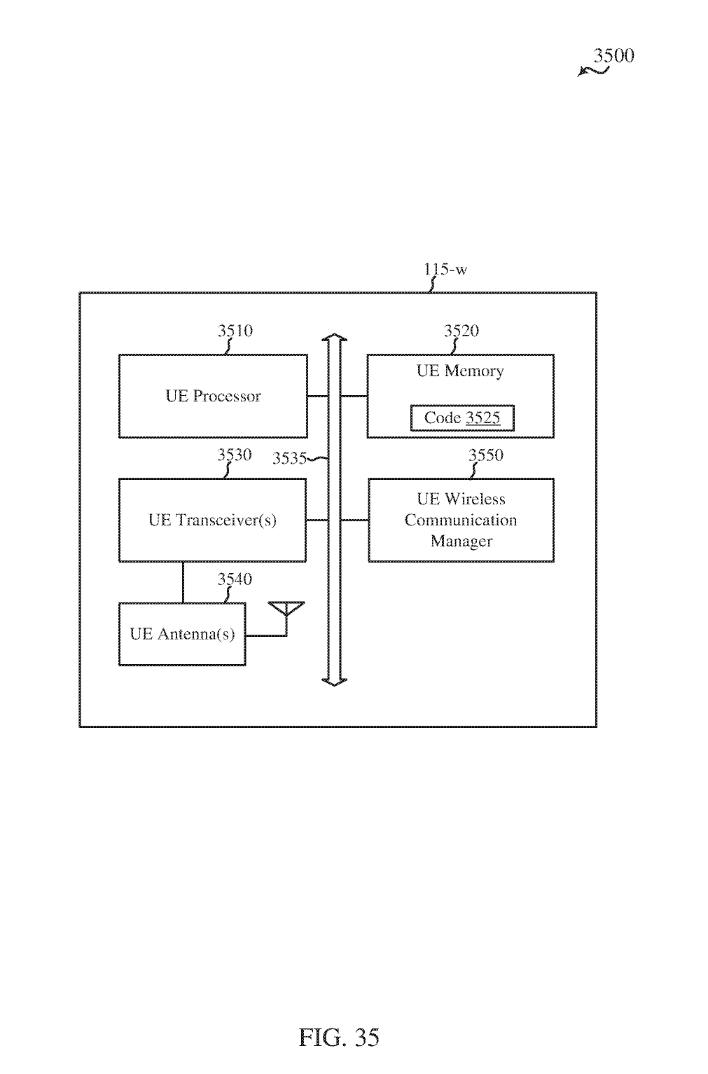

FIG. 35 shows a block diagram 3500 of a UE 115-w for use in wireless communication, in accordance with various aspects of the present disclosure. The UE 115-w may, in some examples, have an internal power supply (not shown), such as a small battery, to facilitate mobile or remote operation. In some examples, the UE 115-w may be an example of aspects of one or more of the UEs 115 described with reference to FIGS. 1-8, 10-12, 17-21, and 25-29, or aspects of one or more of the apparatuses 3105 or 3305 described with reference to FIGS. 31 and 33. The UE 115-w may be configured to implement at least some of the UE and/or apparatus features and functions described in the present disclosure.

The UE 115-w may include a UE processor 3510, a UE memory 3520, at least one UE transceiver (represented by UE transceiver(s) 3530), at least one UE antenna (represented by UE antenna(s) 3540), or a UE wireless communication manager 3550. Each of these components may be in communication with each other, directly or indirectly, over one or more buses 3535.

The UE memory 3520 may include random access memory (RAM) or read-only memory (ROM). The UE memory 3520 may store computer-readable, computer-executable code 3525 containing instructions that are configured to, when executed, cause the UE processor 3510 to perform various functions described herein related to wireless communication, including, for example, the request and receipt of content delivered over a CDN. Alternatively, the computer-executable code 3525 may not be directly executable by the UE processor 3510 but be configured to cause the UE 115-w (e.g., when compiled and executed) to perform various of the functions described herein.

The UE processor 3510 may include an intelligent hardware device, e.g., a central processing unit (CPU), a microcontroller, an ASIC, etc. The UE processor 3510 may process information received through the UE transceiver(s) 3530 or information to be sent to the UE transceiver(s) 3530 for transmission through the UE antenna(s) 3540. The UE processor 3510 may handle, alone or in connection with the UE wireless communication manager 3550, various aspects of communicating over (or managing communications over) one of more radio frequency spectrum bands.

The UE transceiver(s) 3530 may include a modem configured to modulate packets and provide the modulated packets to the UE antenna(s) 3540 for transmission, and to demodulate packets received from the UE antenna(s) 3540. The UE transceiver(s) 3530 may, in some examples, be implemented as one or more UE transmitters and one or more separate UE receivers. The UE transceiver(s) 3530 may support communications over one or more wireless communication links. The UE transceiver(s) 3530 may be configured to communicate bi-directionally, via the UE antenna(s) 3540, with one or more base stations or other devices, such as one or more of the base stations 105 or network access devices 230 described with reference to FIGS. 1-4, 7, 8, 13, 16, 19-22, 25-29, and 36, or aspects of the apparatus 3405 described with reference to FIG. 34. While the UE 115-w may include a single UE antenna, there may be examples in which the UE 115-w may include multiple UE antennas.

The UE wireless communication manager 3550 may be configured to perform or control some or all of the UE or wireless device features or functions described in the present disclosure. The UE wireless communication manager 3550, or portions of it, may include a processor, or some or all of the functions of the UE wireless communication manager 3550 may be performed by the UE processor 3510 or in connection with the UE processor 3510. In some examples, the UE wireless communication manager 3550 may be an example of the wireless communication manager 3120 or 3320 described with reference to FIG. 31 or 33.

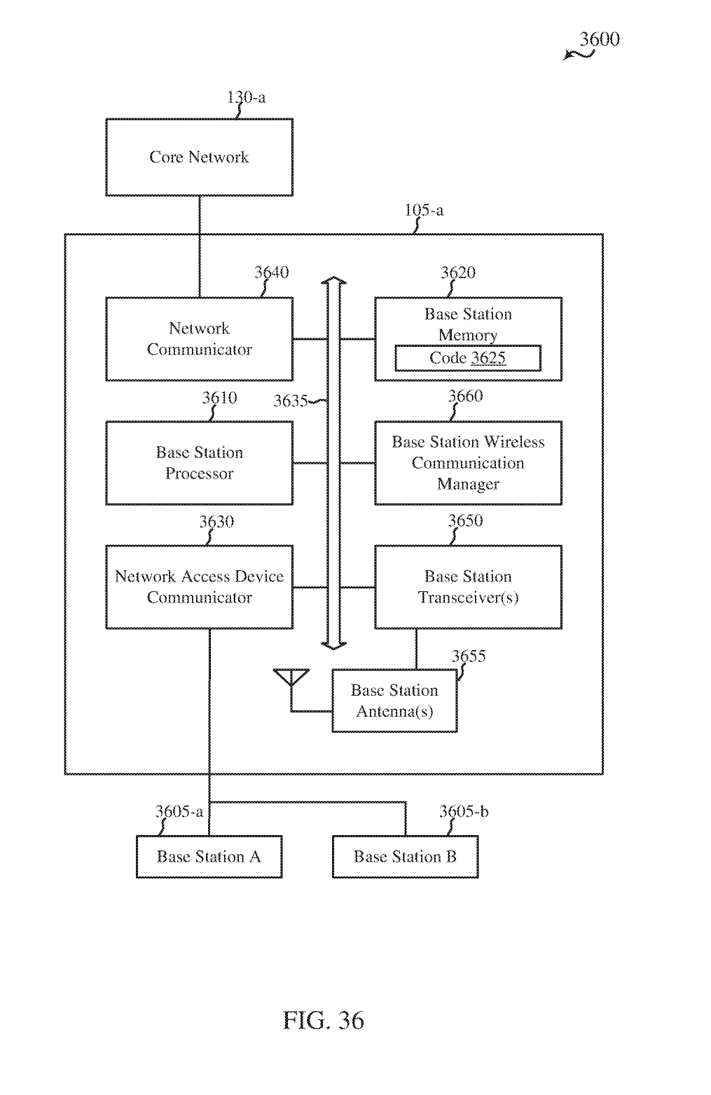

FIG. 36 shows a block diagram 3600 of a base station 105-a (e.g., a base station forming part or all of an eNB) for use in wireless communication, in accordance with various aspects of the present disclosure. In some examples, the base station 105-a may be an example of aspects of one or more of the base stations 105 or network access devices 230 described with reference to FIGS. 1-4, 7, 8, 13, 16, 19-22, and 25-29, or aspects of the apparatus 3405 described with reference to FIG. 34. The base station 105-a may be configured to implement or facilitate at least some of the base station features and functions described in the present disclosure.

The base station 105-a may include a base station processor 3610, a base station memory 3620, at least one base station transceiver (represented by base station transceiver(s) 3650), at least one base station antenna (represented by base station antenna(s) 3655), or a base station wireless communication manager 3660. The base station 105-a may also include one or more of a network access device communicator 3630 or a network communicator 3640. Each of these components may be in communication with each other, directly or indirectly, over one of more buses 3635.

The base station memory 3620 may include RAM or ROM. The base station memory 3620 may store computer-readable, computer-executable code 3625 containing instructions that are configured to, when executed, cause the base station processor 3610 to perform various functions described herein related to wireless communication, including, for example, the routing or processing of requests for content and content transmitted over a CDN. Alternatively, the computer-executable code 3625 may not be directly executable by the base station processor 3610 but be configured to cause the base station 105-a (e.g., when complied and executed) to perform various of the functions described herein.

The base station processor 3610 may include an intelligent hardware device, e.g., a CPU, a microcontroller, an ASIC, etc. The base station processor 3610 may process information received through the base station transceiver(s) 3650, the network access device communicator 3630, or the network communicator 3640. The base station processor 3610 may also process information to be sent to the transceiver(s) 3650 for transmission through the antenna(s) 3655, to the network access device communicator 3630, for transmission to one or more other base stations (e.g., the base station 105-a-a or the base station 105-a-b), or to the network communicator 3640 for transmission to a core network 130-a, which may be an example of one or more aspects of the core network 130 described with reference to FIG. 1. The base station processor 3610 may handle, alone or in connection with the base station wireless communication manager 3660, various aspects of communicating over (or managing communications over) one or more radio frequency spectrum bands.

The base station transceiver(s) 3650 may include a modem configured to modulate packets and provide the modulated packets to the base station antenna(s) 3655 for transmission, and to demodulate packets received from the base station antenna(s) 3655. The base station transceiver(s) 3650 may, in some examples, be implemented as one or more base station transmitters and one or more separate base station receivers. The base station transceiver(s) 3650 may support communication over one or more wireless communication links. The base station transceiver(s) 3650 may be configured to communicate bi-directional, via the antenna(s) 3655, with one or more UEs or other apparatuses, such as one or more of the UEs 115 described with reference to FIGS. 1-8, 10-12, 17-21, 25-29, and 35, or one of the apparatus 3105 or 3305, described with reference to FIGS. 31 and 33. The base station 105-a may, for example, include multiple base station antennas (e.g., an antenna array). The base station 105-a may communicate with the core network 130-a, an Internet CDN, and/or one or more edge node devices of a mobile CDN or Internet CDN through the network communicator 3640. The base station 105-a may also communicate with other network access devices (e.g., other base stations, such as the base station 105-a-a or the base station 105-a-b), using the network access device communicator 3630.

The base station wireless communication manager 3660 may be configured to perform or control some or all of the base station or network access device features or functions described in the present disclosure. The base station wireless communication manager 3660, or portions of it, may include a processor, or some or all of the functions of the base station wireless communication manager 3660 may be performed by the base station processor 3610 or in connection with the base station processor 3610. In some examples, the base station wireless communication manager 3660 may be an example of the wireless communication manager 3420 described with reference to FIG. 34.

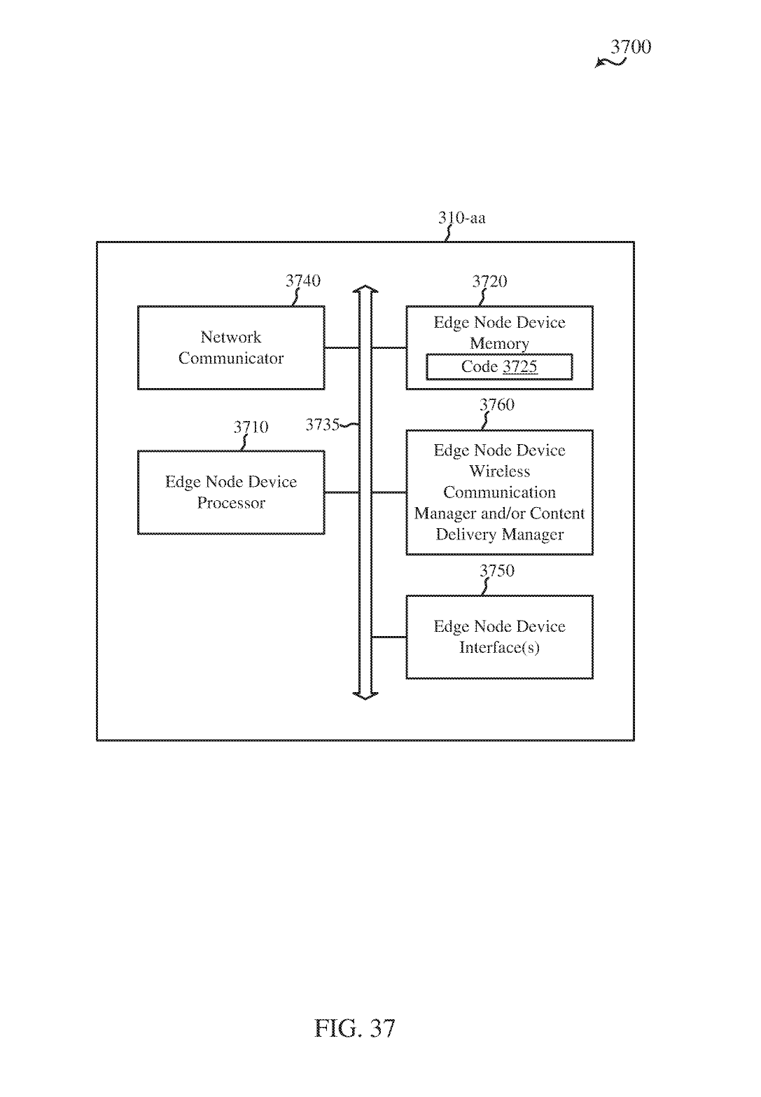

FIG. 37 shows a block diagram 3700 of an edge node device 310-aa (e.g., an edge node device above or below a PGW) for use in wireless communication, in accordance with various aspects of the present disclosure. In some examples, the edge node device 310-aa may be an example of aspects of one or more of the edge node devices 310 described with reference to FIGS. 2-4, 13-16, and 18-29, or aspects of one or more of the apparatuses 3005 or 3305 described with reference to FIGS. 30 and 33. The edge node device 310-aa may be configured to implement or facilitate at least some of the edge node device features and functions described in the present disclosure.

The edge node device 310-aa may include an edge node device processor 3710, an edge node device memory 3720, at least one edge node device interface (represented by edge node device interface(s) 3750), or an edge node device wireless communication manager and/or content delivery manager 3760. Each of these components may be in communication with each other, directly or indirectly, over one or more buses 3735.

The edge node device memory 3720 may include RAM or ROM. The edge node device memory 3720 may store computer-readable, computer-executable code 3725 containing instructions that are configured to, when executed, cause the edge node device processor 3710 to perform various functions described herein related to wireless communication, including, for example, the establishment of secure connections with UEs and other devices, the caching of content, the handling of requests for content received over a CDN, and the transmission of content over a CDN. Alternatively, the computer-executable code 3725 may not be directly executable by the edge node device processor 3710 but be configured to cause the edge node device 310-aa (e.g., when compiled and executed) to perform various of the functions described herein.

The edge node device processor 3710 may include an intelligent hardware device, e.g., a CPU, a microcontroller, an ASIC, etc. The edge node device processor 3710 may process information received through the edge node device interface(s) 3750. The edge node device processor 3710 may also process information to be transmitted through the edge node device interface(s) 3750 to one or more other edge node devices, network access devices, or UEs. The edge node device processor 3710 may handle, alone or in connection with the edge node device wireless communication manager and/or content delivery manager 3760, various aspects of communicating over (or managing communications over) the edge node device interface(s) 3750 and one or more CDNs.

The edge node device wireless communication manager and/or content delivery manager 3760 may be configured to perform or control some or all of the edge node device features or functions described in the present disclosure. The edge node device wireless communication manager and/or content delivery manager 3760, or portions of it, may include a processor, or some or all of the functions of the edge node device wireless communication manager and/or content delivery manager 3760 may be performed by the edge node device processor 3710 or in connection with the edge node device processor 3710. In some examples, the edge node device wireless communication manager and/or content delivery manager 3760 may be an example of the content delivery manager 3020 described with reference to FIG. 30 or the wireless communication manager 3320 described with reference to FIG. 33.

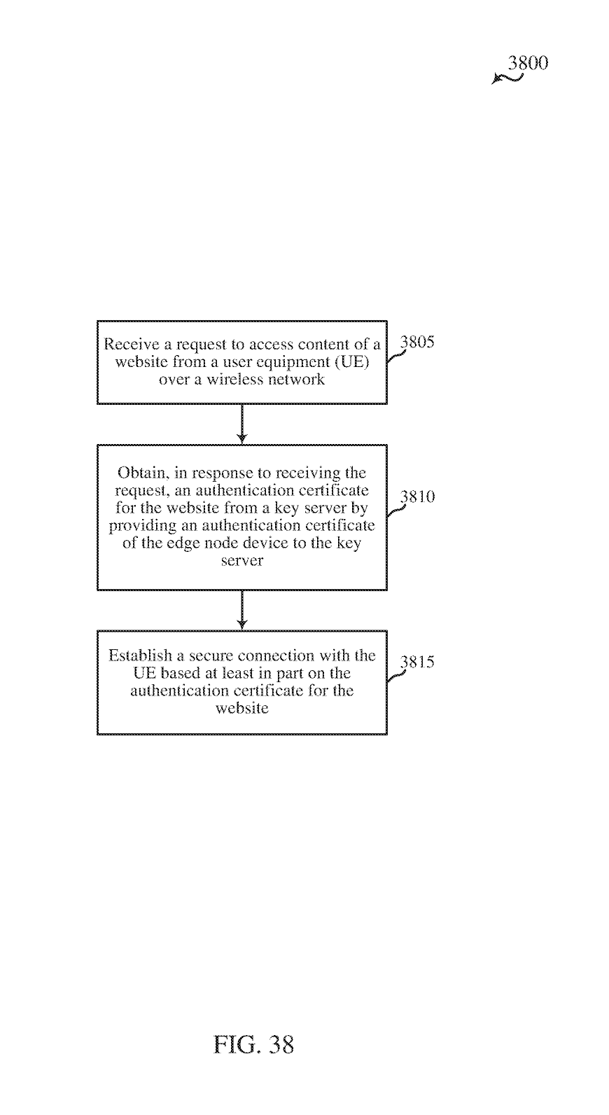

FIG. 38 is a flow chart illustrating an example of a method 3800 for handling content requests at an edge node device of a CDN, in accordance with various aspects of the present disclosure. In some examples, the CDN may include a mobile CDN between a UE and a PGW, and the edge node device may be within the mobile CDN. In other examples, the CDN may include the mobile CDN, and the edge node device may be within the CDN and outside the mobile CDN. For clarity, the method 3800 is described below with reference to aspects of one or more of the edge node devices 310 described with reference to FIGS. 2-4, 9, 13-16, 18-29, and 37, or aspects of one or more of the apparatuses 3005 or 3305 described with reference to FIGS. 30 and 33. In some examples, an edge node device may execute one or more sets of codes to control the functional elements of the edge node device to perform the functions described below. Additionally or alternatively, the edge node device may perform one or more of the functions described below using special-purpose hardware.

At block 3805, the method 3800 may include receiving a request to access content of a website, from a UE, over a wireless network. In some examples, the request to access the content of the website may be received through a network access device.

At block 3810, the method 3800 may include obtaining an authentication certificate for the website from a key server by providing an authentication certificate of the edge node device to the key server. The authentication certificate may be obtained in response to receiving the request at block 3805. In some examples, the method 3800 may include identifying the key server based at least in part on: the website to which the request to access content applies, an identified owner of the website, or a combination thereof.

At block 3815, the method 3800 may include establishing a secure connection with the UE based at least in part on the authentication certificate tor the website. In some examples, the secure connection with the UE may be established through a network access device.

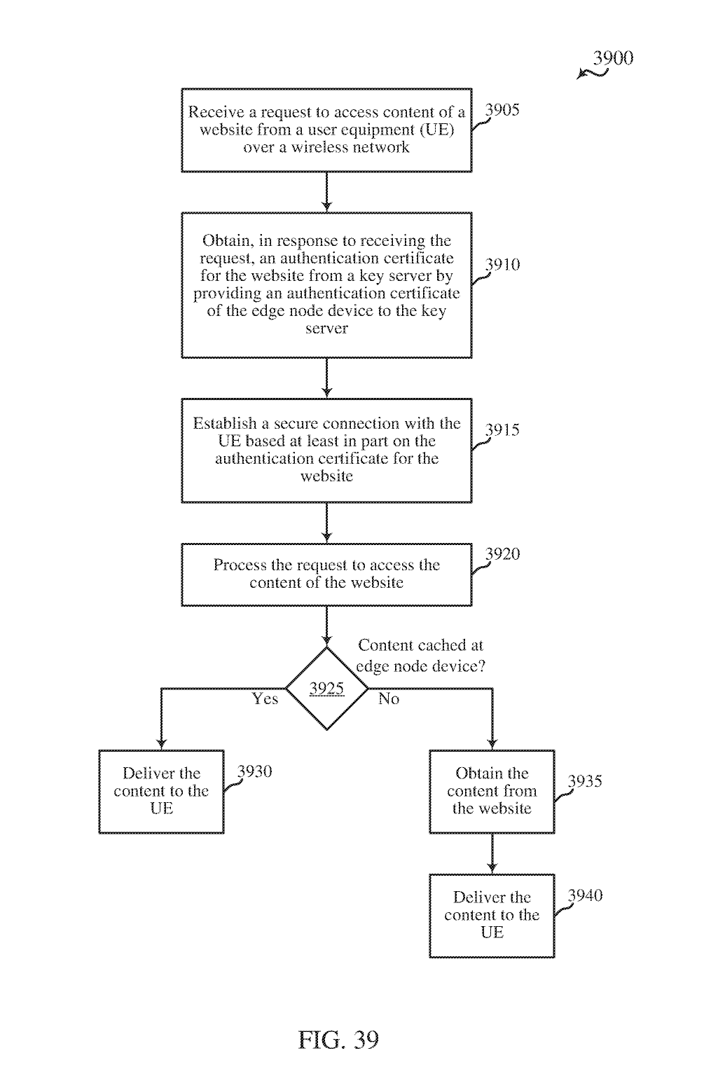

FIG. 39 is a flow chart illustrating an example of a method 3900 for handling content requests at an edge node device of a CDN, in accordance with various aspects of the present disclosure. In some examples, the CDN may include a mobile CDN between a UE and a PGW, and the edge node device may be within the mobile CDN. In other examples, the CDN may include the mobile CDN, and the edge node device may be within the CDN and outside the mobile CDN. For clarity, the method 3900 is described below with reference to aspects of one or more of the edge node devices 310 described with reference to FIGS. 2-4, 9, 13-16, 18-29, and 37, or aspects of one or more of the apparatuses 3005 or 3305 described with reference to FIGS. 30 and 33. In some examples, an edge node device may execute one or more sets of codes to control the functional elements of the edge node device to perform the functions described below. Additionally or alternatively, the edge node device may perform one or more of the functions described below using special-purpose hardware.

At block 3905, the method 3900 may include receiving a request to access content of a website, from a UE, over a wireless network. In some examples, the request to access the content of the website may be received through a network access device.

At block 3910, the method 3900 may include obtaining an authentication certificate for the website from a key server by providing an authentication certificate of the edge node device to the key server. The authentication certificate may be obtained in response to receiving the request at block 3905. In some examples, the method 3900 may include identifying the key server based at least in part on: the website to which the request to access content applies, an identified owner of the website, or a combination thereof.

At block 3915, the method 3900 may include establishing a secure connection with the UE based at least in part on the authentication certificate for the website. In some examples, establishing the secure connection with the UE may include transmitting the authentication certificate for the website to the UE; receiving an encrypted premaster secret from the UE; transmitting the encrypted premaster secret to the key server; receiving a decrypted premaster secret from the key server; and establishing the secure connection with the UE based at least in part on the decrypted premaster secret. In some examples, the secure connection with the UE may be established through a network access device.

At block 3920, after establishing the secure connection with the UE at block 3915, the method 3900 may include processing the request to access the content of the website. At block 3925, the method 3900 may include determining whether the content is cached at the edge node device. In some examples, the method 3900 may include determining that the content is cached at the edge node device based at least in part on mobile CDN content delivery acceleration information associated with the request to access the content, and the method 3900 may continue at block 3930. In some examples, the method 3900 may include determining that the content is not cached at the edge node device based at least in part on mobile CDN content delivery acceleration information associated with the request to access the content, and the method 3900 may continue at block 3935.

At block 3930, the method 3900 may include delivering the content to the UE.

At block 3935, the method 3900 may include obtaining the content from the website; and at block 3940, the method 3900 may include delivering the content to the UE.

In some examples, the method 3800 or 3900 described with reference to FIG. 38 or 39 may be performed by an edge node device involved in the certificateless HTTPs authentication scenario described with reference to FIG. 16.

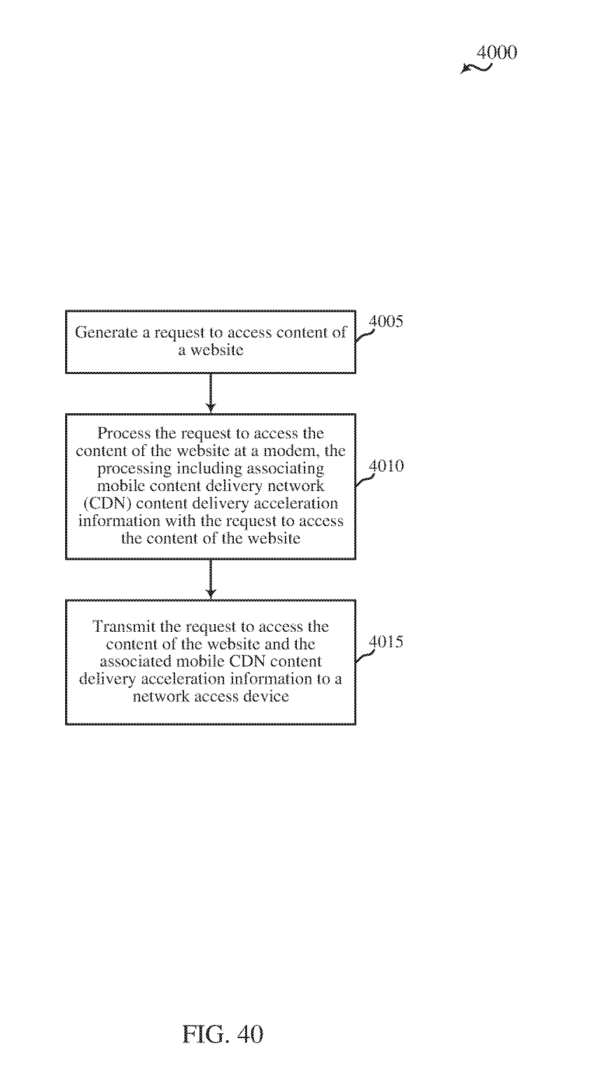

FIG. 40 is a flow chart illustrating an example of a method 4000 for wireless communication at a UE, in accordance with various aspects of the present disclosure. For clarity, the method 4000 is described below with reference to aspects of one or more of the UEs 115 described with reference to FIGS. 1-8, 10-12, 17-21, 25-29, and 35, or aspects of one or more of the apparatuses 3105 or 3305 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4005, the method 4000 may include generating a request to access content of a website.

At block 4010, the method 4000 may include processing the request to access the content of the website at a modem. The processing may include associating mobile CDN content delivery acceleration information with the request to access the content of the website.

At block 4015, the method 4000 may include transmitting the request to access the content of the website and the associated mobile CDN content delivery acceleration information to a network access device.

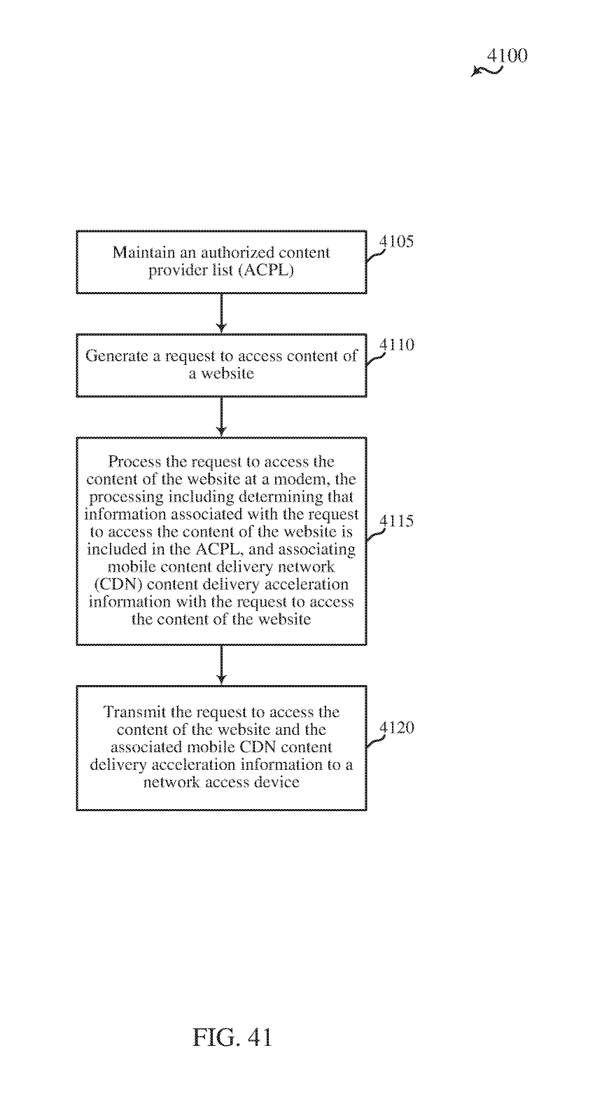

FIG. 41 is a flow chart illustrating an example of a method 4100 for wireless communication at a UE, in accordance with various aspects of the present disclosure. For clarity, the method 4100 is described below with reference to aspects of one or more of the UEs 115 described with reference to FIGS. 1-8, 10-12, 17-21, 25-29, and 35, or aspects of one or more of the apparatuses 3105 or 3305 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4105, the method 4100 may include maintaining an ACPL. The ACPL may include at least one content provider entry, with each of the content provider entries being associated with at least one of: a URL, a URI, a domain name, an HTTP server IP address, a port identifier, a protocol type, or a combination thereof.

At block 4110, the method 4100 may include generating a request to access content of a website.

At block 4115, the method 4100 may include processing the request to access the content of the website at a modem. The processing may include determining that information associated with the request to access the content of the website is included in the ACPL, and associating mobile CDN content delivery acceleration information with the request to access the content of the website. In some examples, determining that information associated with the request to access the content of the website is included in the ACPL may include determining a destination HTTP server IP address and a port associated with the request to access the content of the website is included in the ACPL. In some examples, determining that information associated with the request to access the content of the website is included in the ACPL may further include determining a URL or URI associated with the request to access the content of the website is included in the ACPL.

At block 4120, the method 4100 may include transmitting the request to access the content of the website and the associated mobile CDN content delivery acceleration information to a network access device.

In some examples, the method 4000 or 4100 described with reference to FIG. 40 or 41 may be performed by a UE employing UE-assisted selective content delivery acceleration based on an ACPL, as described with reference to FIG. 18 or 19.

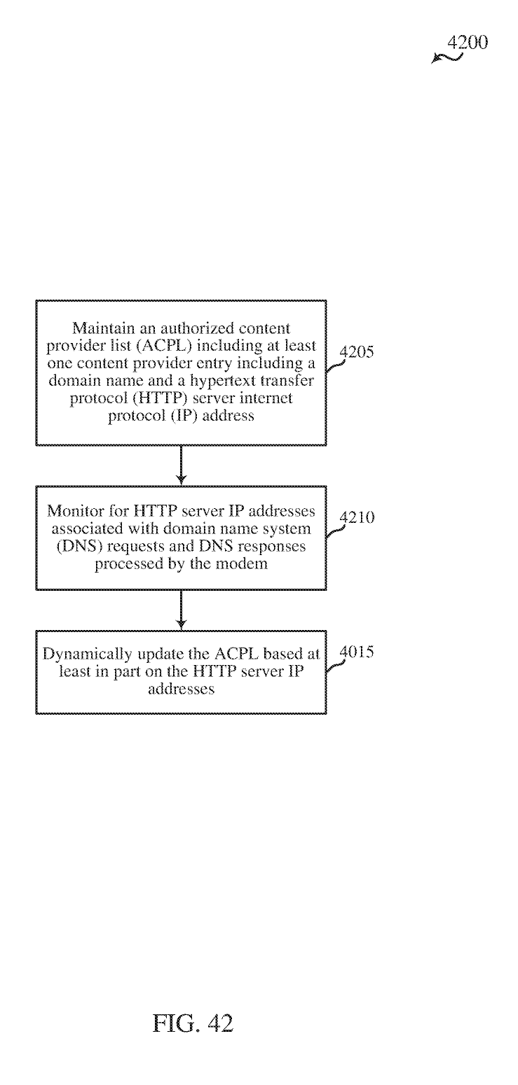

FIG. 42 is a flow chart illustrating an example of a method 4200 for wireless communication at a UE, in accordance with various aspects of the present disclosure. For clarity, the method 4200 is described below with reference to aspects of one or more of the UEs 115 described with reference to FIGS. 1-8, 10-12, 17-21, 25-29, and 35, or aspects of one or more of the apparatuses 3105 or 3305 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4205, the method 4200 may include maintaining an ACPL. The ACPL may include at least one content provider entry, with each of the content provider entries being associated with at least one of: a URL, a URI, a domain name, an HTTP server IP address, a port identifier, a protocol type, or a combination thereof.

At block 4210, the method 4200 may include monitoring for HTTP server IP addresses associated with DNS requests and DNS responses processed by a modem of the UE. In some examples, the monitoring may be performed for DNS requests and DNS responses associated with a DNS UDP port. In some examples, the monitoring may be performed based at least in part on a notification received at the modem from an API.

At block 4215, the method 4200 may include dynamically updating the ACPL based at least in part on the HTTP server IP addresses.

In some examples, the method 4200 may performed in conjunction with the method 4000 or 4100 described with reference to FIG. 40 or 41. In some examples, the method 4200 may be performed by a UE that dynamically updates HTTP server IP addresses included in an ACPL, as described with reference to FIG. 17.

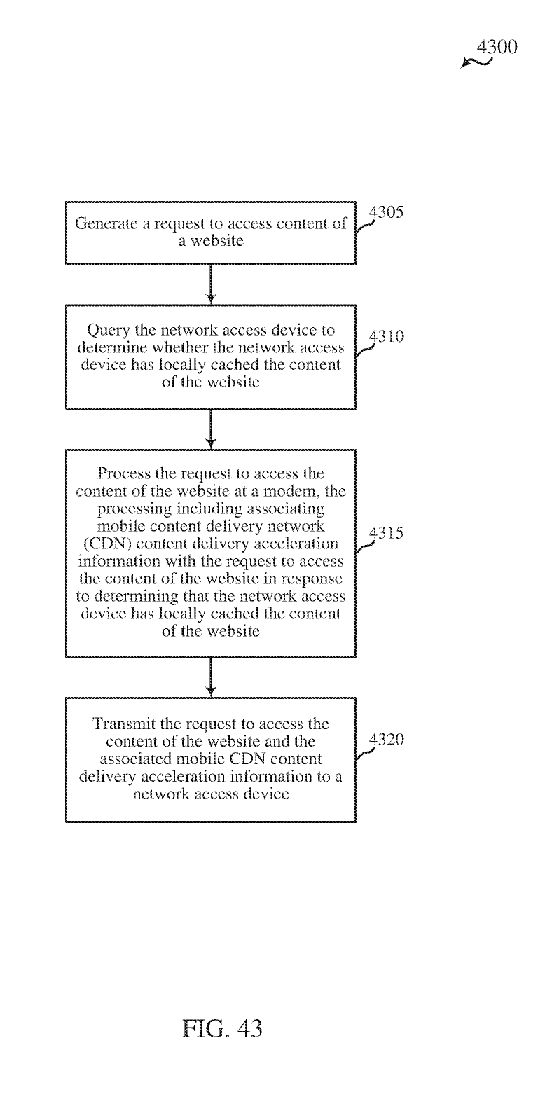

FIG. 43 is a flow chart illustrating an example of a method 4300 for wireless communication at a UE, in accordance with various aspects of the present disclosure. For clarity, the method 4300 is described below with reference to aspects of one or more of the UEs 115 described with reference to FIGS. 1-8, 10-12, 17-24, 25-29, and 35, or aspects of one or more of the apparatuses 3105 or 3305 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4305, the method 4300 may include generating a request to access content of a website.

At block 4310, the method 4300 may include querying a network access device to determine whether the network access device has locally cached the content of the website (e.g., at an edge node device associated with the network access device). In some examples, the querying may include transmitting an HTTP URL/URI request using an RRC signaling extension.

At block 4315, the method 4300 may include processing the request to access the content of the website at a modem. The processing may include associating mobile CDN content delivery acceleration information with the request to access the content of the website. The mobile CDN content delivery acceleration information may be associated with the request to access the content of the website in response to determining that the network access device has locally cached the content of the website.

At block 4320, the method 4300 may include transmitting the request to access the content of the website and the associated mobile CDN content delivery acceleration information to the network access device.

In some examples, the method 4000 or 4300 may be performed by a UE employing UE-assisted selective content delivery acceleration based on out-of-band messaging, as described with reference to FIG. 20 or 21.

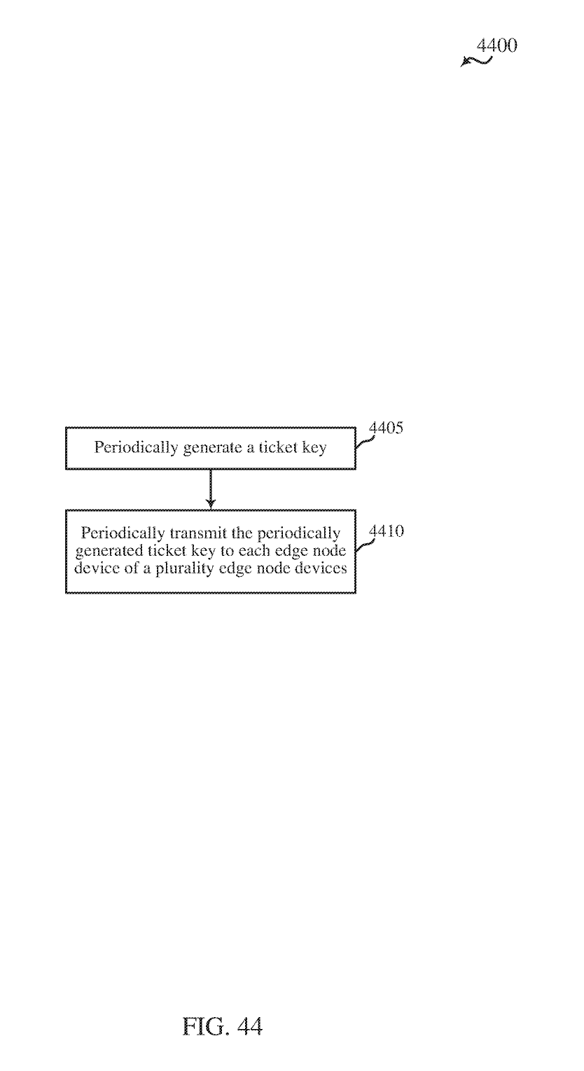

FIG. 44 is a flow chart illustrating an example of a method 4400 for managing ticket keys at a ticket server, in accordance with various aspects of the present disclosure. For clarity, the method 4400 is described below with reference to aspects of the ticket key server 2405 described with reference to FIG. 24, or aspects of the apparatus 3205 described with reference to FIG. 32. In some examples, a ticket server may execute one or more sets of codes to control the functional elements of the ticket server to perform the functions described below. Additionally or alternatively, the ticket server may perform one or more of the functions described below using special-purpose hardware.

At block 4405, the method 4400 may include periodically generating a ticket key. At block 4410, the method 4400 may include periodically transmitting the periodically generated ticket key to each edge node device of a plurality edge node devices. In some examples, at least one of the plurality of edge node devices may be associated with a network access device of a mobile CDN.

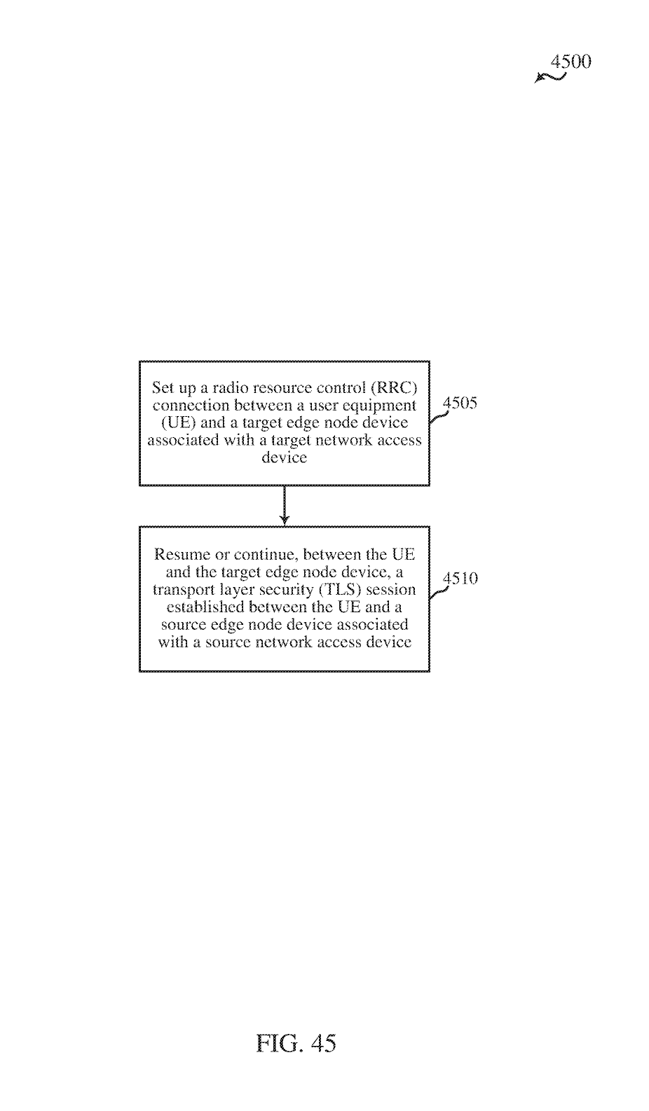

FIG. 45 is a flow chart illustrating an example of a method 4500 for wireless communication within a CDN, in accordance with various aspects of the present disclosure. The method 4500 may be performed by a UE or a target edge node device. For clarity, the method 4500 is described below with reference to aspects of one or more of the UEs 115 described with reference to FIGS. 1-8, 10-12, 17-21, 25-29, and 35, aspects of one or more of the edge node devices 310 described with reference to FIGS. 2-4, 9, 13-16, 18-29, and 37, or aspects of one or more of the apparatuses 3005, 3105, or 3305 described with reference to FIGS. 30, 31, and 33. In some examples, a UE or target edge node device may execute one or more sets of codes to control the functional elements of the UE or target edge node device to perform the functions described below. Additionally or alternatively, the UE or target edge node device may perform one or more of the functions described below using special-purpose hardware.

At block 4505, the method 4500 may include setting up an RRC connection between a UE and a target edge node device. The target edge node device may be associated with a target network access device, and the UE and target edge node device may communicate through the target network access device.

At block 4510, the method 4500 may include resuming or continuing, between the UE and the target edge node device, a TLS session established between the UE and a source edge node device associated with a source network access device. The UE and the source edge node device may communicate through the source network access device.

In some examples of the method 4500, the CDN may include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 4500 may include performing a TLS handshake between the UE and the target edge node device in a single round-trip message transfer. In some examples, the method 4500 may be performed by the UE or target edge node device involved in the message flow 2500, 2600, 2700, 2800, or 2900 described with reference to FIG. 25, 26, 27, 28, or 29.

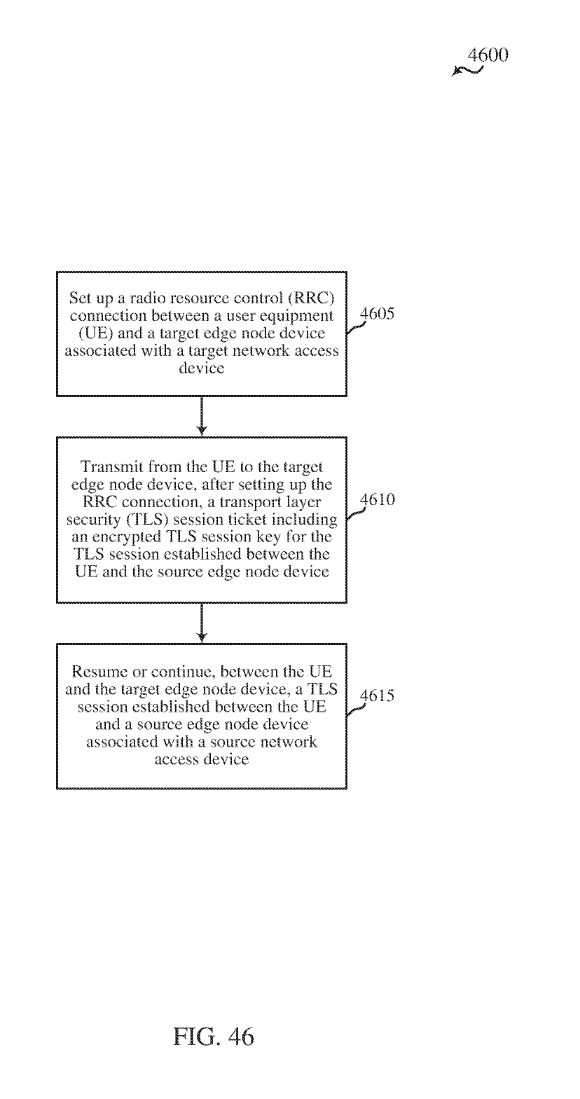

FIG. 46 is a flow chart illustrating an example of a method 4600 for wireless communication within a CDN, in accordance with various aspects of the present disclosure. The method 4600 may be performed by a UE. For clarity, the method 4600 is described below with reference to aspects of one or more of the UEs 115 described with reference to FIGS. 1-8, 10-12, 17-21, 25-29, and 35, or aspects of one or more of the apparatuses 3105 and 3305 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4605, the method 4600 may include setting up an RRC connection between a UE and a target edge node device. The target edge node device may be associated with a target network access device, and the UE and target edge node device may communicate through the target network access device.

At block 4610, the method 4600 may include transmitting from the UE to the target edge node device, after setting up the RRC connection at block 4605, a TLS session ticket including an encrypted TLS session key for a TLS session established between the UE and a source edge node device. The source edge node device may be associated with a source network access device. The UE and the source edge node device may communicate through the source network access device.

At block 4615, the method 4600 may include resuming or continuing, between the UE and the target edge node device, the TLS session established between the UE and the source edge node device.

In some examples of the method 4600, the CDN mas include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 4600 may include performing a TLS handshake between the UE and the target edge node device in a single round-trip message transfer. In some examples, the method 4600 may be performed by the UE involved in the message flow 2500, 2700, or 2800 described with reference to FIG. 25, 27, or 28.

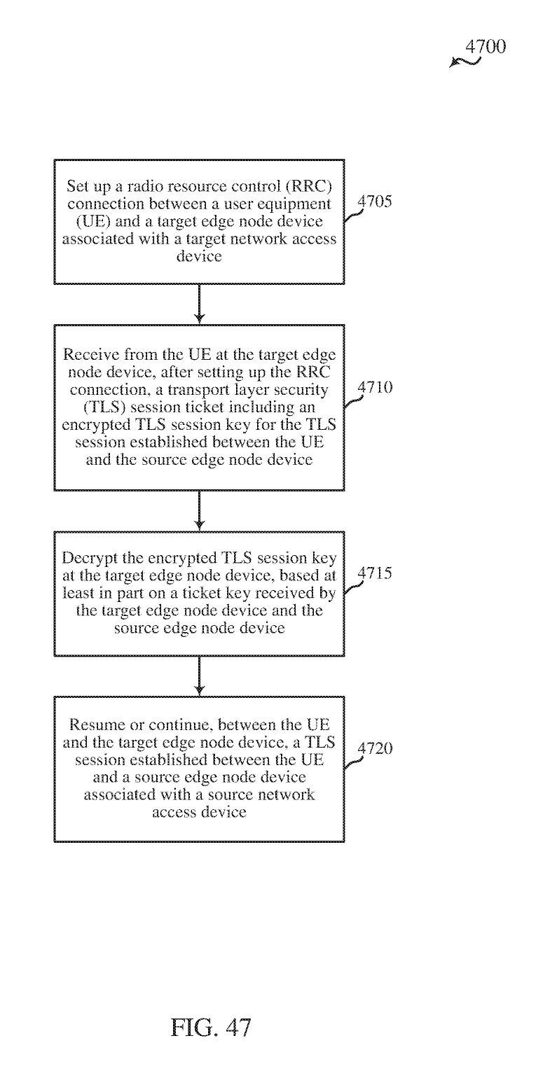

FIG. 47 is a flow chart illustrating an example of a method 4700 for wireless communication within a CDN, in accordance with various aspects of the present disclosure. The method 4700 may be performed by a target edge node device. For clarity, the method 4700 is described below with reference to aspects of one or more of the edge node devices 310 described with reference to FIGS. 2-4, 9, 13-16, 18-29, and 37, or aspects of one or more of the apparatuses 3005 or 3305 described with reference to FIGS. 30 and 33. In some examples, a target edge node device may execute one or more sets of codes to control the functional elements of the target edge node device to perform the functions described below. Additionally or alternatively, the target edge node device may perform one or more of the functions described below using special-purpose hardware.

At block 4705, the method 4700 may include setting up an RRC connection between a UE and a target edge node device. The target edge node device may be associated with a target network access device, and the UE and target edge node device may communicate through the target network access device.

At block 4710, the method 4700 may include receiving from the UE to the target edge node device, after setting up the RRC connection at block 4705, a TLS session ticket including an encrypted TLS session key for a TLS session established between the UE and a source edge node device. The source edge node device may be associated with a source network access device. The UE and the source edge node device may communicate through the source network access device.

At block 4715, the method 4700 may include decrypting the encrypted TLS session key at the target edge node device, based at least in part on a ticket key received by the target edge node device and the source edge node device (e.g., from a ticket server).

At block 4720, the method 4700 may include resuming or continuing, between the UE and the target edge node device, a TLS session established between the UE and a source edge node device associated with a source network access device.

In some examples of the method 4700, the CDN may include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 4700 may include performing a TLS handshake between the UE and the target edge node device in a single round-trip message transfer. In some examples, the method 4700 may be performed by the target edge node device involved in the message flow 2500, 2700, or 2800 described with reference to FIG. 25, 27, or 28.

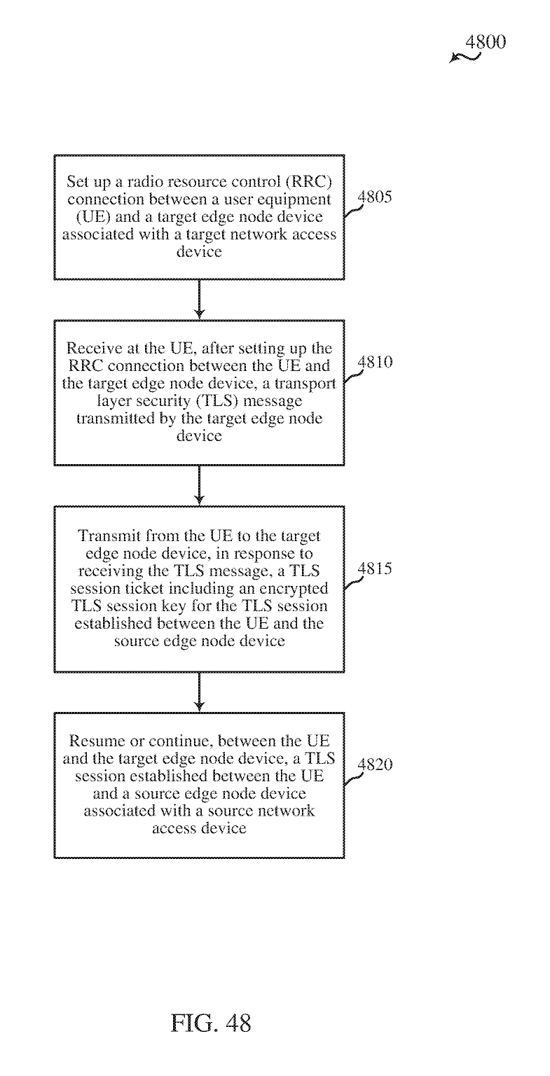

FIG. 48 is a flow chart illustrating an example of a method 4800 for wireless communication within a CDN, in accordance with various aspects of the present disclosure. The method 4800 may be performed by a UE. For clarity, the method 4600 is described below with reference to aspects of one or more of the UEs 115 described with reference to FIGS. 1-8, 10-12, 17-21, 25-29, and 35, or aspects of one or more of the apparatuses 3105 and 3304 described with reference to FIGS. 31 and 33. In some examples, a UE may execute one or more sets of codes to control the functional elements of the UE to perform the functions described below. Additionally or alternatively, the UE may perform one or more of the functions described below using special-purpose hardware.

At block 4805, the method 4800 may include setting up an RRC connection between a UE and a target edge node device. The target edge node device may be associated with a target network access device, and the UE and target edge node device may communicate through the target network access device.

At block 4810, the method 4800 may include receiving at the UE, after setting up the RRC connection between the UE and the target edge node device at block 4805, a TLS message transmitted by the target edge node device.

At block 4815, the method 4800 may include transmitting from the UE to the target edge node device, in response to receiving the TLS message at block 4810, a TLS session ticket including an encrypted TLS session key for a TLS session established between the UE and a source edge node device. The source edge node device may be associated with a source network access device. The UE and the source edge node device may communicate through the source network access device.

At block 4820, the method 4800 may include resuming or continuing, between the UE and the target edge node device, the TLS session established between the UE and the source edge node device.

In some examples of the method 4800, the CDN may include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 4800 may include performing a TLS handshake between the UE and the target edge node device in a single round-trip message transfer. In some examples, the method 4800 may be performed by the UE involved in the message flow 2600 or 2900 described with reference to FIG 26 or 29.

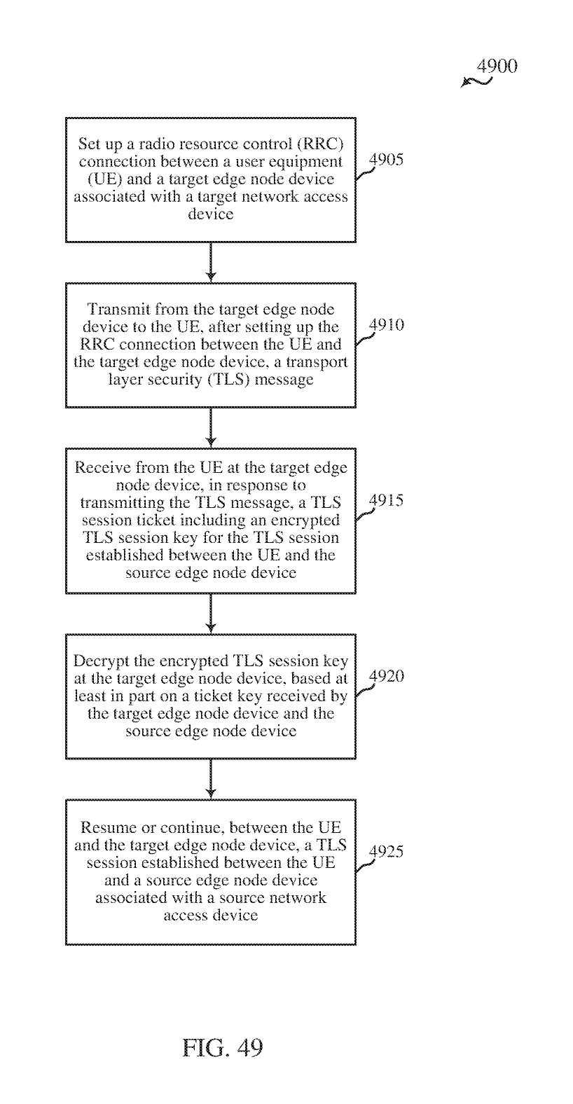

FIG. 49 is a flow chart illustrating an example of a method 4900 for wireless communication within a CDN, in accordance with various aspects of the present disclosure. The method 4900 may be performed by a target edge node device. For clarity, the method 4900 is described below with reference to aspects of one or more of the edge node devices 310 described with reference to FIGS. 2-4, 9, 13-16, 18-29, and 37, or aspects of one or more of the apparatuses 3005 or 3305 described with reference to FIGS. 30 and 33. In some examples, target edge node device may execute one or more sets of codes to control the functional elements of the target edge node device to perform the functions described below. Additionally or alternatively, the target edge node device may perform one or more of the functions described below using special-purpose hardware.

At block 4905, the method 4900 may include setting up an RRC connection between a UE and a target edge node device. The target edge node device may be associated with a target network access device, and the UE and target edge node device may communicate through the target network access device.

At block 4910, the method 4900 may include transmitting from the target edge node device to the UE, after setting up the RRC connection at block 4905, a TLS message.

At block 4915, the method 4900 may include receiving from the UE at the target edge node device, in response to transmitting the TLS message at block 4910, a TLS session ticket including an encrypted TLS session key for a TLS session established between the UE and a source edge node device. The source edge node device may be associated with a source network access device. The UE and the source edge node device may communicate through the source network access device.

At block 4920, the method 4900 may include decrypting the encrypted TLS session key at the target edge node device, based at least in part on a ticket key received by the target edge node device and the source edge node device (e.g., from a ticket server).

At block 4925, the method 4900 may include resuming or continuing, between the UE and the target edge node device, a TLS session established between the UE and a source edge node device associated with a source network access device.

In some examples of the method 4900, the CDN may include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 4900 may include performing a TLS handshake between the UE and the target edge node device in a single round-trip message transfer. In some examples, the method 4900 may be performed by the target edge node device involved in the message flow 2600 or 2900 described with reference to FIG. 26 or 29.

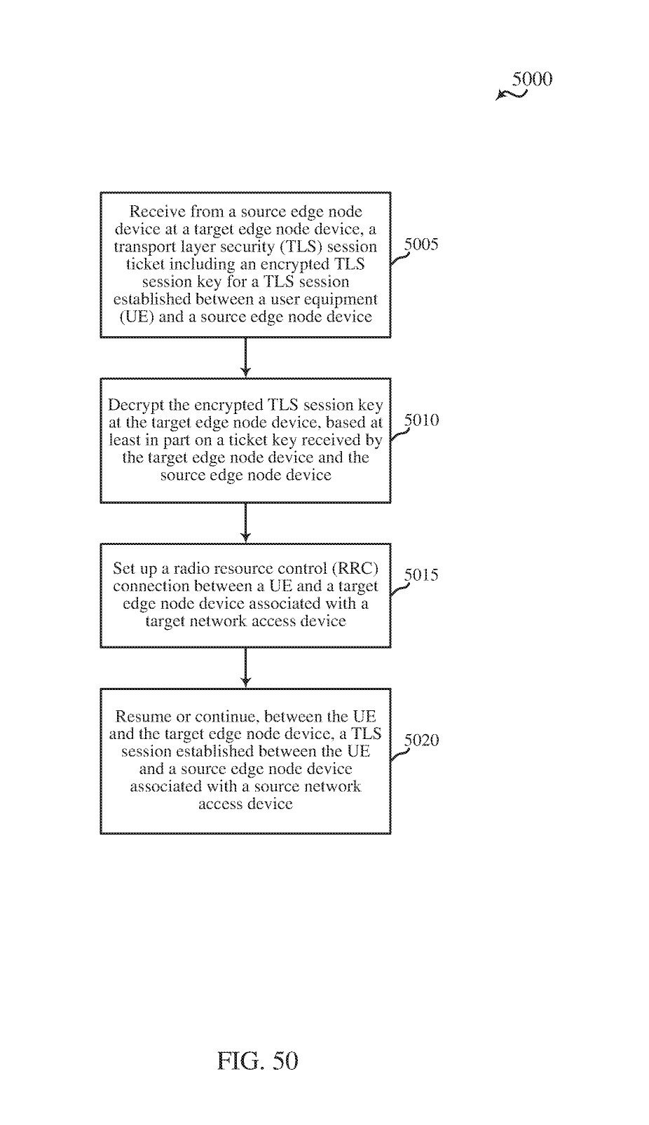

FIG. 50 is a flow chart illustrating an example of a method 5000 for wireless communication within a CDN, in accordance with various aspects of the present disclosure. The method 5000 may be performed by a target edge node device. For clarity, the method 5000 is described below with reference to aspects of one or more of the edge node devices 310 described with reference to FIGS. 2-4, 9, 13-16, 18-29, and 37, or aspects of one or more of the apparatuses 3005 or 3305 described with reference to FIGS. 30 and 33. In some examples, a target edge node device may execute one or more sets of codes to control the functional elements of the target edge node device to perform the functions described below. Additionally or alternatively, the target edge node device may perform one or more of the functions described below using special-purpose hardware.

At block 5005, the method 5000 may include receiving from a source edge node device at a target edge node device, a TLS session ticket including an encrypted TLS session key for a TLS session established between a UE and the source edge node device. The source edge node device may be associated with a source network access device. The target edge node device may be associated with a target network access device. The UE and the source edge node device may communicate through the source network access device. The UE and the target edge node device may communicate through the target network access device. In some examples, the TLS session ticket may be received with a request for handover of the UE from the source network access device to the target network access device, before the RRC connection is established with the UE.

At block 5010, the method 5000 may include decrypting the encrypted TLS session key at the target edge node device, based at least in part on a ticket key received by the target edge node device and the source edge node device (e.g., from a ticket server).

At block 5015, the method 5000 may include setting up an RRC connection between the UE and the target edge node device after receiving the TLS session key at block 5010.

At block 5020, the method 5000 may include resuming or continuing, between the UE and the target edge node device, a TLS session established between the UE and a source edge node device associated with a source network access device.

In some examples of the method 5000, the CDN may include a mobile CDN between the UE and a PGW, and at least one of the source edge node device or the target edge node device may be within the mobile CDN. In other examples, the CDN may include the mobile CDN, and at least one of the source edge node device or the target edge node device may be within the CDN and outside the mobile CDN. In some examples, the method 5000 may include performing a TLS handshake between the UE and the target edge node device in a single round-trip message transfer. In some examples, the method 5000 may be performed by the target edge node device involved in the message flow 2700 described with reference to FIG. 27.

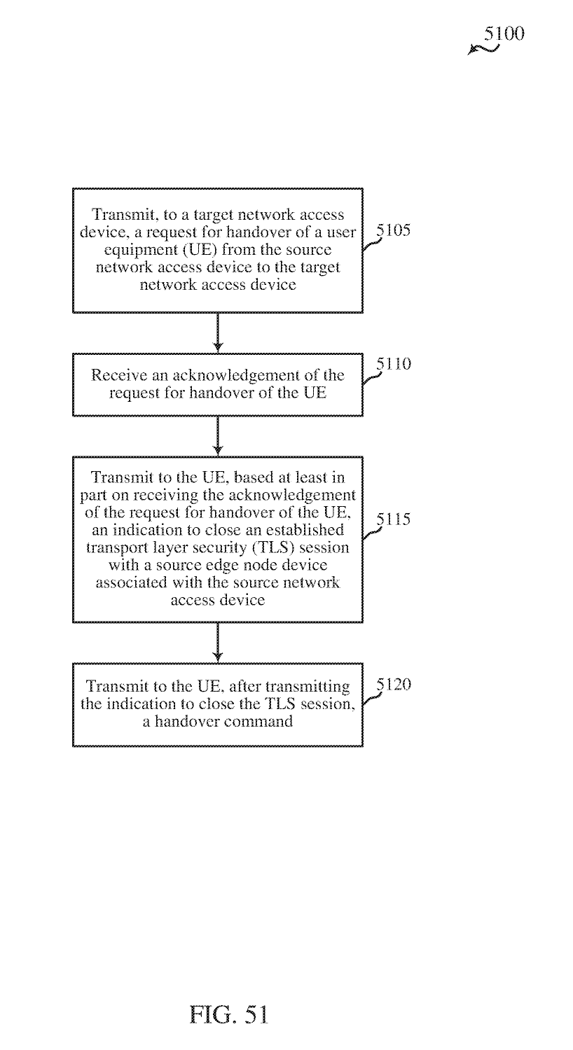

FIG. 51 is a flow chart illustrating an example of a method 5100 for wireless communication at a source network access device within a CDN, in accordance with various aspects of the present disclosure. For clarity, the method 5100 is described below with reference to aspects of one or more of the base stations 105 or network access devices 230 described with reference to FIGS. 1-4, 7, 8, 13, 16, 19-22, 25-29, and 36, or aspects of the apparatus 3405 described with reference to FIG. 34. In some examples, a network access device may execute one or more sets of codes to control the functional elements of the network access device to perform the functions described below. Additionally or alternatively, the network access device may perform one or more of the functions described below using special-purpose hardware.

At block 5105, the method 5100 may include transmitting, to a target network access device, a request for handover of a UE from the source network access device to the target network access device.

At block 5110, the method 5100 may include receiving an acknowledgement of the request for handover of the UE.

At block 5115, the method 5100 may include transmitting to the UE, based at least in part on receiving the acknowledgement of the request for handover of the UE at block 5110, an indication to close an established TLS session with a source edge node device associated with the source network access device.

At block 5120, the method 5100 may include transmitting to the UE after transmitting the indication to close the TLS session at block 5115, a handover command.

In some examples, the method 5100 may be performed by the source network access device involved in the message flow 2700 described with reference to FIG. 27.

The methods 3800, 3900, 4000, 4100, 4200, 4300, 4400, 4500, 4600, 4700, 4800, 4900, 5000, and 5100 described with reference to FIGS. 38-51 are particular implementations, and the operations of the methods may be rearranged or otherwise modified such that other implementations are possible.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are with in the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for handling content requests at an edge node device of a content delivery network (CDN), comprising:
receiving a request to access content of a website from a user equipment (UE) over a wireless network;
obtaining, in response to receiving the request, an authentication certificate for the website from a key server by providing an authentication certificate of the edge node device to the key server; and
establishing a secure connection with the UE based at least in part on the authentication certificate for the website.

2. The method of claim 1, wherein establishing the secure connection with the UE comprises:
transmitting the authentication certificate for the website to the UE;
receiving an encrypted premaster secret from the UE;
transmitting the encrypted premaster secret to the key server;
receiving a decrypted premaster secret from the key server; and
establishing the secure connection with the UE based at least in part on the decrypted premaster secret.

3. The method of claim 1, further comprising:
processing the request to access the content of the website after establishing the secure connection with the UE;
determining that the content is cached at the edge node device based at least in part on mobile CDN content delivery acceleration information associated with the request to access the content; and
delivering the content to the UE.

4. The method of claim 1, further comprising:
processing the request to access the content of the website after establishing the secure connection with the UE;
determining that the content is not cached at the edge node device based at least in part on mobile CDN content delivery acceleration information associated with the request to access the content;
obtaining the content from the website; and
delivering the content to the UE.

5. The method of claim 1, further comprising:
identifying the key server based at least in part on: the website, an identified owner of the website, or a combination thereof.

6. The method of claim 1, wherein the request to access the content of the website is received through a network access device, and wherein the secure connection with the UE is established through the network access device.

7. The method of claim 1, wherein the CDN comprises a mobile CDN between the UE and a packet gateway, and wherein the edge node device is within the mobile CDN.

8. The method of claim 1, wherein the CDN comprises a mobile CDN between the UE and a packet gateway, and wherein the edge node device is within the CDN and outside the mobile CDN.

9. An apparatus for handling content requests at an edge node device of a content delivery network (CDN), comprising:
means for receiving a request to access content of a website from a user equipment (UE) over a wireless network;
means for obtaining, in response to receiving the request, an authentication certificate for the website from a key server by providing an authentication certificate of the edge node device to the key server; and
means for establishing a secure connection with the UE based at least in part on the authentication certificate for the website.

10. The apparatus of claim 9, wherein the means for establishing the secure connection with the UE comprises:
means for transmitting the authentication certificate for the website to the UE;
means for receiving an encrypted premaster secret from the UE;
means for transmitting the encrypted premaster secret to the key server;
means for receiving a decrypted premaster secret from the key server; and
means for establishing the secure connection with the UE based at least in part on the decrypted premaster secret.

11. The apparatus of claim 9, further comprising:
means for processing the request to access the content of the website after establishing the secure connection with the UE;
means for determining that the content is cached at the edge node device based at least in part on mobile CDN content delivery acceleration information associated with the request to access the content; and
means for delivering the content to the UE.

12. The apparatus of claim 9, further comprising:
means for processing the request to access the content of the website after establishing the secure connection with the UE;
means for determining that the content is not cached at the edge node device based at least in part on mobile CDN content delivery acceleration information associated with the request to access the content;
means for obtaining the content from the website; and
means for delivering the content to the UE.

13. The apparatus of claim 9, further comprising:
means for identifying the key server based at least in part on: the website, an identified owner of the website, or a combination thereof.

14. The apparatus of claim 9, wherein the request to access the content of the website is received through a network access device, and wherein the secure connection with the UE is established through the network access device.

15. The apparatus of claim 9, wherein the CDN comprises a mobile CDN between the UE and a packet gateway, and wherein the edge node device is within the mobile CDN.

16. The apparatus of claim 9, wherein the CDN comprises a mobile CDN between the UE and a packet gateway, and wherein the edge node device is within the CDN and outside the mobile CDN.

17. An apparatus for handling content requests at an edge node device of a content delivery network (CDN), comprising:
a processor; and
memory in electronic communication with the processor;
the processor and the memory configured to:
receive a request to access content of a website from a user equipment (UE) over a wireless network;
obtain, in response to receiving the request, an authentication certificate for the website from a key server by providing an authentication certificate of the edge node device to the key server; and
establish a secure connection with the UE based at least in part on the authentication certificate for the website.

18. A non-transitory computer-readable medium storing computer-executable code for handling content requests at an edge node device of a content delivery network (CDN), the code executable by a processor to:
receive a request to access content of a website from a user equipment (UE) over a wireless network;
obtain, in response to receiving the request, an authentication certificate for the website from a key server by providing an authentication certificate of the edge node device to the key server; and
establish a secure connection with the UE based at least in part on the authentication certificate for the website.

19. A method for wireless communication at a user equipment (UE), comprising:
generating a request to access content of a website;
processing the request to access the content of the website at a modem, the processing including associating mobile content delivery network (CDN) content delivery acceleration information with the request to access the content of the website; and
transmitting the request to access the content of the website and the associated mobile CDN content delivery acceleration information to a network access device.

20. The method of claim 19, further comprising:
maintaining an authorized content provider list (ACPL);
wherein processing the request to access the content of the website at the modem comprises:
determining that information associated with the request to access the content of the website is included in the ACPL.

21. The method of claim 20, wherein the ACPL comprises at least one content provider entry, and wherein each of the content provider entries is associated with at least one of: a uniform resource locator (URL), a uniform resource identifier (URI), a domain name, a hypertext transfer protocol (HTTP) server internet protocol (IP) address, a port identifier, a protocol type, or a combination thereof.

22. The method of claim 20, wherein determining that information associated with the request to access the content of the website is included in the ACPL comprises:
determining a destination hypertext transfer protocol (HTTP) server internet protocol (IP) address and a port associated with the request to access the content of the website is included in the ACPL.

23. The method of claim 22, wherein determining that information associated with the request to access the content of the website is included in the ACPL further comprises:
determining a uniform resource locator (URL( or uniform resource identifier (URI) associated with the request to access the content of the website is included in the ACPL.

24. The method of claim 20, wherein the ACPL comprises at least one content provider entry including a domain name and a hypertext transfer protocol (HTTP) server internet protocol (IP) address, the method further comprising:
monitoring for HTTP server IP addresses associated with domain name system (DNS) requests and DNS responses processed by the modem; and
dynamically updating the ACPL based at least in part on the HTTP server IP addresses.

25. The method of claim 24, wherein the monitoring is performed for DNS requests and DNS responses associated with a DNS user datagram protocol (UDP) port.

26. The method of claim 24, wherein the monitoring is performed based at least in part on a notification received by the modem from an application programming interface (API).

27. The method of claim 19, further comprising:
querying the network access device to determine whether the network access device has locally cached the content of the website;
wherein the mobile CDN content delivery acceleration information is associated with the request to access the content of the website in response to determining that the network access device has locally cached the content of the website.

28. The method of claim 27, wherein the querying comprises transmitting a hypertext transfer protocol (HTTP) uniform resource locator (URL)/uniform resource identifier (URI) request using a radio resource control (RRC) signaling extension.

29. An apparatus for wireless communication at a user equipment (UE), comprising:
means for generating a request to access content of a website;
means for processing the request to access the content of the website at a modem, the processing including associating mobile content delivery network (CDN) content delivery acceleration information with the request to access the content of the website; and
means for transmitting the request to access the content of the website and the associated mobile CDN content delivery acceleration information to a network access device.

30. The apparatus of claim 29, further comprising:
means for maintaining an authorized content provider list (ACPL);
wherein the means for processing the request to access the content of the website at the modem comprises:
means for determining that information associated with the request to access the content of the website is included in the ACPL.

31. The apparatus of claim 30, wherein the ACPL comprises at least one content provider entry, and wherein each of the content provider entries is associated with at least one of: a uniform resource locator (URL), a uniform resource identifier (URI), a domain name, a hypertext transfer protocol (HTTP) server internet protocol (IP) address, a port identifier, a protocol type, or a combination thereof.

32. The apparatus of claim 30, wherein the means for determining that information associated with the request to access the content of the website is included in the ACPL comprises:
means for determining a destination hypertext transfer protocol (HTTP) server internet protocol (IP) address and a port associated with the request to access the content of the website is included in the ACPL.

33. The apparatus of claim 32, wherein the means for determining that information associated with the request to access the content of the website is included in the ACPL further comprises:
means for determining a uniform resource locator (URL( or uniform resource identifier (URI) associated with the request to access the content of the website is included in the ACPL.

34. The apparatus of claim 30, wherein the ACPL comprises at least one content provider entry including a domain name and a hypertext transfer protocol (HTTP) server internet protocol (IP) address, the apparatus further comprising:
means for monitoring for HTTP server IP addresses associated with domain name system (DNS) requests and DNS responses processed by the modem; and
means for dynamically updating the ACPL based at least in part on the HTTP server IP addresses.

35. The apparatus of claim 34, wherein the monitoring is performed for DNS requests and DNS responses associated with a DNS user datagram protocol (UDP) port.

36. The apparatus of claim 34, wherein the monitoring is performed based at least in part on a notification received by the modem from an application programming interface (API).

37. The apparatus of claim 29, further comprising:
means for querying the network access device to determine whether the network access device has locally cached the content of the website;
wherein the mobile CDN content delivery acceleration information is associated with the request to access the content of the website in response to determining that the network access device has locally cached the content of the website.

38. The apparatus of claim 37, wherein the means for querying comprises means for transmitting a hypertext transfer protocol (HTTP) uniform resource locator (URL)/uniform resource identifier (URI) request using a radio resource control (RRC) signaling extension.

39. An apparatus for wireless communication at a user equipment (UE), comprising:
a processor; and
memory in electronic communication with the processor;
the processor and the memory configured to:
generate a request to access content of a website;
process the request to access the content of the website at a modem, the processing including associating mobile content delivery network (CDN) content delivery acceleration information with the request to access the content of the website; and
transmit the request to access the content of the website and the associated mobile CDN content delivery acceleration information to a network access device.

40. A non-transitory computer-readable medium storing computer-executable code for wireless communication at a user equipment (UE), the code executable by a processor to:
generate a request to access content of a website;
process the request to access the content of the website at a modem, the processing including associating mobile content delivery network (CDN) content delivery acceleration information with the request to access the content of the website; and
transmit the request to access the content of the website and the associated mobile CDN content delivery acceleration information to a network access device.

41. A method for managing ticket keys at a ticket key server, comprising:
periodically generating a ticket key; and
periodically transmitting the periodically generated ticket key to each edge node device of a plurality edge node devices.

42. The method of claim 41, wherein at least one of the plurality of edge node devices is associated with a network access device of a mobile content delivery network (CDN).

43. An apparatus for managing ticket keys at a ticket key server, comprising:
means for periodically generating a ticket key; and
means for periodically transmitting the periodically generated ticket key to each edge node device of a plurality edge node devices.

44. The apparatus of claim 43, wherein at least one of the plurality of edge node devices is associated with a network access device of a mobile content delivery network (CDN).

45. An apparatus for managing ticket keys at a ticket key server, comprising:
a processor; and
memory in electronic communication with the processor;
the processor and the memory configured to:
periodically generate a ticket key; and
periodically transmit the periodically generated ticket key to each edge node device of a plurality edge node devices.

46. A non-transitory computer-readable medium, storing computer-executable code for managing ticket keys at a ticket key server, the code executable by a processor to:
periodically generate a ticket key; and
periodically transmit the periodically generated ticket key to each edge node device of a plurality edge node devices.

47. A method for wireless communication within a content delivery network (CDN), comprising:
setting up a radio resource control (RRC) connection between a user equipment (UE) and a target edge node device associated with a target network access device; and
resuming or continuing, between the UE and the target edge node device, a transport layer security (TLS) session established between the UE and a source edge node device associated with a source network access device.

48. The method of claim 47, further comprising:
transmitting from the UE to the target edge node device, after setting up the RRC connection and before resuming or continuing the TLS session, a TLS session ticket including an encrypted TLS session key for the TLS session established between the UE and the source edge node device.

49. The method of claim 47, further comprising:
receiving from the UE at the target edge node device, after setting up the RRC connection and before resuming or continuing the TLS session, a TLS session ticket including an encrypted TLS session key for the TLS session established between the UE and the source edge node device; and
decrypting the encrypted TLS session key at the target edge node device, based at least in part on a ticket key received by the target edge node device and the source edge node device.

50. The method of claim 47, further comprising:
receiving at the UE, after setting up the RRC connection between the UE and the target edge node device, a TLS message transmitted by the target edge node device; and
transmitting from the UE to the target edge node device, in response to receiving the TLS message and before resuming or continuing the TLS session, a TLS session ticket including an encrypted TLS session key for the TLS session established between the UE and the source edge node device.

51. The method of claim 47, further comprising:
transmitting from the target edge node device to the UE, after setting up the RRC connection between the UE and the target edge node device, a TLS message;
receiving from the UE at the target edge node device, in response to transmitting the TLS message and before resuming or continuing the TLS session, a TLS session ticket including an encrypted TLS session key for the TLS session established between the UE and the source edge node device; and
decrypting the encrypted TLS session key at the target edge node device, based at least in part on a ticket key received by the target edge node device and the source edge node device.

52. The method of claim 47, further comprising:
receiving from the source edge node device at the target edge node device, prior to setting up the RRC connection, a TLS session ticket including an encrypted TLS session key for the TLS session established between the UE and the source edge node device; and
decrypting the encrypted TLS session key at the target edge node device, based at least in part on a ticket key received by the target edge node device and the source edge node device.

53. The method of claim 47, further comprising:
performing a TLS handshake between the UE and the target edge node device in a single round-trip message transfer.

54. The method of claim 47, wherein the CDN comprises a mobile CDN between the UE and a packet gateway, and wherein at least one of the source edge node device or the target edge node device is within the mobile CDN.

55. The method of claim 47, wherein the CDN comprises a mobile CDN between the UE and a packet gateway, and wherein at least one of the source edge node device or the target edge node device is within the CDN and outside the mobile CDN.

56. An apparatus for wireless communication within a content delivery network (CDN), comprising:
means for setting up a radio resource control (RRC) connection between a user equipment (UE) and a target edge node device associated with a target network access device; and
means for resuming or continuing, between the UE and the target edge node device, a transport layer security (TLS) session established between the UE and a source edge node device associated with a source network access device.

57. The apparatus of claim 56, further comprising:
means for transmitting from the UE to the target edge node device, after setting up the RRC connection and before resuming or continuing the TLS session, a TLS session ticket including an encrypted TLS session key for the TLS session established between the UE and the source edge node device.

58. The apparatus of claim 56, further comprising:
means for receiving from the UE at the target edge node device, after setting up the RRC connection and before resuming or continuing the TLS session, a TLS session ticket including an encrypted TLS session key for the TLS session established between the UE and the source edge node device; and
means for decrypting the encrypted TLS session key at the target edge node device, based at least in part on a ticket key received by the target edge node device and the source edge node device.

59. The apparatus of claim 56, further comprising:
means for receiving at the UE, after setting up the RRC connection between the UE and the target edge node device, a TLS message transmitted by the target edge node device; and
means for transmitting from the UE to the target edge node device, in response to receiving the TLS message and before resuming or continuing the TLS session, a TLS session ticket including an encrypted TLS session key for the TLS session established between the UE and the source edge node device.

60. The apparatus of claim 56, further comprising:
means for transmitting from the target edge node device to the UE, after setting up the RRC connection between the UE and the target edge node device, a TLS message;
means for receiving from the UE at the target edge node device, in response to transmitting the TLS message and before resuming or continuing the TLS session, a TLS session ticket including an encrypted TLS session key for the TLS session established between the UE and the source edge node device; and
means for decrypting the encrypted TLS session key at the target edge node device, based at least in part on a ticket key received by the target edge node device and the source edge node device.

61. The apparatus of claim 56, further comprising:
means for receiving from the source edge node device at the target edge node device, prior to setting up the RRC connection, a TLS session ticket including an encrypted TLS session key for the TLS session established between the UE and the source edge node device; and
means for decrypting the encrypted TLS session key at the target edge node device, based at least in part on a ticket key received by the target edge node device and the source edge node device.

62. The apparatus of claim 56, further comprising:
means for performing a TLS handshake between the UE and the target edge node device in a single round-trip message transfer.

63. The apparatus of claim 56, wherein the CDN comprises a mobile CDN between the UE and a packet gateway, and wherein at least one of the source edge node device or the target edge node device is within the mobile CDN.

64. The apparatus of claim 56, wherein the CDN comprises a mobile CDN between the UE and a packet gateway, and wherein at least one of the source edge node device or the target edge node device is within the CDN and outside the mobile CDN.

65. An apparatus for wireless communication within a content delivery network (CDN), comprising:
a processor; and
memory in electronic communication with the processor;
the processor and the memory configured to:
set up a radio resource control (RRC) connection between a user equipment (UE) and a target edge node device associated with a target network access device; and
resume or continue, between the UE and the target edge node device, a transport layer security (TLS) session established between the UE and a source edge node device associated with a source network access device.

66. A non-transitory computer-readable medium storing computer-executable code for wireless communication within a content delivery network (CDN), the code executable by a processor to:
set up a radio resource control (RRC) connection between a user equipment (UE) and a target edge node device associated with a target network access device; and
resume or continue, between the UE and the target edge node device, a transport layer security (TLS) session established between the UE and a source edge node device associated with a source network access device.

67. A method for wireless communication at a source network access device within a content delivery network (CDN), comprising:
transmitting, to a target network access device, a request for handover of a user equipment (UE) from the source network access device to the target network access device;
receiving an acknowledgement of the request for handover of the UE;
transmitting to the UE, based at least in part on receiving the acknowledgement of the request for handover of the UE, an indication to close an established transport layer security (TLS) session with a source edge node device associated with the source network access device; and
transmitting to the UE, after transmitting the indication to close the TLS session, a handover command.

68. An apparatus for wireless communication at a source network access device within a content delivery network (CDN), comprising:
means for transmitting, to a target network access device, a request for handover of a user equipment (UE) from the source network access device to the target network access device;
means for receiving an acknowledgement of the request for handover of the UE;
means for transmitting to the UE, based at least in part on receiving the acknowledgement of the request for handover of the UE, an indication to close an established transport layer security (TLS) session with a source edge node device associated with the source network access device; and
means for transmitting to the UE, after transmitting the indication to close the TLS session, a handover command.

69. An apparatus for wireless communication at a source network access device within a content delivery network (CDN), comprising:
a processor; and
memory in electronic communication with the processor;
the processor and the memory configured to:
transmit, to a target network access device, a request for handover of a user equipment (UE) from the source network access device to the target network access device;
receive an acknowledgement of the request for handover of the UE;
transmit to the UE, based at least in part on receiving the acknowledgement of the request for handover of the UE, an indication to close an established transport layer security (TLS) session with a source edge node device associated with the source network access device; and
transmit to the UE, after transmitting the indication to close the TLS session, a handover command.

70. A non-transitory computer-readable medium storing computer-executable code for wireless communication at a source network access device within a content delivery network (CDN), the code executable by a processor to:
transmitting, to a target network access device, a request for handover of a user equipment (UE) from the source network access device to the target network access device;
receiving an acknowledgement of the request for handover of the UE;
transmitting to the UE, based at least in part on receiving the acknowledgement of the request for handover of the UE, an indication to close an established transport layer security (TLS) session with a source edge node device associated with the source network access device; and
transmitting to the UE, after transmitting the indication to close the TLS session, a handover command.
